(19) United States
(12) Patent Application Publication
(10) Pub. No.: US 2002/0120451 A1
(43) Pub. Date: Aug. 29, 2002

(54) Apparatus and method for providing information by speech

(76) Inventors: Yumiko Kato, Osaka (JP); Yumi Wakita, Nara-shi (JP)

Correspondence Address: RATNER AND PRESTIA, Suite 301, One Westlakes, Berwyn, P.O. Box 980, Valley Forge, PA, 19482-0980, US

(21) Appl. No.: 09/871,283

(22) Filed: May 31, 2001

(30) Foreign Application Priority Data
May 31, 2000 (JP) 2000-163,807
Sep. 29, 2000 (JP) 2000-300,061

(51) Int. Cl. G10L 13/00

(52) U.S. Cl. 704/258

(57) ABSTRACT

An apparatus for providing information by speech, has analyzing means of extracting all or some of words from an input sentence based on a predetermined criterion, replacing the extracted words with standard words by use of predetermined relation information, selecting a standard sentence pattern most relevant to the input sentence from among a plurality of prepared standard sentence patterns by use of the standard words, and replacing all or some of the standard words of the selected standard sentence pattern with the corresponding words; and

speech synthesizing means of performing speech synthesis of the sentence on which the word replacement has been performed, by use of prosody information previously assigned to at least the selected standard sentence pattern,

wherein the relation information is such that to the predetermined standard words, words relevant to the standard words are related.

### BACKGROUND OF THE INVENTION

1. Field of the Invention

The present invention relates to an apparatus for providing information by speech, a method for providing information by speech and a program that analyze an input signal or the like of an input text, speech, image or the like, convert it into a speech, and output the speech.

2. Description of the Related Art

As a first conventional apparatus for providing information by speech, an apparatus is known that performs language processing including syntactic analysis of the input sentence on the assumption that a complete and grammatically correct sentence is input, and performs speech synthesis based on the result of the language processing.

Aside from this apparatus, as a second conventional apparatus for providing information by speech, a speech synthesizing apparatus of Japanese Laid-open Patent Application No. H08-63187 is known for reading out stereotyped sentences such as speech service of, for example, traffic information or weather conditions by natural and easy-to-catch speech.

The second apparatus divides the message into stereotyped parts which are fixed information common to all the messages to be synthesized, and non-stereotyped parts that vary among messages, and applies speech information stored in a database to the stereotyped parts and applies speech information obtained by synthesis to the non-stereotyped parts, thereby generating a speech for providing information.

Here, the speech information stored in the database is prosody information such as a phoneme duration and a fundamental frequency pattern for application to the stereotyped parts, and the speech information obtained by synthesis is prosody information such as a phoneme duration and a fundamental frequency pattern for application to the non-stereotyped parts which information is classified and stored according to the number of syllables and the accent type for the position of each non-stereotyped part in the sentence. The fundamental frequencies of both are connected, and a speech waveform is generated based on the information.

As described above, conventional information provision by speech is such that, like the first apparatus, language processing including syntactic analysis is performed on the assumption that a complete and grammatically correct sentence is input and speech synthesis is performed based on the result of the language processing or that, like the second apparatus, with respect to information of a limited range such as traffic information or weather conditions, a signal that is input in a fixed format and by which a stereotyped sentence is uniquely decided is applied to a stereotyped sentence to perform speech synthesis.

However, in the first apparatus, it is necessary that the input be a complete and grammatically correct sentence, and a sentence including an input error such as a literal error or an omitted word cannot be handled. Therefore, when there is an input error, it is impossible to convert the input sentence into a speech that can be understood by the listener.

Moreover, in the first apparatus, it is difficult to create the prosody information used in speech synthesis. Therefore, it is difficult to provide information by natural speech.

Moreover, in the second apparatus, since the positions of the non-stereotyped parts in the sentence are predetermined, it is easy to create the prosody information and consequently, information can be provided by natural speech. However, it is necessary that the input sentence be written in a fixed format that can be converted into a stereotyped sentence. In addition, a sentence including a format error such as a literal error or an omitted word cannot be handled. Consequently, when there is a format error, it is impossible to convert the input sentence into a speech that can be understood by the listener.

That is, according to the conventional information provision by speech, to provide information by natural speech, it is necessary to input a sentence in a fixed format.

Moreover, according to the conventional information provision by speech, it is necessary that the input be a complete and grammatically correct sentence or be in a fixed format, and when there is an input error or a format error such as a literal error or an omitted word, it is impossible to convert the input sentence into a speech that can be understood by the listener.

Moreover, it is impossible to convert a nonverbal input such as an enumeration of words, an image, a temperature and a pressure into an understandable speech.

### SUMMARY OF THE INVENTION

An object of the present invention is, in view of the above-mentioned problems, to provide an apparatus for providing information by speech, a method for providing information by speech and a program that are capable of accepting an arbitrary input and providing information by natural speech.

Another object of the present invention is, in view of the above-mentioned problems, to provide an apparatus for providing information by speech, a method for providing information by speech and a program that are capable of accepting an arbitrary input and outputting a speech that can be understood by the listener even when there is an error in the input.

Still another object of the present invention is, in view of the above-mentioned problems, to provide an apparatus for providing information by speech, a method for providing information by speech and a program that are capable of converting even a nonverbal input such as a speech, an image or a sound into an understandable speech.

The 1st invention of the present invention is an apparatus for providing information by speech, comprising:

analyzing means of extracting all or some of words from an input sentence based on a predetermined criterion, replacing the extracted words with standard words by use of predetermined relation information, selecting a standard sentence pattern most relevant to the input sentence from among a plurality of prepared standard sentence patterns by use of the standard words, and replacing all or some of the standard words of the selected standard sentence pattern with the corresponding words; and

speech synthesizing means of performing speech synthesis of the sentence on which the word replacement has been performed, by use of prosody information previously assigned to at least the selected standard sentence pattern,

wherein said relation information is such that to the predetermined standard words, words relevant to the standard words are related.

The 2nd invention of the present invention is an apparatus for providing information by speech according to 1st invention, wherein said predetermined criterion is selection of a word occurring in the relation information.

The 3rd invention of the present invention is an apparatus for providing information by speech, comprising:

analyzing means of extracting all or some of words from an input sentence based on a predetermined criterion, and selecting a standard sentence pattern most relevant to the input sentence from among a plurality of prepared standard sentence patterns by use of the extracted words; and

speech synthesizing means of performing speech synthesis of the selected standard sentence pattern by use of prosody information previously assigned to at least the selected standard sentence pattern,

wherein said predetermined criterion is selection of a word coinciding with any of words registered in the prepared standard sentence patterns.

The 4th invention of the present invention is an apparatus for providing information by speech, comprising:

analyzing means of extracting all or some of words of a first language from an input sentence of the first language based on a predetermined criterion, replacing the extracted words of the first language with standard words of a second language by use of predetermined relation information, selecting a standard sentence pattern of the second language most relevant to the input sentence from among a plurality of prepared standard sentence patterns of the second language by use of the standard words of the second language, and replacing all or some of the standard words of the second language of the selected standard sentence pattern of the second language with words of the second language corresponding to words of the first language corresponding to the standard words of the second language; and

speech synthesizing means of performing speech synthesis of the sentence on which the word replacement has been performed, by use of prosody information previously assigned to at least the selected standard sentence pattern of the second language,

wherein said relation information is such that to the predetermined standard words of the second language, words of the first language relevant to the standard words of the second language are related.

The 5th invention of the present invention is an apparatus for providing information by speech, comprising:

analyzing means of extracting all or some of words of a first language from an input sentence of the first language based on a predetermined criterion, replacing the extracted words of the first language with standard words of the first language by use of predetermined relation information, selecting a standard sentence pattern of the first language most relevant to the input sentence from among a plurality of prepared standard sentence patterns of the first language by use of the standard words of the first language, identifying a predetermined standard sentence pattern of a second language associated with the selected standard sentence pattern of the first language, and replacing all or some of standard words of the second language of the identified standard sentence pattern of the second language with words of the second language equivalent to the input words of the first language corresponding to the standard words of the first language corresponding to the standard words of the second language; and

speech synthesizing means of performing speech synthesis of the sentence on which the word replacement has been performed, by use of prosody information previously assigned to at least the selected standard sentence pattern of the second language,

wherein said relation information is such that to the predetermined standard words of the first language, words of the first language relevant to the standard words of the first language are related.

The 6th invention of the present invention is an apparatus for providing information by speech according to 4th or 5th inventions, wherein said predetermined criterion is selection of a word of the first language occurring in the relation information.

The 7th invention of the present invention is an apparatus for providing information by speech, comprising:

analyzing means of extracting all or some of words of a first language from an input sentence of the first language based on a predetermined criterion, and selecting a standard sentence of a second language most relevant to the input sentence from among a plurality of prepared standard sentence patterns of the second language by use of words of the second language corresponding to the extracted words of the first language; and

speech synthesizing means of performing speech synthesis of the selected standard sentence pattern of the second language by use of prosody information previously assigned to at least the selected standard sentence pattern of the second language,

wherein said predetermined criterion is selection of a word of the first language corresponding to a word of the second language registered in the prepared standard sentence patterns of the second language.

The 8th invention of the present invention is an apparatus for providing information by speech, comprising:

analyzing means of extracting all or some of words of a first language from an input sentence of the first language based on a predetermined criterion, selecting a standard sentence pattern of the first language most relevant to the input sentence of the first language from among a plurality of prepared standard sentence patterns of the first language by use of the extracted words of the first language, and identifying a predetermined standard sentence pattern of a second language corresponding to the selected standard sentence pattern of the first language; and

speech synthesizing means of performing speech synthesis of the identified standard sentence pattern of the second language by use of prosody information previously assigned to at least the identified standard sentence pattern of the second language,

wherein said predetermined criterion is selection of a word of the first language coinciding with any of words of the first language registered in the prepared standard sentence patterns of the first language.

The 9th invention of the present invention is an apparatus for providing information by speech, comprising:

analyzing means of extracting all or some of words from an input sentence based on a predetermined criterion, replacing the extracted words with standard words by use of predetermined relation information, selecting a standard sentence pattern most relevant to the input sentence from among a plurality of prepared standard sentence patterns by use of the standard words, identifying a predetermined response standard sentence pattern corresponding to the selected standard sentence pattern, and replacing all or some of the standard words of the identified response standard sentence pattern with the corresponding words; and

speech synthesizing means of performing speech synthesis of the sentence on which the word replacement has been performed, by use of prosody information previously assigned to at least the identified response standard sentence pattern,

wherein said relation information is such that to the predetermined standard words, words relevant to the standard words are related.

The 10th invention of the present invention is an apparatus for providing information by speech according to 9th invention, wherein said predetermined criterion is selection of a word occurring in the relation information.

The 11th invention of the present invention is an apparatus for providing information by speech, comprising:

analyzing means of extracting all or some of words from an input sentence based on a predetermined criterion, selecting a standard sentence pattern most relevant to the input sentence from among a plurality of prepared standard sentence patterns by use of the extracted words, and identifying a predetermined response standard sentence pattern corresponding to the selected standard sentence pattern; and

speech synthesizing means of performing speech synthesis of the identified response standard sentence pattern by use of prosody information previously assigned to at least the identified response standard sentence pattern,

wherein said predetermined criterion is selection of a word the same as a word registered in the prepared standard sentence patterns.

The 12th invention of the present invention is an apparatus for providing information by speech according to any of 1st, 2nd, 4th, and 5th to 10th inventions, wherein when replacing the standard words of the selected standard sentence pattern with the words, said analyzing means leaves, of the standard words of the selected standard sentence pattern, standard words not corresponding to the words as they are, or replaces the standard words not corresponding to the words with predetermined words.

The 13th invention of the present invention is an apparatus for providing information by speech according to any of 1st to 11th inventions, wherein all or some of the prepared standard sentence patterns are each associated with a predetermined operation and/or image data.

The 14th invention of the present invention is an apparatus for providing information by speech according to 13th invention, wherein all or some of the prepared standard sentence patterns are each associated with a predetermined operation, and when selecting or identifying the standard sentence pattern, said analyzing means also identifies the operation corresponding to the standard sentence pattern, and the identified operation is performed when said speech synthesizing means outputs a result of the speech synthesis.

The 15th invention of the present invention is an apparatus for providing information by speech according to 13th invention, wherein all or some of the prepared standard sentence patterns are each associated with a predetermined image, and when selecting or identifying the standard sentence pattern, said analyzing means also identifies the image corresponding to the standard sentence pattern, and the identified image is displayed when said speech synthesizing means outputs a result of the speech synthesis.

The 16th invention of the present invention is an apparatus for providing information by speech according to any of 1st to 11th inventions, comprising signal processing means of analyzing an input signal and generating one word or a plurality of words in accordance with a result of the analysis,

wherein said input sentence is the generated word or words.

The 17th invention of the present invention is an apparatus for providing information by speech according to 16th invention, wherein said input signal is at least one of a speech, a sound, an image, a vibration, an acceleration, a temperature and a tension.

The 18th invention of the present invention is an apparatus for providing information by speech according to 17th invention, wherein said input signal is at least a speech, and said signal processing means performs speech recognition of the input speech and generates one word or a plurality of words in accordance with a result of the speech recognition.

The 19th invention of the present invention is an apparatus for providing information by speech according to 17th invention, wherein said input signal is at least a sound, and said signal processing means recognizes a sound source of the input sound and generates one word or a plurality of words in accordance with a result of the sound source recognition.

The 20th invention of the present invention is an apparatus for providing information by speech according to 17th invention, wherein said input signal is at least an images, and said signal processing means analyzes the input image and generates one word or a plurality of words in accordance with a result of the analysis.

The 21st invention of the present invention is an apparatus for providing information by speech according to any of 1st to 11th inventions, wherein there is a possibility that the input sentence is incomplete.

The 22nd invention of the present invention is an apparatus for providing information by speech according to 21st invention, wherein that there is a possibility that the input sentence is incomplete is a case where there is a possibility that all or a part of the input sentence is omitted, a case where there is a possibility that all or a part of the input sentence is replaced with an irrelevant sentence, or a case where there is a possibility that an irrelevant sentence is inserted in the input sentence.

The 23rd invention of the present invention is an apparatus for providing information by speech according to 22nd invention, wherein when said analyzing means fails in the selection of the standard sentence pattern because all of the input sentence is omitted or all of the input sentence is replaced with an irrelevant sentence, said speech synthesizing means does not perform the speech synthesis.

The 24th invention of the present invention is an apparatus for providing information by speech according to 21st invention, wherein that there is a possibility that the input sentence is incomplete is a case where there is a possibility that the input sentence is a grammatically incomplete sentence including a colloquial expression, a case where there is a possibility that the input sentence is an enumeration of words, a case where the input sentence includes a literal error or an omitted word, or a case where there is a possibility that the input sentence is not a sentence but an expression comprising symbols and words.

The 25th invention of the present invention is an apparatus for providing information by speech according to 21st invention, wherein when the input sentence is a sentence generated as a result of a speech recognition result, that there is a possibility that the input sentence is incomplete is a case where there is a possibility that the speech recognition result includes a recognition error, or a case where there is a possibility that the speech recognition is a failure so that a recognition result corresponding to all or part of the input speech on which the speech recognition is performed is not output as the speech recognition result.

The 26th invention of the present invention is an apparatus for providing information by speech according to any of 1st to 11th inventions, wherein said prosody information is a speech waveform obtained by recording a naturally generated speech of the standard sentence pattern assigned the prosody information.

The 27th invention of the present invention is an apparatus for providing information by speech according to any of 1st to 11th inventions, wherein said prosody information is information extracted from a naturally generated speech of the standard sentence pattern assigned the prosody information.

The 28th invention of the present invention is an apparatus for providing information by speech according to 27th invention, wherein said extracted information includes at least one of a fundamental frequency pattern, an intensity pattern, a phoneme duration pattern and a speech rate of the speech.

The 29th invention of the present invention is an apparatus for providing information by speech according to any of 1st to 11th inventions, wherein said prosody information is associated with at least one of the following conditions: a phoneme string; the number of morae, the number of syllables; an accent; a position in a sentence; presence or absence and a duration of an immediately preceding or succeeding pause; an accent type of an immediately preceding or succeeding accent phrase; prominence; a string of parts of speech; a clause attribute; and a dependency relation.

The 30th invention of the present invention is an apparatus for providing information by speech according to any of 1st to 11th inventions, wherein said prosody information is stored in prosody generation units, and said prosody generation units are any of accent phrases, phrases, words and paragraphs.

The 31st invention of the present invention is a method for providing information by speech, comprising the steps of:

extracting all or some of words from an input sentence based on a predetermined criterion, and replacing the extracted words with standard words by use of predetermined relation information;

selecting a standard sentence pattern most relevant to the input sentence from among a plurality of prepared standard sentence patterns by use of the standard words;

replacing all or some of the standard words of the selected standard sentence pattern with the corresponding words; and

performing speech synthesis of the sentence on which the word replacement has been performed, by use of prosody information previously assigned to at least the selected standard sentence pattern,

wherein said relation information is such that to the predetermined standard words, words relevant to the standard words are related.

The 32nd invention of the present invention is a method for providing information by speech, comprising the steps of:

extracting all or some of words from an input sentence based on a predetermined criterion, and selecting a standard sentence pattern most relevant to the input sentence from among a plurality of prepared standard sentence patterns by use of the extracted words; and

performing speech synthesis of the selected standard sentence pattern by use of prosody information previously assigned to at least the selected standard sentence pattern,

wherein said predetermined criterion is selection of a word coinciding with any of words registered in the prepared standard sentence patterns.

The 33rd invention of the present invention is a program for causing a computer to function as all or some of the following means of the apparatus for providing information by speech according to 1st invention:

analyzing means of extracting all or some of words from an input sentence based on a predetermined criterion, replacing the extracted words with standard words by use of predetermined relation information, selecting a standard sentence pattern most relevant to the input sentence from among a plurality of prepared standard sentence patterns by use of the standard words, and replacing all or some of the standard words of the selected standard sentence pattern with the corresponding words; and

speech synthesizing means of performing speech synthesis of the sentence on which the word replacement has been performed, by use of prosody information previously assigned to at least the selected standard sentence pattern.

The 34th invention of the present invention is a program for causing a computer to function as all or some of the following means of the apparatus for providing information by speech according to 3rd invention:

analyzing means of extracting all or some of words from an input sentence based on a predetermined criterion, and selecting a standard sentence pattern most relevant to the input sentence from among a plurality of prepared standard sentence patterns by use of the extracted words; and

speech synthesizing means of performing speech synthesis of the selected standard sentence pattern by use of prosody information previously assigned to at least the selected standard sentence pattern.

The 35th invention of the present invention is a program for causing a computer to function as all or some of the following means of the apparatus for providing information by speech according to 4th invention:

analyzing means of extracting all or some of words of a first language from an input sentence of the first language based on a predetermined criterion, replacing the extracted words of the first language with standard words of a second language by use of predetermined relation information, selecting a standard sentence pattern of the second language most relevant to the input sentence from among a plurality of prepared standard sentence patterns of the second language by use of the standard words of the second language, and replacing all or some of the standard words of the second language of the selected standard sentence pattern of the second language with words of the second language corresponding to words of the first language corresponding to the standard words of the second language; and

speech synthesizing means of performing speech synthesis of the sentence on which the word replacement has been performed, by use of prosody information previously assigned to at least the selected standard sentence pattern of the second language.

The 36th invention of the present invention is a program for causing a computer to function as all or some of the following means of the apparatus for providing information by speech according to 5th invention:

analyzing means of extracting all or some of words of a first language from an input sentence of the first language based on a predetermined criterion, replacing the extracted words of the first language with standard words of the first language by use of predetermined relation information, selecting a standard sentence pattern of the first language most relevant to the input sentence from among a plurality of prepared standard sentence patterns of the first language by use of the standard words of the first language, identifying a predetermined standard sentence pattern of a second language associated with the selected standard sentence pattern of the first language, and replacing all or some of standard words of the second language of the identified standard sentence pattern of the second language with words of the second language equivalent to the input words of the first language corresponding to the standard words of the first language corresponding to the standard words of the second language; and

speech synthesizing means of performing speech synthesis of the sentence on which the word replacement has been performed, by use of prosody information previously assigned to at least the selected standard sentence pattern of the second language.

The 37th invention of the present invention is a program for causing a computer to function as all or some of the following means of the apparatus for providing information by speech according to 7th invention:

analyzing means of extracting all or some of words of a first language from an input sentence of the first language based on a predetermined criterion, and selecting a standard sentence pattern of a second language most relevant to the input sentence from among a plurality of prepared standard sentence patterns of the second language by use of words of the second language corresponding to the extracted words of the first language; and

speech synthesizing means of performing speech synthesis of the selected standard sentence pattern of the second language by use of prosody information previously assigned to at least the selected standard sentence pattern of the second language.

The 38th invention of the present invention is a program for causing a computer to function as all or some of the following means of the apparatus for providing information by speech according to 8th invention:

analyzing means of extracting all or some of words of a first language from an input sentence of the first language based on a predetermined criterion, selecting a standard sentence pattern of the first language most relevant to the input sentence of the first language from among a plurality of prepared standard sentence patterns of the first language by use of the extracted words of the first language, and identifying a predetermined standard sentence pattern of a second language corresponding to the selected standard sentence pattern of the first language; and

speech synthesizing means of performing speech synthesis of the identified standard sentence pattern of the second language by use of prosody information previously assigned to at least the identified standard sentence pattern of the second language.

The 39th invention of the present invention is a program for causing a computer to function as all or some of the following means of the apparatus for providing information by speech according to 9th invention:

analyzing means of extracting all or some of words from an input sentence based on a predetermined criterion, replacing the extracted words with standard words by use of predetermined relation information, selecting a standard sentence pattern most relevant to the input sentence from among a plurality of prepared standard sentence patterns by use of the standard words, identifying a predetermined response standard sentence pattern corresponding to the selected standard sentence pattern, and replacing all or some of the standard words of the identified response standard sentence pattern with the corresponding words; and

speech synthesizing means of performing speech synthesis of the sentence on which the word replacement has been performed, by use of prosody information previously assigned to at least the identified response standard sentence pattern.

The 40th invention of the present invention is a program for causing a computer to function as all or some of the following means of the apparatus for providing information by speech according to 11th invention:

analyzing means of extracting all or some of words from an input sentence based on a predetermined criterion, selecting a standard sentence pattern most relevant to the input sentence from among a plurality of prepared standard sentence patterns by use of the extracted words, and identifying a predetermined response standard sentence pattern corresponding to the selected standard sentence pattern; and

speech synthesizing means of performing speech synthesis of the identified response standard sentence pattern by use of prosody information previously assigned to at least the identified response standard sentence pattern.

### BRIEF DESCRIPTION OF THE DRAWINGS

FIG. 1 is a block diagram of a system for providing information by speech according to first and fifth embodiments of the present invention;

FIG. 2 is a flowchart of the operation of the first embodiment of the present invention;

FIG. 3(a) is a view showing an example of a prosody information connecting method in the first embodiment of the present invention;

FIG. 3(b) is a view showing another example of the prosody information connecting method in the first embodiment of the present invention;

FIG. 4 is a view showing a concrete example of processing in the first embodiment of the present invention;

FIG. 5 is a view showing an example of a key word information assigned dictionary in the first embodiment of the present invention;

FIG. 6 is a view showing an example of a meaning class database in the first embodiment of the present invention;

FIG. 7(a) is a view showing an example of the standard sentence pattern database in the first embodiment of the present invention;

FIG. 7(b) is a view showing an example of the dependency relation database in the first embodiment of the present invention;

FIG. 8 is a view showing another concrete example of the processing in the first embodiment of the present invention;

FIG. 9 is a block diagram of a system for providing information by speech according to a second embodiment of the present invention;

FIG. 10 is a flowchart of the operation of the second embodiment of the present invention;

FIG. 11 is a view showing a concrete example of processing in the second embodiment of the present invention;

FIG. 12 is a view showing an example of an English key word information assigned dictionary in the second embodiment of the present invention;

FIG. 13 is a view showing an example of an English meaning class database in the second embodiment of the present invention;

FIG. 14(a) is a view showing an example of a Japanese standard sentence pattern database in the second embodiment of the present invention;

FIG. 14(b) is a view showing an example of an English dependency relation database in the second embodiment of the present invention;

FIG. 15 is a block diagram of a system for providing information by speech according to a third embodiment of the present invention;

FIG. 16 is a flowchart of the operation of the third embodiment of the present invention;

FIGS. 17(a) to 17(e) are views showing a concrete example of processing in the third embodiment of the present invention;

FIG. 18 is a block diagram of a system for providing information by speech according to a fourth embodiment of the present invention;

FIG. 19 is a flowchart of the operation of the fourth embodiment of the present invention;

FIG. 20 is a flowchart of the operation of a fifth embodiment of the present invention;

FIG. 21 is a view showing a concrete example of processing in the fifth embodiment of the present invention;

FIG. 22(a) is a view showing an example of the standard sentence pattern database in the fifth embodiment of the present invention;

FIG. 22(b) is a view showing an example of the dependency relation database in the fifth embodiment of the present invention;

FIG. 23 is a block diagram of a system for providing information by speech according to a sixth embodiment of the present invention;

FIG. 24 is a flowchart of the operation of the sixth embodiment of the present invention;

FIG. 25 is a view showing a concrete example of processing in the sixth embodiment of the present invention;

FIG. 26 is a block diagram of a system for providing information by speech according to a modification of the first embodiment of the present invention;

FIG. 27 is a flowchart of the operation of the modification of the first embodiment of the present invention; and

FIG. 28 is a view showing an example of the standard sentence pattern database of the modification of the first embodiment of the present invention.

### EXPLANATION OF REFERENCE NUMERALS

110 Text input portion

120 Key word information assigned dictionary

121 Meaning class database

122 Dependency relation database

130 Key word extracting portion

132 Dependency relation analyzing portion

150 Standard sentence pattern searching portion

160 Non-stereotyped part generating portion

170 Speech synthesizing portion

171 Non-stereotyped part prosody database

172 Prosody control portion

173 Phoneme piece database

174 Waveform generating portion

180 Output portion

210 Speech input portion

230 Speech recognizing and key word extracting portion

910 Image recognizing portion

930 Meaning tag generating portion

950 Standard sentence pattern searching portion

### DESCRIPTION OF THE PREFERRED EMBODIMENTS

Hereinafter, embodiments of the present invention will be described with reference to the drawings.

(First Embodiment)

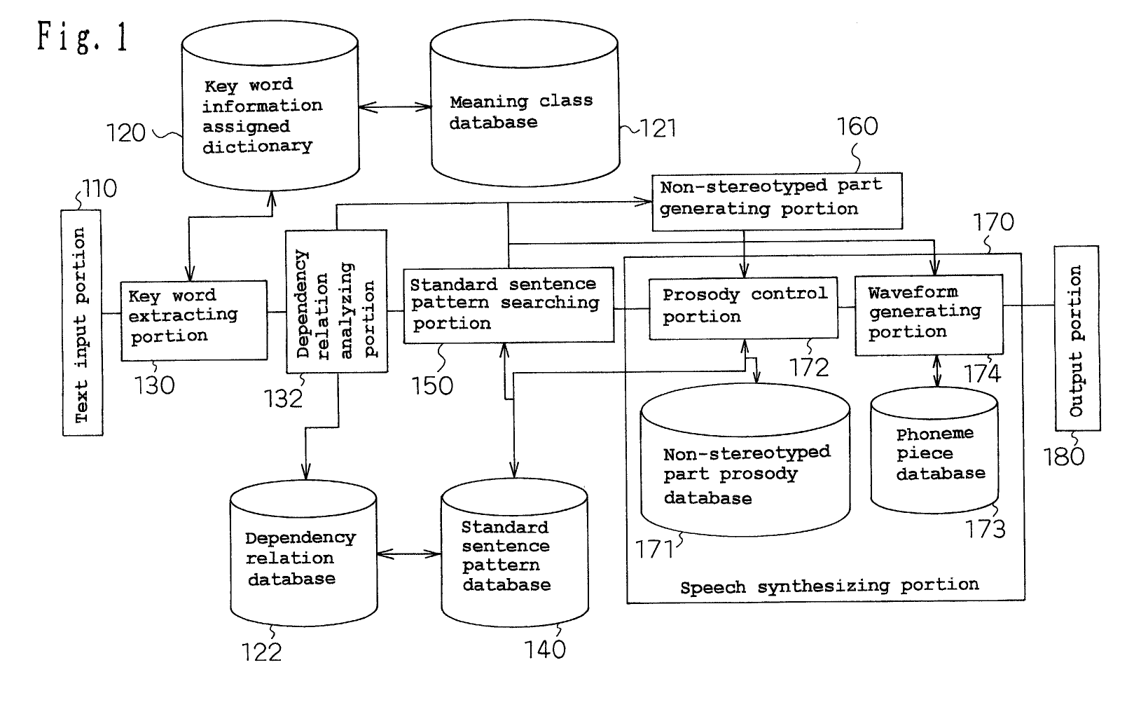

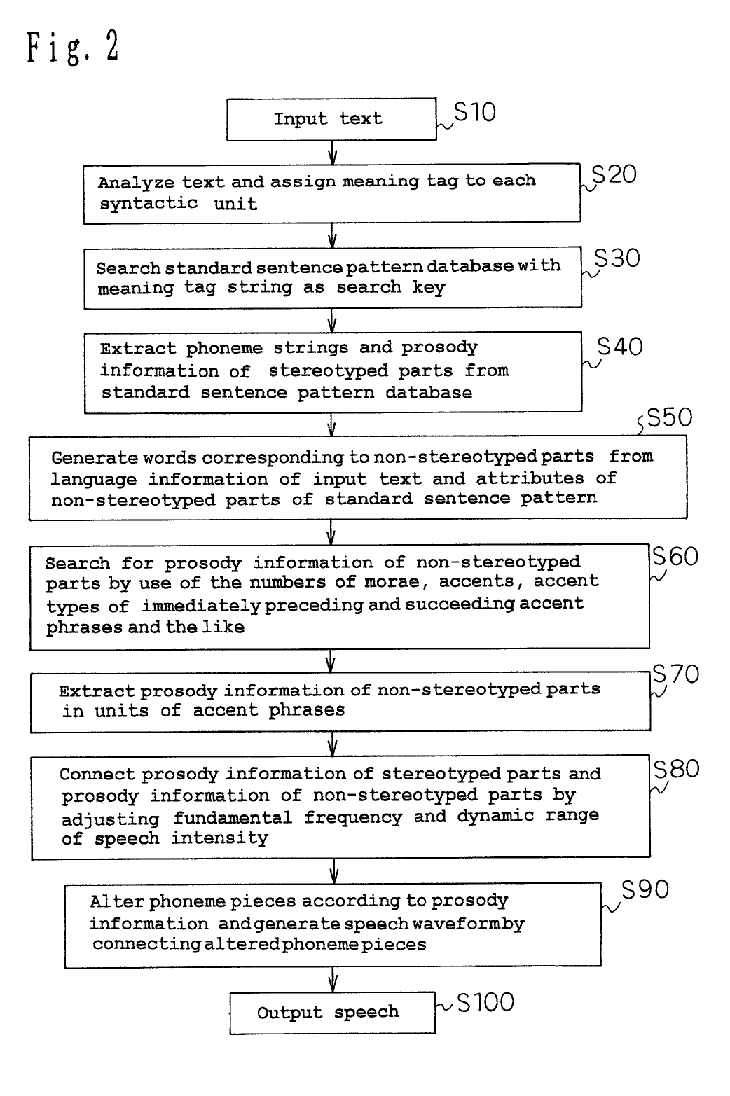

FIG. 1 is a functional block diagram showing the structure of a system for providing information by speech according to a first embodiment of the present invention. FIG. 2 is a flowchart of the operation of the system for providing information by speech according to the first embodiment of the present invention.

In FIG. 1, reference numeral 110 represents a text input portion for inputting a text. Reference numeral 120 represents a key word information assigned dictionary in which information necessary for analysis of morphemes such as the written form, the pronunciation and the part of speech is stored, and morphemes to be treated as key words are assigned a key word flag. Reference numeral 121 represents a meaning class database in which meaning tags corresponding to the key words in the key word information assigned dictionary 120 are stored. Reference numeral 130 represents a key word extracting portion that performs morpheme analysis on the input text with reference to the key word information assigned dictionary 120, extracts key words from the input text, and assigns each of the extracted key words a meaning tag. Reference numeral 140 represents a standard sentence pattern database in which adjustment parameters of standard sentence patterns, stereotyped part phoneme strings, stereotyped part prosody patterns and non-stereotyped part prosody patterns are stored. Reference numeral 122 represents a dependency relation database in which meaning tag sets formed by combining meaning tags relevant to each other are stored. The standard sentence pattern data corresponding to each meaning tag set is stored in the standard sentence pattern database 140. Reference numeral 132 represents a dependency relation analyzing portion that calculates the degree of coincidence between a meaning tag string output from the key word extracting portion 130 and each of the meaning tag sets stored in the dependency relation database 122. Reference numeral 150 represents a standard sentence pattern searching portion that searches the standard sentence pattern database based on the calculated degree of coincidence. Reference numeral 160 represents a non-stereotyped part generating portion that generates phonetic symbol strings corresponding to the non-stereotyped parts of the input.

Reference numeral 170 represents a speech synthesizing portion. Reference numeral 180 represents an output portion that outputs a speech waveform. The speech synthesizing portion 170 includes: a non-stereotyped part prosody database 171 in which the phoneme string, the number of morae, the accent, the position in the sentence, the presence or absence and the durations of immediately preceding and succeeding pauses, the accent types of the immediately preceding and succeeding accent phrases and the prosody information are stored; a prosody control portion 172 that extracts the prosody information of the non-stereotyped parts with reference to the non-stereotyped part prosody database 171, and connects the extracted prosody information to the prosody information of the stereotyped parts extracted by the standard sentence pattern searching portion 150; and a waveform generating portion 174 that generates a speech waveform based on the prosody information output from the prosody control portion 172 by use of a phoneme piece database 173 in which a waveform generating unit is stored and phoneme pieces stored in the phoneme piece database 173. The above-mentioned prosody information is information extracted from a naturally generated speech of the standard sentence pattern assigned the prosody information, and includes at least one of the fundamental frequency pattern, the intensity pattern and the phoneme duration pattern of the speech.

The operation of the system for providing information by speech structured as described above will be described with reference to FIG. 2.

In the system for providing information by speech according to this embodiment, before providing information by speech, it is necessary to prepare the key word information assigned dictionary 120, the meaning class database 121, the dependency relation database 122 and the standard sentence pattern database 140.

To do so, first, the developer manually decides key words representative of an intention for each input sentence meaning. Here, the sentence meaning is a unit of one or a plurality of different sentences representing an equal intention. Alternately, as another method, key words can be semiautomatically decided by the developer assigning a meaning tag representative of an intention of a sentence for each sentence of a corpus, classifying the sentences of the corpus by regarding sentences assigned the same meaning tag as one sentence meaning, selecting the words common to the sentence meanings as key word candidates, and checking the key word candidates.

The developer divides the key words decided in this manner into classes according to the meaning, and decides a meaning tag for each class.

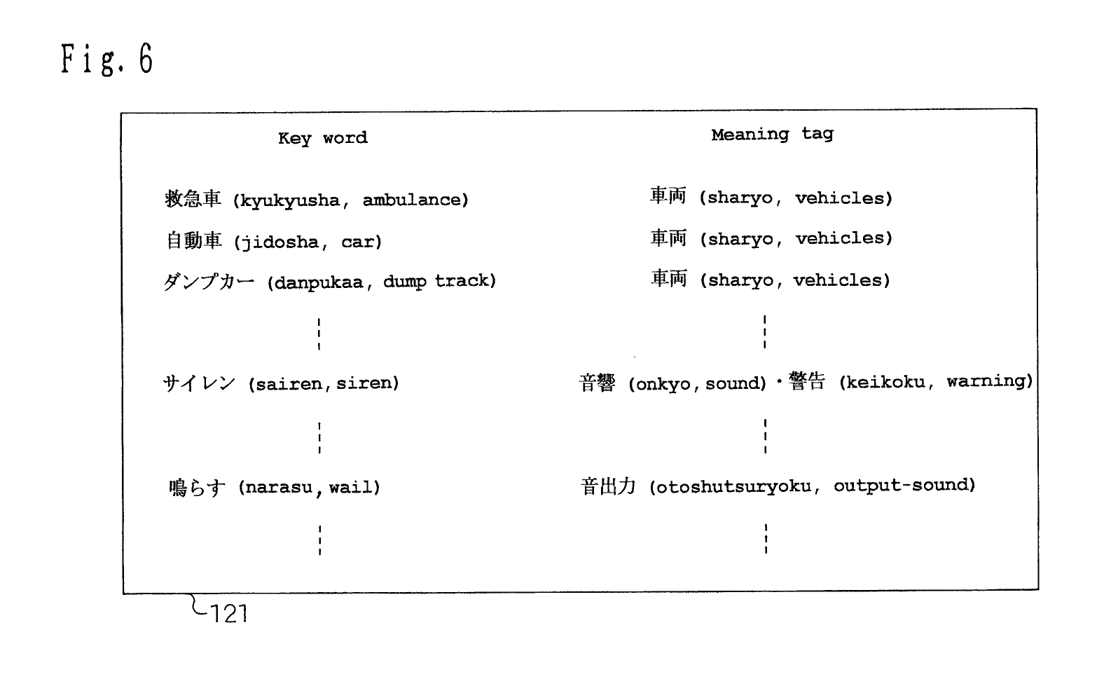

FIG. 5 shows an example of the key word information assigned dictionary 120. In the key word information assigned dictionary 120, information necessary for analysis of morphemes such as the written form, the pronunciation, the part of speech and the like is stored, and morphemes to be treated as key words are assigned the key word flag. With respect to “ [symbol] (kyukyusha, ambulance)” in FIG. 5, the pronunciation is “ [symbol] (kyukyusha)” and the part of speech is a noun. These pieces of information are used when morpheme analysis is performed. Moreover, the key word flag of “ [symbol] (kyukyusha, ambulance)” is 1, that is, [symbol] (kyukyusha, ambulance) is assigned the key word flag. Therefore, “ [symbol] (kyukyusha, ambulance)” is a key word. On the contrary, with respect to “ [symbol] (wa)” in FIG. 5, the pronunciation is “ [symbol] (wa)” and the part of speech is a postpositional particle. Moreover, the key word flag of “ [symbol] (wa)” is 0, that is, “ [symbol] (wa)” is not assigned the key word flag. Therefore, “ [symbol] (wa)” is not a key word.

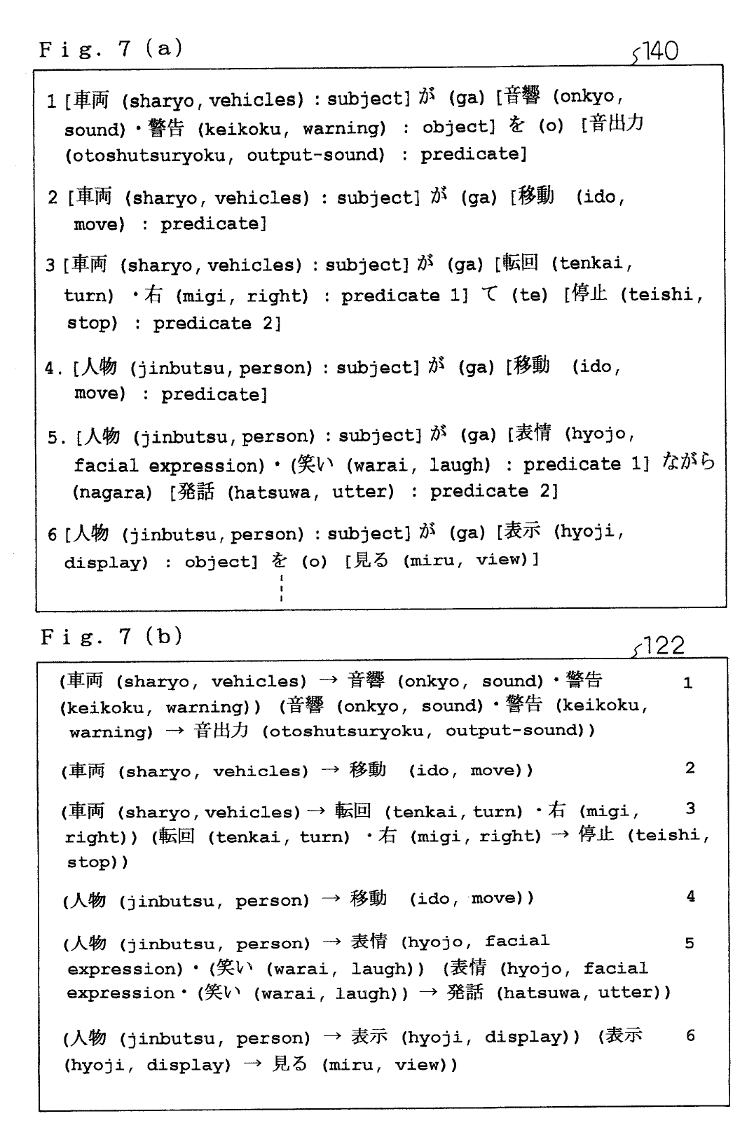

FIG. 6 shows an example of the meaning class database 121. In the meaning class database 121, each key word is assigned a meaning tag representative of the class to which the key word belongs. For example, “ [symbol] (kyukyusha, ambulance)” is assigned “ [symbol] (sharyo, vehicles)” as the meaning tag, and “ [symbol] (jidosha, car)” and “ [symbol] (danpukaa, dump track)” are also assigned “ [symbol] (sharyo, vehicles)” as the meaning tag. Moreover, “ [symbol] (sairen, siren)” is assigned “ [symbol] (onkyo, sound)· [symbol] (keikoku, warning)” as the meaning tag, and “ [symbol] (narasu, wail)” is assigned “ [symbol] (otoshutsuryoku, output-sound)” as the meaning tag.

That is, the meaning tags represent classes into which words extracted from input text or a speech recognition result are divided based on superordinate concepts, parts of speech, clause attributes and the like as shown in thesauruses. A bunsetsu is defined as a type of language unit for Japanese. It is the smallest unit, when native Japanese divides sentences naturally. The meaning tag is not limited to preset fixed information as described above, but may be varied (be caused to perform learning) according to the use environment based on the output result of the dependency relation analyzing portion 132 described later. Varying the meaning tag according to the use environment means that the method of classing of the meaning class database 121 is improved so that in a case where a problem arises such that a speech cannot be normally output when a speech is output from an input text by use of the system for providing information by speech according to this embodiment, a speech can be normally output even when the same text is input. It is unnecessary that the meaning class database 121 be an independent database, but the database 121 may be included in the key word information assigned dictionary 120.

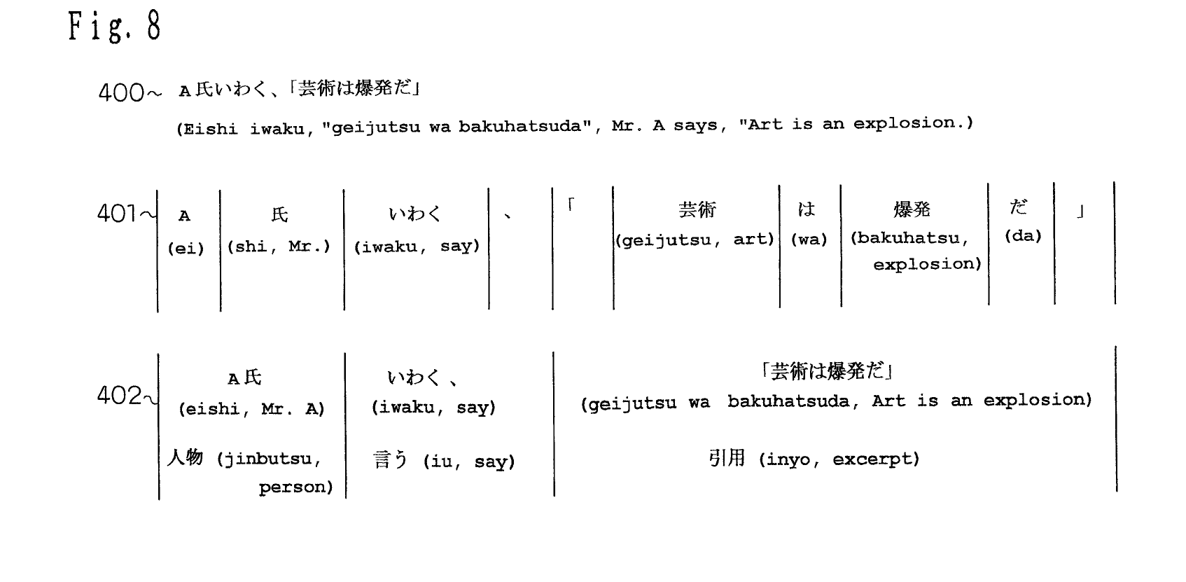

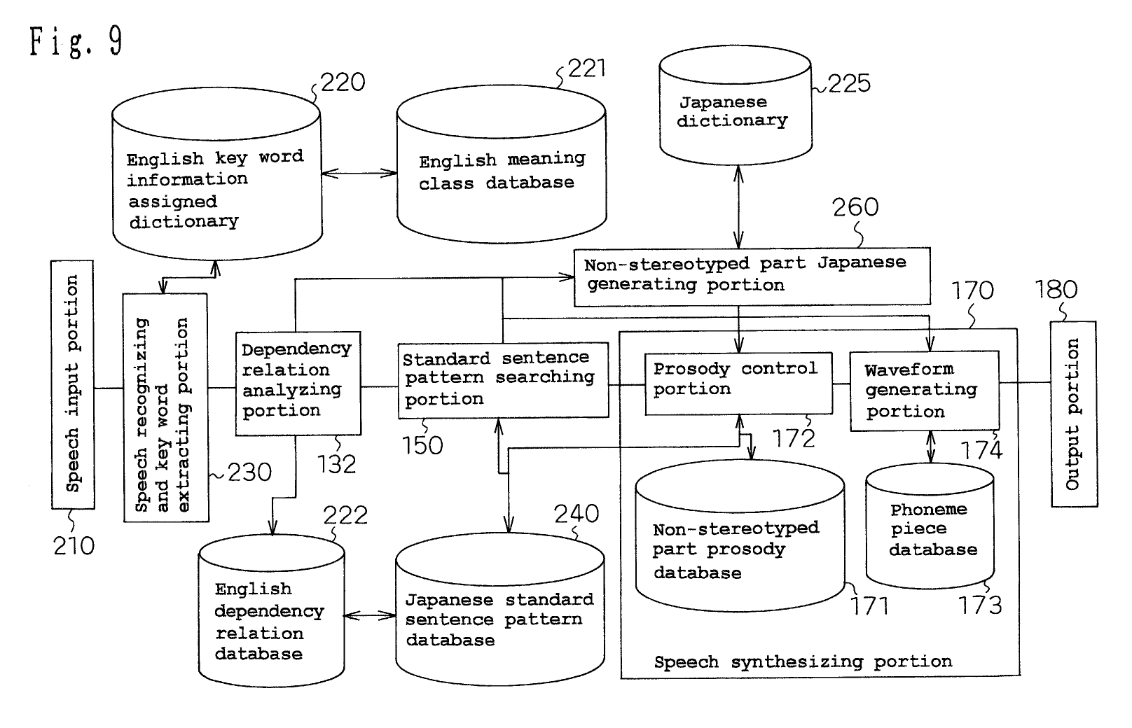

FIG. 7(a) shows an example of the standard sentence pattern database 140. In the standard sentence pattern database 140, a plurality of standard sentence patterns is stored. For example, the first standard sentence pattern is “ [symbol] (sharyo, vehicles): subject] [symbol] (ga) [symbol] (onkyo, sound)· [symbol] (keikoku, warning): object] [symbol] (o) [symbol] (otoshutsuryoku, output-sound): predicate].” The meaning tag “ [symbol] (sharyo, vehicles)” is the subject of the standard sentence pattern, the meaning tag “ [symbol] (onkyo, sound)· [symbol] (keikoku, warning)” is the object of the standard sentence pattern, and the meaning tag “ [symbol] (otoshutsuryoku, output-sound)” is the predicate of the standard sentence pattern. The third standard sentence pattern is “[ [symbol] (sharyo, vehicles): subject] [symbol] (ga) [symbol] (tenkai, turn)· [symbol] (migi, right): predicate 1] [symbol] (te) [symbol] (teishi, stop): predicate 2].” The meaning tag “ [symbol] (sharyo, vehicles)” is the subject of the standard sentence pattern, the meaning tag “ [symbol] (tenkai, turn)· [symbol] (migi, right)” is the firstpredicate of the standard sentence pattern, and the meaning tag “ [symbol] (teishi, stop)” is the second predicate of the standard sentence pattern. In the standard sentence pattern database 140, prosody information such as adjustment parameters of stereotyped part phoneme strings, stereotyped part prosody patterns and non-stereotyped part prosody patterns are stored so as to be associated with standard sentence patterns. These pieces of information are used in speech synthesis.

FIG. 7(b) shows an example of the dependency relation database 122. In the dependency relation database 122, meaning tag sets are stored each comprising a set of meaning tags of each standard sentence pattern in the standard sentence pattern database 140. In FIG. 7(b), “( [symbol] (sharyo, vehicles) [symbol] (onkyo, sound)· [symbol] (keikoku, warning)), ( [symbol] (onkyo, sound)· [symbol] (keikoku, warning) [symbol] (otoshutsuryoku, output-sound))” is one meaning tag set. The number such as 1 following the meaning tag set represents the standard sentence pattern in the standard sentence pattern database 140 corresponding to the meaning tag set. For example, the meaning tag set “( [symbol] (sharyo, vehicles) [symbol] (onkyo, sound)· [symbol] (keikoku, warning)) ( [symbol] (onkyo, sound)· [symbol] (keikoku, warning)→ [symbol] (otoshutsuryoku, output-sound))” followed by a numeral 1 corresponds to the first standard sentence pattern “ [symbol] (sharyo, vehicles): subject] [symbol] (ga) [symbol] (onkyo, sound)· [symbol] (keikoku, warning): object] [symbol] (o) [symbol] (otoshutsuryoku, output-sound): predicate]” of the standard sentence pattern database 140.

In the meaning tag sets, meaning tags form pairs like “( [symbol] (sharyo, vehicles)→ [symbol] (onkyo, sound)· [symbol] (keikoku, warning)), [symbol] (onkyo, sound)· [symbol] (keikoku, warning) [symbol] (otoshutsuryoku, output-sound).” The meaning tag pairs represent cooccurrence relations of meaning tags in standard sentence patterns, and are predetermined by the developer. The standard sentence patterns corresponding to the meaning tag sets are stored in the standard sentence pattern database 140.

It is assumed that the key word information assigned dictionary 120, the meaning class database 121, the dependency relation database 122 and the standard sentence pattern database 140 as described above are prepared.

Next, the operation to provide information by speech will be described.

First, the text input portion 110 accepts text data to be processed (step 10). Then, the key word extracting portion 130 performs morpheme analysis on the input text data by use of the key word information assigned dictionary 120 to assign language information such as the pronunciation and the part of speech, and performs syntactic analysis to assign a meaning tag to each syntactic unit (step 20).

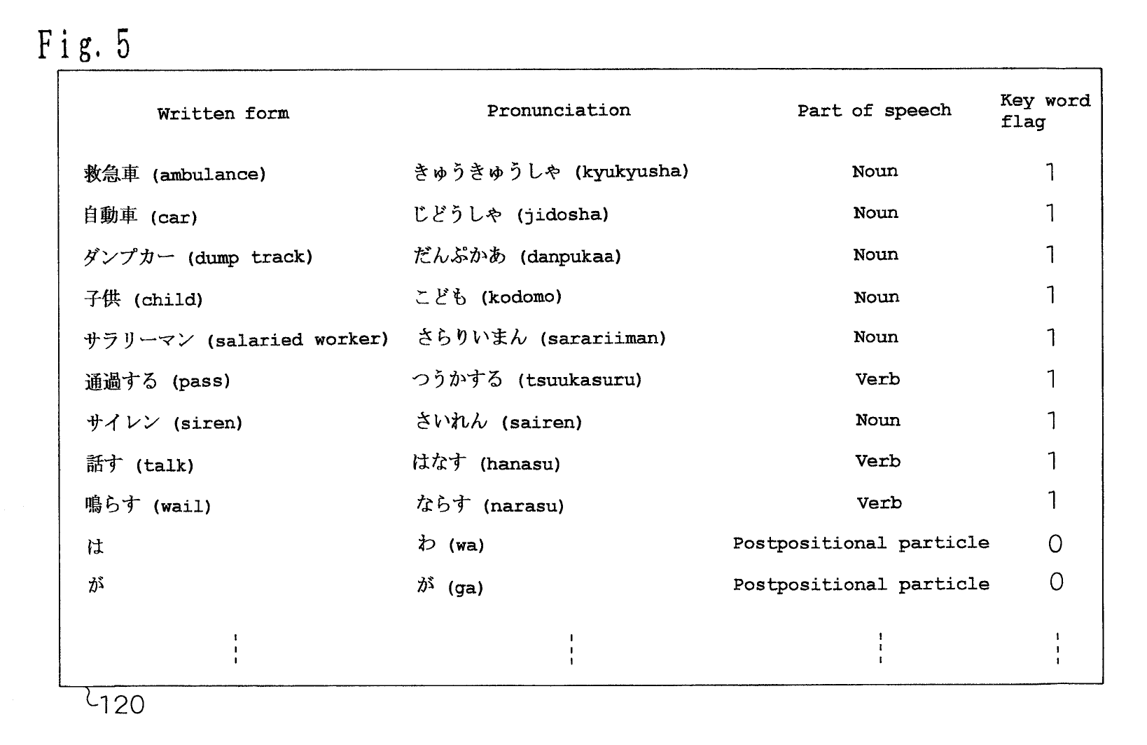

Specifically, it is assumed that the text input to the text input portion 110 is an input text 700 as shown in FIG. 4. That is, it is assumed that a text “ [symbol] (kyukyusha ga sairen o narashita, An ambulance wailed its siren.)” is input to the text input portion 110.

Then, the key word extracting portion 130 performs morpheme analysis on the input text 700 by use of the key word information assigned dictionary 120 to assign language information such as the pronunciation and the part of speech. Moreover, the key word extracting portion 130 extracts, of the morphemes of the input text 700, ones assigned the key word flag in the key word information assigned dictionary 120 as key words. The key word extraction result 701 of FIG. 4 is key words extracted in this manner.

Then, the key word extracting portion 130 replaces the extracted key words with meaning tags with reference to the meaning class database 121. By further assigning language information such as the part of speech, the meaning tag assignment result 702 of FIG. 4 is obtained.

That is, a key word “ [symbol] (kyukyusha, ambulance)” is replaced with a meaning tag “ [symbol] (sharyo, vehicles)”, and is assigned information such as “general noun” and “subject” as the information such as the part of speech. A key word “ [symbol] (sairen, siren)” is replaced with a meaning tag “ [symbol] (onkyo, sound)· [symbol] (keikoku, warning)”, and is assigned information such as “general noun” and “object” as the information such as the part of speech. A key word “ [symbol] (narashita, wailed)” is replaced with a meaning tag “ [symbol] (otoshutsuryoku, output-sound)”, and is assigned information such as “verb” and “predicate” as the information such as the part of speech.

Then, the dependency relation analyzing portion 132 calculates the degree of coincidence between the meaning tag string of each syntactic unit extractedby the key word extracting portion 130 and each meaning tag set in the dependency relation database. Then, the standard sentence pattern searching portion 150 selects from the standard sentence pattern database 140 the standard sentence pattern corresponding to the meaning tag set having the highest degree of coincidence calculated by the dependency relation analyzing portion 132 (step 30).

Specifically, the dependency relation analyzing portion 132 forms meaning tag pairs by arbitrarily combining the meaning tags of the meaning tag assignment result 702 which is the string of the meaning tags extracted by the key word extracting portion 130. That is, from the meaning tag assignment result 702, three meaning tag pairs ( [symbol] (sharyo, vehicles)→ [symbol] (onkyo, sound)· [symbol] (keikoku, warning)), ( [symbol] (onkyo, sound)· [symbol] (keikoku, warning)→ [symbol] (otoshutsuryoku, output-sound)) and ( [symbol] (otoshutsuryoku, output-sound)→ [symbol] (sharyo, vehicles)) are formed as shown in the meaning tag combinations 703. Then, the dependency relation analyzing portion 132 compares the formed meaning tag combinations 703 and the meaning tag sets in the dependency relation database 122, and calculates the number of coinciding meaning tag pairs. In the example of FIG. 7(b), with respect to the meaning tag set “ [symbol] (sharyo, vehicles)→ [symbol] (onkyo, sound)· [symbol] (keikoku, warning)) [symbol] (onkyo, sound)· [symbol] (keikoku, warning)→ [symbol] (otoshutsuryoku, output-sound))”, two meaning tag pairs coincide with meaning tag pairs of the meaning tag combinations 703 formed by the dependency relation analyzing portion 132. In this case, the degree of coincidence of this meaning tag set is 2.

With respect to the meaning tag set [symbol] (sharyo, vehicles)→ [symbol] (ido, move))”, since it coincides with none of the meaning tag pairs of the meaning tag combinations 703 formed by the dependency relation analyzing portion 132, the degree of coincidence of this meaning tag set is 0. Moreover, in the example of FIG. 7(b), the dependency relation analyzing portion 132 calculates the degrees of coincidence of the other meaning tag sets to be 0.

Every time calculating the degree of coincidence of a meaning tag set, the dependency relation analyzing portion 132 notifies the standard sentence pattern searching portion 150 of the calculated degree of coincidence and the number of the standard sentence pattern in the standard sentence pattern database 140 corresponding to the meaning tag set the degree of coincidence of which is calculated.

Notified by the dependency relation analyzing portion 132 of the degree of coincidence and the number of the standard sentence pattern in the standard sentence pattern database 140 corresponding to the meaning tag set the degree of coincidence of which is calculated, the standard sentence pattern searching portion 150 selects from the standard sentence pattern database 140 the standard sentence pattern corresponding to the meaning tag set having the highest degree of coincidence. In the example of FIG. 7(b), the meaning tag set having the highest degree of coincidence is “( [symbol] (sharyo, vehicles)→ [symbol] (onkyo, sound)· [symbol] (keikoku, warning)), ( [symbol] (onkyo, sound)· [symbol] (keikoku, warning)→ [symbol] (otoshutsuryoku, output-sound)).” Therefore, as the standard sentence pattern corresponding to the meaning tag set, “ [symbol] (sharyo, vehicles): subject] [symbol] (ga) [symbol] (onkyo, sound)· [symbol] (keikoku, warning): object] [symbol] (o) [symbol] (otoshutsuryoku, output-sound): predicate]” is selected from the standard sentence pattern database 140 of FIG. 7(a) as shown in the selected standard sentence pattern 704.

Then, the standard sentence pattern searching portion 150 extracts the phoneme strings and the prosody information of the stereotyped parts of the selected standard sentence pattern (step 40).

Specifically, the standard sentence pattern searching portion 150 extracts the phoneme strings and the prosody information of “ [symbol] (ga)” and “ [symbol] (o)” which are the stereotyped parts of the selected standard sentence pattern 704. The phoneme strings and the prosody information are stored in the standard sentence pattern database 140 so as to be associated with the selected standard sentence pattern.

Then, the non-stereotyped part generating portion 160 compares the attributes of the non-stereotyped parts of the standard sentence pattern selected at step 40 and the language information assigned at step 20, and generates words corresponding to the non-stereotyped parts from the input text (step 50).

Specifically, the non-stereotyped parts correspond to the parts of the meaning tags such as the part of “ [symbol] (sharyo, vehicles): subject]” of the selected standard sentence pattern 704, and the key words of the input text corresponding to the meaning tags are changeable according to the input text. The attributes of the non-stereotyped parts are that the meaning tag “ [symbol] (sharyo, vehicles)” of the selected standard sentence pattern 704 is the subject, that the meaning tag “ [symbol] (onkyo, sound)· [symbol] (keikoku, warning)” is the object and that the meaning tag “ [symbol] (otoshutsuryoku, output-sound)” is the predicate. The language information assigned at step 20 is, as shown in the key word extraction result 701 and the meaning tag assignment result 702, information that “ [symbol] (kyukyusha, ambulance)” is a general noun and the subject, “ [symbol] (sairen, siren)” is a general noun and the object and “ [symbol] (narashita, wailed)” is a verb and the predicate.

Consequently, since the attribute of the meaning tag “ [symbol] (sharyo, vehicles)” is the subject and the language information of “ [symbol] (kyukyusha, ambulance)” is the subject, the non-stereotyped part generating portion 160 recognizes that they correspond to each other, and generates “ [symbol] (kyukyusha, ambulance)” as the word of the non-stereotyped part of “ [symbol] (sharyo, vehicles).” Likewise, the non-stereotyped part generating portion 160 generates “ [symbol] (sairen, siren)” for the meaning tag “ [symbol] (onkyo, sound)· [symbol] (keikoku, warning).” For the meaning tag “ [symbol] (otoshutsuryoku, output-sound)”, the non-stereotyped part generating portion 160 generates “ [symbol] (narashita, wailed).” By applying the words of the non-stereotyped parts to the standard sentence pattern in this manner, a sentence “< [symbol] (kyukyusha, ambulance)> [symbol] (ga)< [symbol] (sairen, siren)> [symbol] (o)< [symbol] (narashita, wailed)>∘” is obtained as shown in the application to the standard sentence pattern 705.

While in this embodiment, the non-stereotyped part generating portion 160 compares the attributes of the non-stereotyped parts of the standard sentence pattern selected at step 40 and the language information assigned at step 20, and generates words corresponding to the non-stereotyped parts from the input text (step 50), the correspondence between key words and meaning tags may be held when a meaning tag is assigned to each key word at step 20 so that words corresponding to the non-stereotyped parts are generated by use of the correspondence instead of by comparing the language information.

The prosody control portion 172 searches the non-stereotyped part prosody database 171 by use of at least one of the phoneme strings, the numbers of morae and the accents of the non-stereotyped parts generated at step 50, the positions of the non-stereotyped parts in the sentence, the presence or absence and the durations of pauses between the non-stereotyped parts and the stereotyped parts, and the accent types of the stereotyped parts adjoining the non-stereotyped parts (step 60), and extracts the prosody information of the non-stereotyped parts in units of accent phrases (step 70).

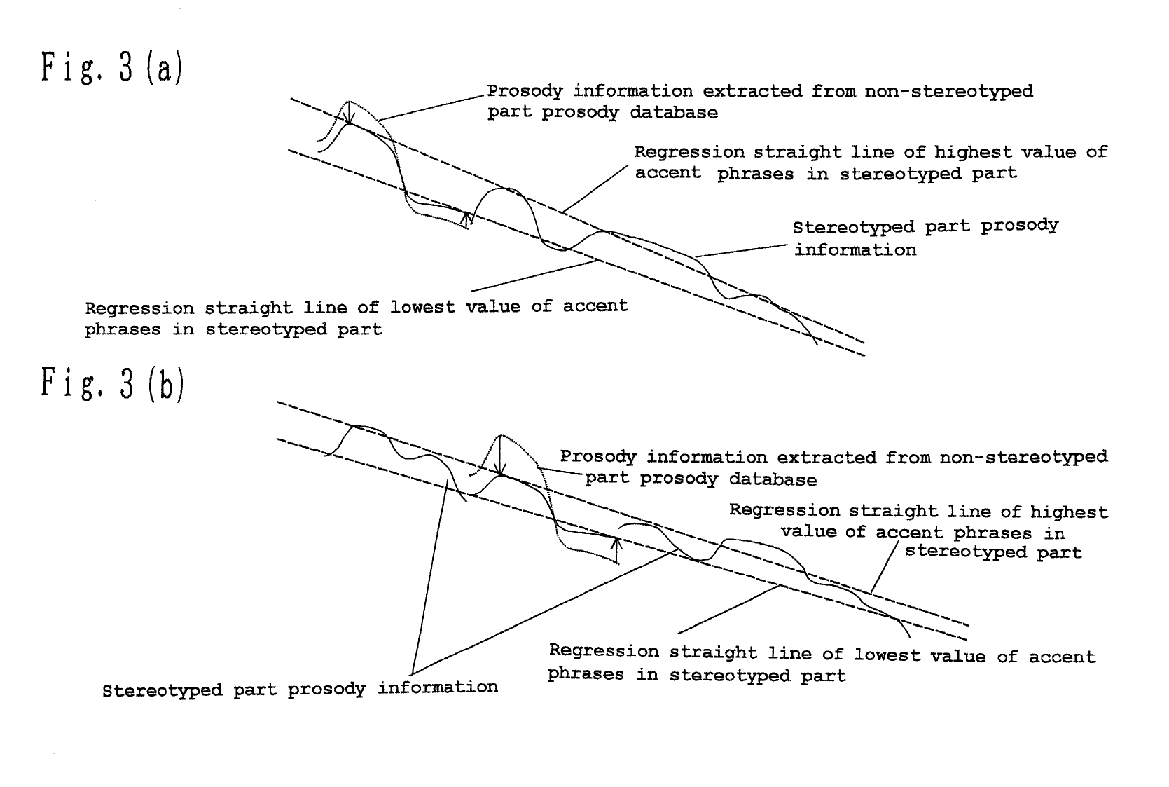

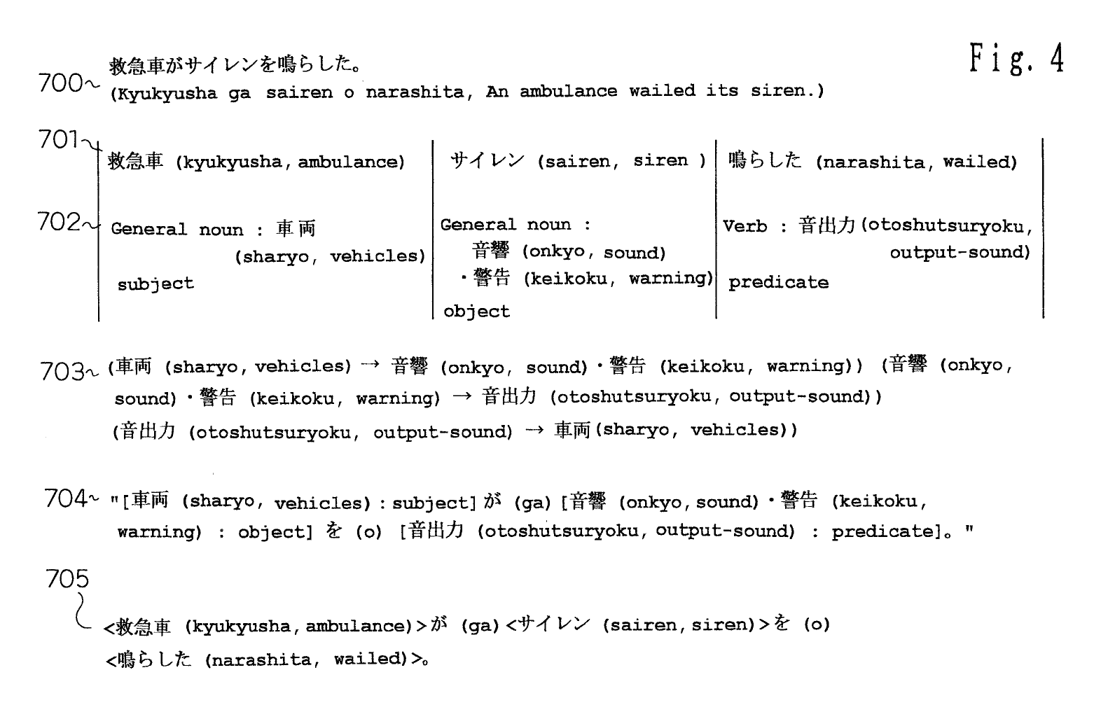

Then, the prosody control portion 172 adjusts the prosody information of the non-stereotyped parts extracted at step 60 based on the non-stereotyped part prosody adjustment parameters of the standard sentence pattern mapped at step 40, and connects the adjusted prosody information to the prosody information of the stereotyped parts extracted at step 40. The adjustment is performed, for example, as shown in FIG. 3(a) or 3(b) (step 80)

FIG. 3(a) shows a case where a stereotyped part is present only on one side of a non-stereotyped part. In this case, first, the regression straight line of the highest value of the prosody information of the accent phrases in the stereotyped part and the regression straight line of the lowest value of the prosody information of the accent phrases in the stereotyped part are obtained. Then, the prosody information of the accent phrases in the non-stereotyped part is adjusted so that the prosody information of the accent phrases in the non-stereotyped part is present between the regression straight line of the highest value and the regression straight line of the lowest value.

FIG. 3(b) shows a case where a stereotyped part is present on each side of a non-stereotyped part. First, like in the case of FIG. 3(a), the regression straight line of the highest value of the prosody information of the accent phrases in the stereotyped part and the regression straight line of the lowest value of the prosody information of the accent phrases in the stereotyped part are obtained. In this case, however, the regression straight line of the highest value and the regression straight line of the lowest value are obtained in consideration of the prosody information of the accent phrases in the stereotyped parts present on both sides of the non-stereotyped part. Then, the prosody information of the accent phrases in the non-stereotyped part is adjusted so that the prosody information of the accent phrases in the non-stereotyped part is present between the regression straight line of the highest value and the regression straight line of the lowest value.

The waveform generating portion 174 generates a speech waveform by use of phoneme pieces stored in the phoneme piece database 173 based on the phoneme strings of the stereotyped parts extracted at step 40, the phoneme strings of the non-stereotyped parts generated at step 50 and the prosody information generated at step 80 (step 90).

The speech waveform generated at step 90 is output as a speech from the output portion 180 (step 100).

As described above, according to the system for providing information by speech of this embodiment, by use of the speech synthesizing portion that realizes synthetic speech with high naturalness by using stereotyped sentences for a given text by extracting the meaning of the input text, converting it to a standard sentence pattern having an equal meaning and synthesizing a speech, information can be accurately provided by natural speech.

Further, even when a given text is input, information can be accurately provided by natural speech.

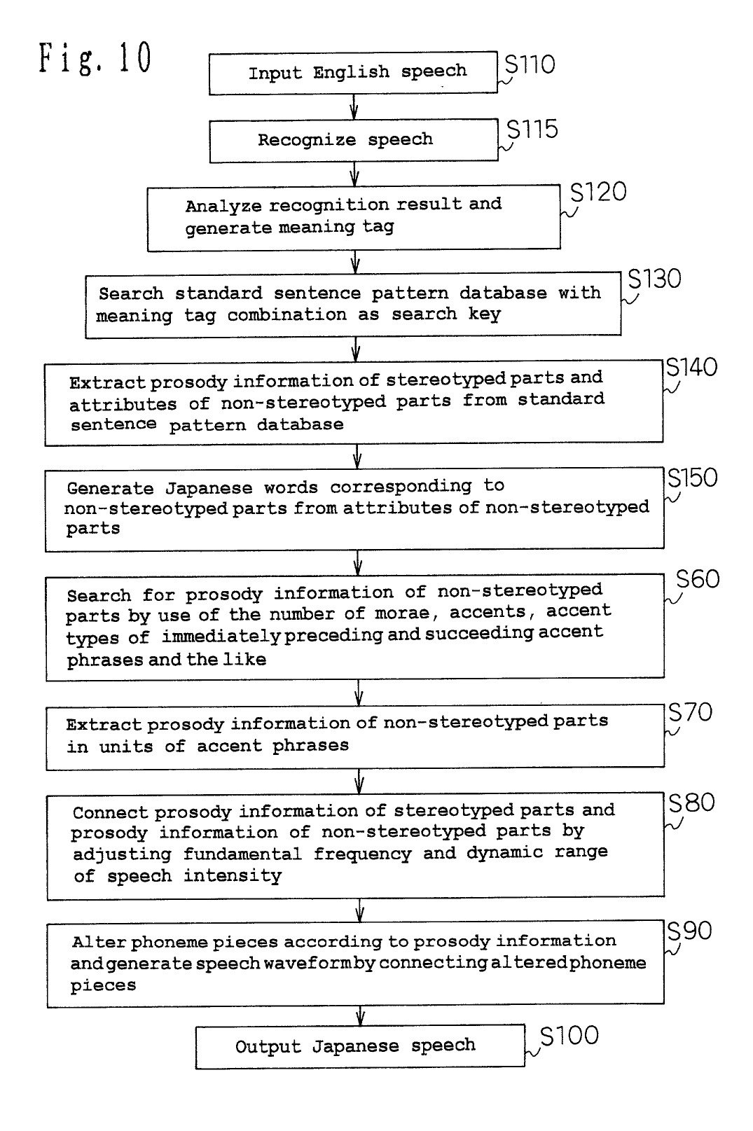

An example different from the above-described one is shown in FIG. 8. FIG. 8 shows a case where at step 20, the input text is an input text 400 “A [symbol] [symbol] (Eishi iwaku, “geijutsu wa bakuhatsuda”, Mr. A says, “Art is an explosion.”).” By performing morpheme analysis on this text data, a morpheme analysis result 401 is obtained. Then, language information such as the pronunciation and the part of speech is assigned to each morpheme. For example, with respect to the morpheme “A”, the pronunciation is “ [symbol] (ei)” and the part of speech is a noun, and with respect to the morpheme “ [symbol] (Mr.)”, the pronunciation is “ [symbol] (shi)” and the part of speech is a suffix. Then, syntactic analysis of the morpheme analysis result 401 assigned language information is performed, and a meaning tag is assigned to each syntactic unit, so that a meaning tag assignment result 402 is obtained. In this embodiment, clauses are used as syntactic units like in the above-described embodiment. That is, “ [symbol] (eishi, Mr. A)” is assigned a meaning tag “ [symbol] (jinbutsu, person)”, and “ [symbol] (iwaku, say)” is assigned a meaning tag “ [symbol] (iu, say).” The part of the excerpt is regarded as one clause, and “ [symbol] (geijutsu wa bakuhatsuda, Art is an explosion)” is assigned “ [symbol] (inyo, excerpt).”

Then, when it is assumed that the standard sentence pattern selected at step 30 is [“ [symbol] (jinbutsu, person): subject] [symbol] (ga)[ [symbol] (inyo, excerpt): object] [symbol] (to)[ [symbol] (iu, say): predicate]”, the result of application of non-stereotyped parts to the standard sentence pattern in a manner similar to that of the above-described steps is “< [symbol] (eishi, Mr. A)> [symbol] (ga)<┌ [symbol] (geijutsu wa bakuhatsuda, Art is an explosion)> [symbol] (to)< [symbol] (iwaku, say)> [symbol] .”As described above, when an input text is provided as a speech, the word order is sometimes inverted according to the standard sentence pattern, and even in such a case, information can be provided by natural speech reflecting the meaning of the input text.

The key word extracting portion 130, the dependency relation analyzing portion 132, the standard sentence pattern searching portion 150 and the non-stereotyped part generating portion 160 in this embodiment are an example of the analyzing means in the present invention. The speech synthesizing portion 170 in this embodiment is an example of the speech synthesizing means in the present invention. The input text of this embodiment is an example of the input sentence in the present invention. The key word information assigned dictionary 120 and the meaning class database 121 in this embodiment are an example of the relation information in the present invention. Extracting key words in this embodiment is an example of extracting all or some of the words in the present invention. Extracting as key words morphemes assigned the key word flag in this embodiment is an example of extracting all or some of the words based on the predetermined criterion in the present invention. The meaning tags in this embodiment are an example of the standard words in the present invention. The non-stereotyped part generating portion 160 comparing the attributes of the non-stereotyped parts of the standard sentence pattern selected at step 40 and the language information assigned at step 20 and generating words corresponding to the non-stereotyped parts from the input text (step 50) in this embodiment is an example of replacing all or some of the standard words of the selected standard sentence pattern with the corresponding words.

While in this embodiment, the meaning tags associate key words with classes into which words are divided based on superordinate concepts, parts of speech, clause attributes and the like as shown in thesauruses, they may associate key words with concepts or concepts of the same levels. Further, in this embodiment, the meaning class database 121 is not limited to the example shown in FIG. 6, but may be any database that determines the rule for associating key words with meaning tags. To sum up, the relation information in the present invention may be any information where the predetermined standard words are related to words relevant to the standard words.

While in this embodiment, morphemes assigned the key word flag in the key word information assigned dictionary 120 are extracted as key words from the input text 700 and the key word flag is assigned to all the content words in the example of FIG. 5, by assigning the key word flag only to words frequently used for a specific case such as a case where a person rides a vehicle, provision of information on the specific case by speech can be efficiently performed. In such a case, not all the morphemes occurring in the input text 700 are assigned the key word flag in the key word information assigned dictionary 120. Therefore, in such a case, there are cases where not all the morphemes in the input text 700 are extracted as key words but only some of them are extracted as key words.

The analyzing means in the present invention is not limited to one that generates all the words corresponding to the meaning tags which are the non-stereotyped parts of the standard sentence pattern like the non-stereotyped part generating portion 160 in this embodiment. When a key word corresponding to a meaning tag of a non-stereotyped part of the standard sentence pattern is a word the same as the meaning tag, it is unnecessary to generate the word corresponding to the meaning tag. Moreover, when the input text includes an error, there are cases where the key word corresponding to a meaning tag of the standard sentence pattern is not found. In such cases, it is not always necessary for the non-stereotyped part generating portion 160 to generate the key word corresponding to the meaning tag. A case where the input text includes an error will be described in detail in an embodiment described later. To sum up, it is necessary for the analyzing means in the present invention only to replace all or some of the standard words of the selected standard sentence pattern with the corresponding words.

While the key word extracting portion 130 in this embodiment replaces the extracted key words with meaning tags by use of the meaning class database 121, it is not always necessary to use the meaning class database 121. That is, the key word extracting portion 130 may use the extracted key words as they are. In this case, the dependency relation analyzing portion 132 forms key word combinations instead of meaning tag combinations. In the dependency relation database 122, key word sets in which the parts of the meaning tags of the meaning tag sets are replaced by key words are stored. Consequently, the dependency relation analyzing portion 132 calculates the degree of coincidence between the key word combinations and the key word sets. In the standard sentence pattern database 140, standard sentence patterns in which the non-stereotyped parts of the standard sentence patterns are replaced with key words instead of meaning tags are stored. Since the key words are not replaced with meaning tags, the non-stereotyped part generating portion 160 is unnecessary. In this case, as the criterion for deciding which morphemes of the input text are selected as key words, the words included in standard sentence patterns stored in the standard sentence pattern database 140 are selected as key words. Therefore, of the words in the key word information assigned dictionary 120, only words satisfying this criterion are assigned the key word flag. As described above, information provision by speech can also be performed when the standard sentence pattern consists of only stereotyped parts.

While in this embodiment, the dependency relation analyzing portion 132 calculates the degree of coincidence between the meaning tag combinations 703 of FIG. 4 and the meaning tag sets of FIG. 7(b) by determining whether the meaning tag pairs of these coincide with each other or not, the present invention is not limited thereto. The degree of coincidence may be calculated by a general computational expression as shown in the following expression 1:

$$d = {\sum }_{i = 1}^{m} {\sum }_{j = 1}^{n} {w}_{ij} {C}_{ij} \qquad [ Expression 1 ]$$

Here, d is the degree of coincidence, 1 . . . i . . . m is the dimension (attribute) setting the dependency relation, 1 . . . j . . . n is the kind of the dependency relation, w is the weight of the meaning tag pair, C is the coinciding meaning tag pair, and takes the following two values: 1 when the meaning tag pair coincides; and 0 when it does not coincide. By calculating the degree of coincidence based on the expression 1, the degree of coincidence can be obtained with higher degree of accuracy.

While the phoneme duration pattern is used as the prosody information in this embodiment, the speech rate (the rate of speech) may be used instead of the phoneme duration pattern.

While the prosody is controlled by a method as shown at steps 60 to 80 of FIG. 2, the prosody may be controlled by a method other than this method. Hereinafter, with respect to such a modification, mainly differences from the above-described embodiment will be described.

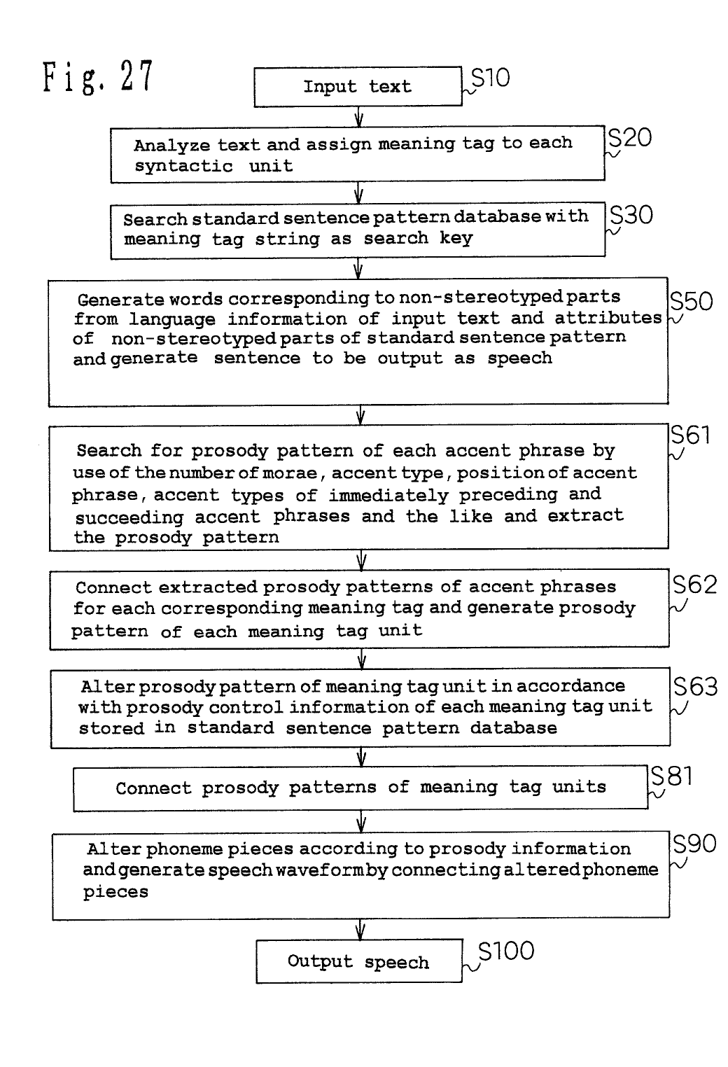

FIG. 26 is a functional block diagram showing the structure of a system for providing information by speech according to this modification. FIG. 26 is different from FIG. 1 in that the standard sentence pattern database 140 of FIG. 1 is replaced by a standard sentence pattern database 140a in FIG. 26, that the non-stereotyped part prosody database 171 of FIG. 1 is replaced by a prosody database 171a in FIG. 26, and that the key word information assigned dictionary 120 of FIG. 1 is replaced by a key word information and accent phrase information assigned dictionary 120a in FIG. 26.

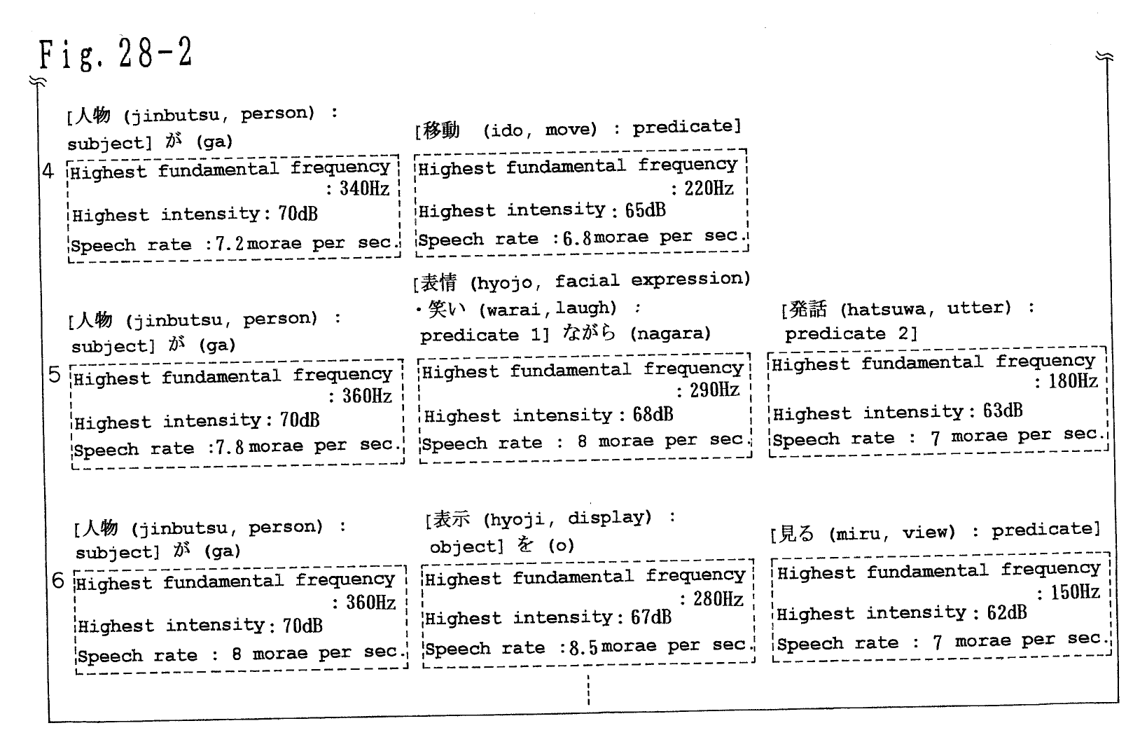

That is, while the standard sentence pattern database 140 as shown in FIG. 7(a) is used in the above-described embodiment, in this modification, the standard sentence pattern database 140a shown in FIG. 28 is used instead. That is, in the standard sentence pattern database 140 shown in FIG. 7(a), prosody information such as adjustment parameters of stereotyped part phoneme strings, stereotyped part prosody patterns and non-stereotyped part prosody patterns is stored so as to be associated with each standard sentence pattern such as “[ [symbol] (sharyo, vehicles): subject] [symbol] (ga)[ [symbol] (onkyo, sound)· [symbol] (keikoku, warning): object] [symbol] (o)[ [symbol] (otoshutsuryoku, output-sound): predicate].”On the contrary, in the standard sentence pattern database 140a shown in FIG. 26, prosody control information is previously associated with each meaning tag unit of each standard sentence pattern. Here, meaning tag units are units into which a standard sentence pattern is divided at each meaning tag. That is, one meaning tag unit includes, of a standard sentence pattern, one meaning tag and a word other than the meaning tag that is present between the meaning tag and the next meaning tag. Each meaning tag unit is associated with prosody control information for controlling the prosody of the meaning tag unit as the prosody information.

For example, in the example of FIG. 28, the first standard sentence pattern “[ [symbol] (sharyo, vehicles): subject] [symbol] (ga)[ [symbol] (onkyo, sound)· [symbol] (keikoku, warning): object] [symbol] (o) [symbol] (otoshutsuryoku, output-sound): predicate]”has three meaning tag units “[ [symbol] (sharyo, vehicles): subject] [symbol] (ga)”, “[ [symbol] (onkyo, sound)· [symbol] (keikoku, warning): object] [symbol] (o)”and “[ [symbol] (otoshutsuryoku, output-sound): predicate].”

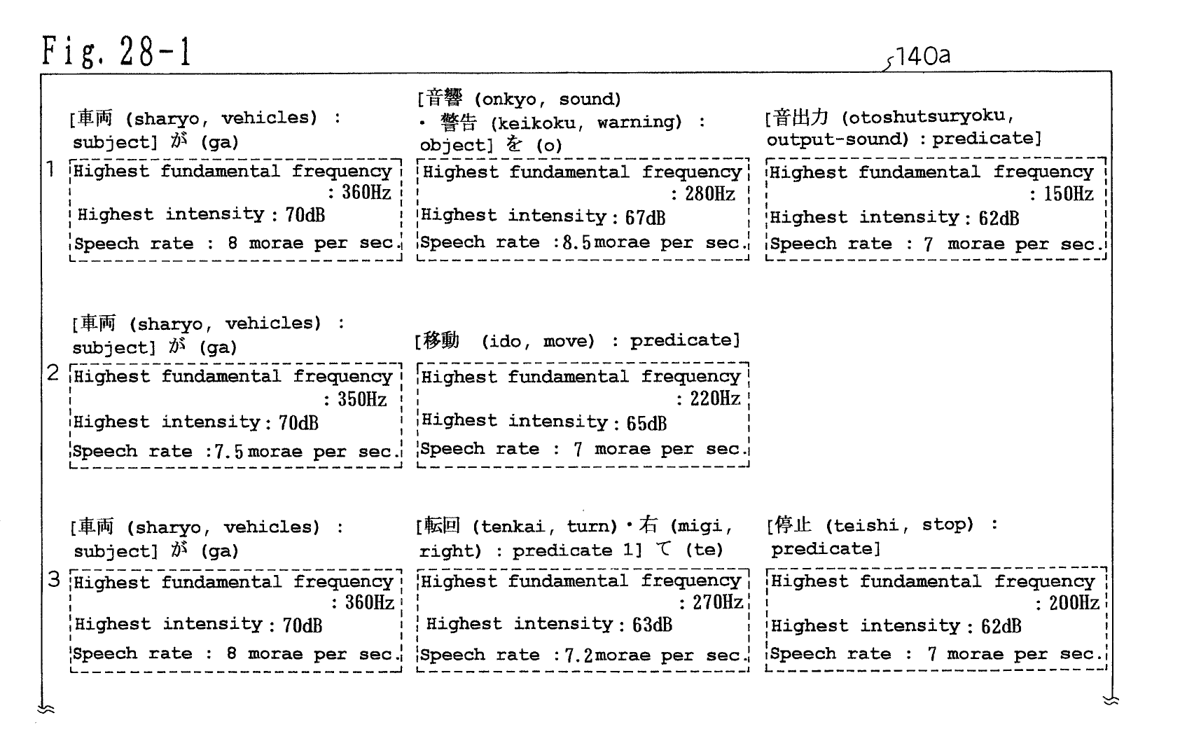

The meaning tag unit “[ [symbol] (sharyo, vehicles): subject] [symbol] (ga)”is associated with prosody control information that the highest fundamental frequency (the highest value of the fundamental frequency) is 360 Hz, the highest intensity (the highest value of the sound pressure) is 70 dB and the speech rate (the rate of speech) is 7.5 morae per second. The meaning tagunit “[ [symbol] (onkyo, sound)· [symbol] (keikoku, warning): object] [symbol] (o)” is associated with prosody control information that the highest fundamental frequency is 280 Hz, the highest intensity is 67 dB and the speech rate is 8.5 morae per second. The meaning tag unit “[ [symbol] (otoshutsuryoku, output-sound): predicate]” is associated with prosody control information that the highest fundamental frequency is 150 Hz, the highest intensity is 62 dB and the speech rate is 7 morae per second. In the second and succeeding standard sentence patterns of FIG. 27, prosody control information is similarly assigned to meaning tag units.

As described above, unlike the above-described embodiment, in the standard sentence pattern database 140a, the prosody information is not divided into that of stereotyped parts and that of non-stereotyped parts, and each meaning tag unit is associated with prosody control information as the prosody information.

In the non-stereotyped part prosody database 171 of the above-described embodiment, prosody information of each non-stereotyped part such as the phoneme string, the number of morae, the accent, the position in the sentence, the presence or absence and the durations of immediately preceding and succeeding pauses (silent condition), the accent types of the immediately preceding and succeeding accent phrases and the like are stored. On the contrary, in the prosody database 171a of this modification, the prosody patterns of the accent phrases are classified according to the number of morae, the accent type, the position of the accent phrase, the accent types of the immediately preceding and succeeding accent phrases and the like. The prosody patterns in the non-stereotyped part prosody database 171a may be further classified according to the presence or absence and the durations of pauses immediately before and after the accent phrase and the like. Therefore, by specifying as the search keys the number of morae, the accent type, the position of the accent phrase and the accent types of the accent phrases immediately before and after the accent phrase, the prosody pattern corresponding to the specified number of morae, accent type, position of the accent phrase and accent types of the accent phrases immediately before and after the accent phrase can be identified from among the prosody patterns stored in the prosody database 171a, and the identified prosody pattern can be extracted. The prosody pattern in this case is, for example, prosody information such as a fundamental frequency pattern, an intensity pattern and a phoneme duration pattern of a speech which are previously extracted from a naturally generated speech. The prosody database 171a is a database as described above.

Hereinafter, the operation of this modification will be described.

FIG. 27 is a flowchart of the operation of this modification.

The operations of steps 10, 20 and 30 are similar to those of the above-described embodiment. When the operation of step 30 is finished, like in the above-described embodiment, “[ [symbol] (sharyo, vehicles): subject] [symbol] (ga)[ [symbol] (onkyo, sound)·(keikoku, warning): object](o)[(otoshutsuryoku, output-sound): predicate]” is selected from the standard sentence pattern database 140a of FIG. 26 as shown in the selected standard sentence pattern 704 of FIG. 4.

Then, at step 50, like in the above-described embodiment, by applying the words of the non-stereotyped parts to the standard sentence pattern, a sentence “ [symbol] (kyukyusha, ambulance) [symbol] (ga)< [symbol] (sairen, siren) [symbol] (o) [symbol] (narashita, wailed)>∘” is obtained as shown in the application to the standard sentence pattern 705 of FIG. 4. At this point of time, the phoneme string, the number of morae and the accent type of each accent phrase of the sentence “ [symbol] (kyukyusha, ambulance) [symbol] (ga) [symbol] (sairen, siren) [symbol] (o)< [symbol] (narashita, wailed)> [symbol] ” are generated based on the pronunciation and the accent information extracted from the key word information and accent information assigned dictionary 120a for each key word. Moreover, information such as the position of the accent phrase in the sentence, the presence or absence and the duration of a pause between accent phrases and the accent types of the accent phrases immediately before and after the accent phrase is also obtained from the generated sentence.

The accent phrase will be described. For example, in a sentence “ [symbol] [symbol] (kyukyusha to shobosha to patoka toga, An ambulance, a fire engine and a patrol car.)”, [symbol] (kyukyusha to, an ambulance)”, [symbol] (shobosha to, a fire engine)” and [symbol] (patoka toga, and a patrol car)” are each one accent phrase. Moreover, for example, [symbol] (kyukyusha ga sairen o narashita, An ambulance wailed its siren.)” has three accent phrases “ [symbol] (kyukyusha ga, An ambulance)”, “ [symbol] (sairen o, its siren)” and “ [symbol] (narashita, wailed)∘.” As described above, the accent phrase is a phoneme string including one or more morae and serving as a unit for controlling the prosody in speech synthesis.

Explaining the accent phrase “ [symbol] (kyukyusha ga, An ambulance)”, since the accent phrase “ [symbol] (kyukyusha ga, An ambulance)” includes six morae “ [symbol] (kyu)”, “(u)”, “ [symbol] (kyu)”, “(u)”, “ [symbol] (sha)” and “ [symbol] (ga)”, the number of morae is six. Moreover, since the accent is on the third mora “ [symbol] (kyu)”, the accent type is a type having the accent on the third mora (hereinafter, an accent phrase having the accent on the N-th mora will be referred to as N type). Thus, with respect to the accent phrase “ [symbol] (kyukyusha ga, An ambulance)”, the number of morae is six and the accent type is 3 type. As described above, when the sentence “ [symbol] (kyukyusha, ambulance) [symbol] (ga) [symbol] (sairen, siren)> [symbol] (o)< [symbol] (narashita, wailed)>∘” is obtained as step 50, information representative of the phoneme string, the number of morae and the accent type of each accent phrase of the sentence [symbol] (kyukyusha, ambulance) [symbol] (ga)< [symbol] (sairen, siren)> [symbol] (o) [symbol] (narashita, wailed)>∘” is also generated.

Then, the prosody information control portion 172 searches the prosody database 171a for the prosody pattern of each accent phrase by using as the search keys at least one of the number of morae and the accent type of the accent phrase, the position of the accent phrase, the accent types of the accent phrases immediately before and after the accent phrase, and extracts the prosody pattern coinciding with the search keys (step 61).

For example, with respect to the accent phrase “ [symbol] (kyukyusha ga, An ambulance)”, the number of morae is six and the accent type is 3 type as mentioned above. Moreover, the position of this accent phrase is the head of the sentence. Moreover, no accent phrase is present immediately before this accent phrase, and the accent phrase immediately thereafter is “ [symbol] (sairen o, its siren).” Since the accent phrase “ [symbol] (sairen o, its siren)” includes five morae “ [symbol] (sa)”, “ [symbol] (i)”, “ [symbol] (re)”, “ [symbol] (n)” and “ [symbol] (o)”, the number of morae is five. Since the accent is on the first mora “ [symbol] (sa)”, the accent type is 1 type. Therefore, with respect to the accent types of the accent phrases immediately before and after the accent phrase “ [symbol] (kyukyusha ga, An ambulance)”, no accent phrase is present immediately before the accent phrase, and the accent type of the accent phrase immediately after the accent phrase is 1 type. Therefore, as the prosody pattern corresponding to the accent phrase “ [symbol] (kyukyusha ga, An ambulance)”, prosody information such as the fundamental frequency pattern, the intensity pattern and the phoneme duration pattern of a speech which is the prosody pattern in a case where the number of morae is six, the accent type is 3 type, the accent phrase is at the head of the sentence, and the accent type of the immediately succeeding accent phrase is 1 type is extracted.

Then, the prosody control portion 172 connects the prosody patterns extracted at step 61 for each meaning tag unit, and generates the prosody pattern of each meaning tag unit (step 63).

That is, the meaning tag unit corresponding to the accent phrase “ [symbol] (kyukyushaga, An ambulance)” is “[ [symbol] (sharyo, vehicles): subject] [symbol] (ga)”, and in this case, since the accent phrase and the meaning tag unit are in a one-to-one correspondence with each other, it is unnecessary to connect accent phrases. However, for example, the part corresponding to the meaning tag unit “[ [symbol] (sharyo, vehicles): subject] [symbol] (ga)” is a sentence “ [symbol] (kyukyusha to shobosha to patoka toga, An ambulance, a fire engine and a patrol car)”, the three accent phrases “ [symbol] (kyukyusha to, An ambulance)”, “ [symbol] (shobosha to, a fire engine)” and “ [symbol] (patoka toga, and a patrol car)” correspond to the meaning tag unit “[ [symbol] (sharyo, vehicles): subject] [symbol] (ga).” Therefore, in this case, the prosody patterns of these three accent phrases are connected to generate the prosody pattern of the meaning tag unit.

Then, the prosody control portion 172 alters the prosody pattern of each meaning tag unit in accordance with the prosody control information of each meaning tag unit stored in the standard sentence database (step 63).

For example, the prosody control information of a meaning tag unit “[ [symbol] (sharyo, vehicles): subject] [symbol] (ga)” of a standard sentence pattern “[ [symbol] (sharyo, vehicles): subject] [symbol] (ga)[ [symbol] (onkyo, sound) [symbol] (keikoku, warning): object] [symbol] (o)[ [symbol] (otoshutsuryoku, output-sound): predicate]” is such that the highest fundamental frequency is 360 Hz, the highest intensity is 70 dB and the speech rate is 8 morae per second as shown in FIG. 28. Therefore, the prosody pattern of the meaning tag unit generated at step 63 is altered so as to coincide with such prosody control information. That is, the prosody pattern is altered so that the highest value of the fundamental frequency pattern of the speech of the prosody pattern is 360 Hz, that the highest value of the intensity pattern of the prosody pattern is 70 dB and that the phoneme duration pattern is a speech rate of 8 morae per second. Similar processing is performed on the prosody pattern of the meaning tag unit “[ [symbol] (onkyo, sound)· [symbol] (keikoku, warning): object] [symbol] (o)” and the prosody pattern of the meaning tag unit “[ [symbol] (otoshutsuryoku, output-sound): predicate].”

Then, the prosody control portion 172 connects the altered prosody patterns of the meaning tag units (S81). That is, the prosody pattern of the meaning tag unit “[ [symbol] (sharyo, vehicles): subject] [symbol] (ga)”, the prosody pattern of the meaning tag unit “[ [symbol] (onkyo, sound)· [symbol] (keikoku, warning): object] [symbol] (o)” and the prosody pattern of the meaning tag unit “[ [symbol] (otoshutsuryoku, output-sound): predicate]” are connected in this order. In this manner, the prosody pattern of the sentence “ [symbol] [symbol] (kyukyusha ga sairen o narashita, An ambulance wailed its siren.)” is generated.

Then, the waveform generating portion 173 reads phoneme pieces from the phoneme piece database 173, alters the read phoneme pieces according to the generated prosody pattern, and connects them, thereby generating a speech waveform (step 90).

Then, the output portion 180 outputs the generated speech waveform to the outside (S100). In this manner, a speech “ [symbol] (kyukyusha ga sairen o narashita, An ambulance wailed its siren.)” is output.

While prosody patterns are extracted in units of accent phrases in the above-described modification, prosody patterns may be extracted in units of clauses or words. When prosody patterns are extracted in units of clauses, the prosody pattern of each clause is previously stored in the prosody database 171a. The extracted prosody patterns are connected for each meaning tag unit like in the above-described modification. When prosody patterns are extracted in units of words, the prosody pattern of each word is previously stored in the prosody database 171a, The extracted prosody patterns are connected for each meaning tag unit like in the above-described modification.

Further, while in the above-described modification, the meaning tag units in the standard sentence pattern database 140a of FIG. 26 are each assigned the prosody control information such as the highest fundamental frequency (the highest value of the fundamental frequency), the highest intensity (the highest value of the sound pressure) and the speech rate (the rate of speech), the present invention is not limited thereto. Prosody information such as the lowest fundamental frequency (the lowest value of the fundamental frequency) and the lowest intensity (the lowest value of the sound pressure) may also be assigned. Moreover, prosody control information such as the phoneme duration may be assigned.

While the speech rate is used in the above-described modification, the present invention is not limited thereto. The phoneme duration pattern may be used instead of the speech rate. Moreover, both the speech rate and the phoneme duration may be used.

While morae are used in this embodiment, the present invention is not limited thereto. Syllables may be used instead of morae. In this case, when the number of morae is used in this embodiment, the number of syllables is used instead.

It is to be noted that this modification is applicable not only to the above-described embodiment but also to second and succeeding embodiments.

The prosody information of the present invention includes prosody patterns such as the fundamental frequency pattern, the intensity pattern and the phoneme duration pattern of the speech of each accent phrase extracted by searching the prosody database 171a in this embodiment. Moreover, the prosody information of the present invention includes prosody control information assigned to each meaning tag unit in the standard sentence database, that is, the highest fundamental frequency (the highest value of the fundamental frequency), the highest intensity (the highest value of the sound pressure) and the speech rate (the rate of speech) of each accent phrase.

Further, while the prosody information of the present invention has been described as prosody patterns associated with conditions such as the number of morae and the accent type of the accent phrase, the position of the accent phrase and the accent types of the accent phrases immediately before and after the accent phrase, the present invention is not limited thereto. It is necessary for the prosody information of the present invention only to be associated with at least one of the following conditions: the phoneme string; the number of morae; the number of syllables; the accent; the position in the sentence; the presence or absence and the duration of an immediately preceding or succeeding pause; the accent type of the immediately preceding or succeeding accent phrase; the prominence; the string of parts of speech; the clause attribute; and the dependency relation.

Further, the prosody control information assigned to each meaning tag unit in this embodiment is an example of the prosody information previously assigned to at least the selected standard sentence pattern in the present invention. The prosody information assigned to the stereotyped parts in this embodiment is an example of the prosody information previously assigned to at least the selected standard sentence pattern in the present invention. The prosody information of the non-stereotyped parts extracted as a result of searching for the non-stereotyped part prosody database 171 by use of the phoneme strings, the numbers of morae and the accents of the non-stereotyped parts generated at step 50, the positions of the non-stereotyped parts in the sentence, the presence or absence and the durations of pauses between the non-stereotyped parts and the stereotyped parts, and the accent types of the stereotyped parts adjoining the non-stereotyped parts (step 60) in this embodiment is an example of the prosody information previously assigned to at least the selected standard sentence pattern in the present invention.

(Second Embodiment)

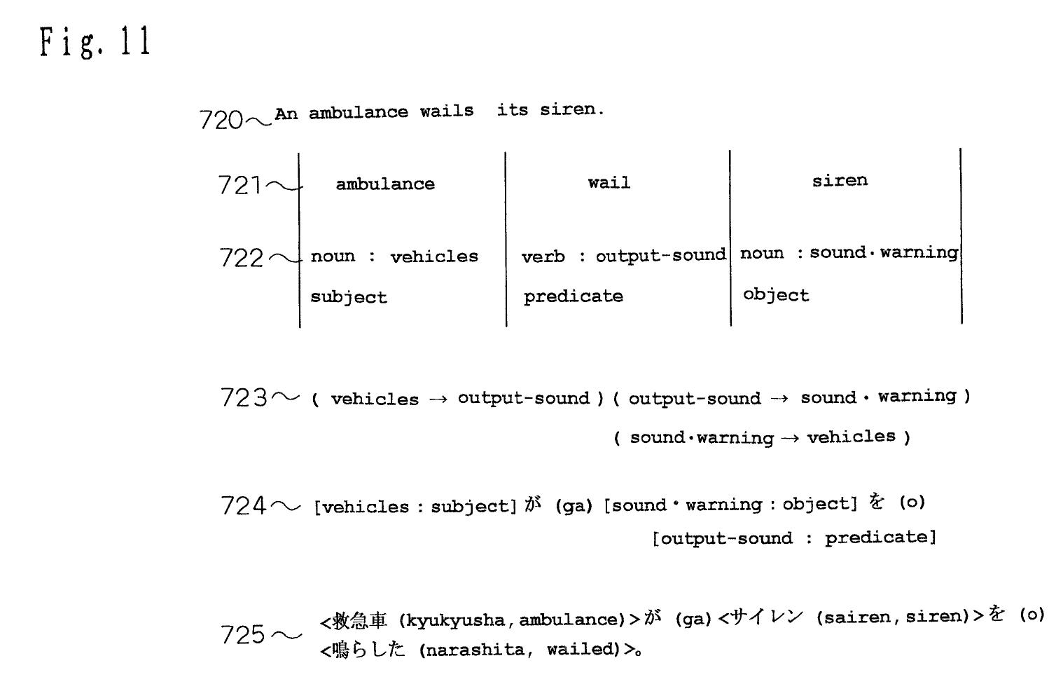

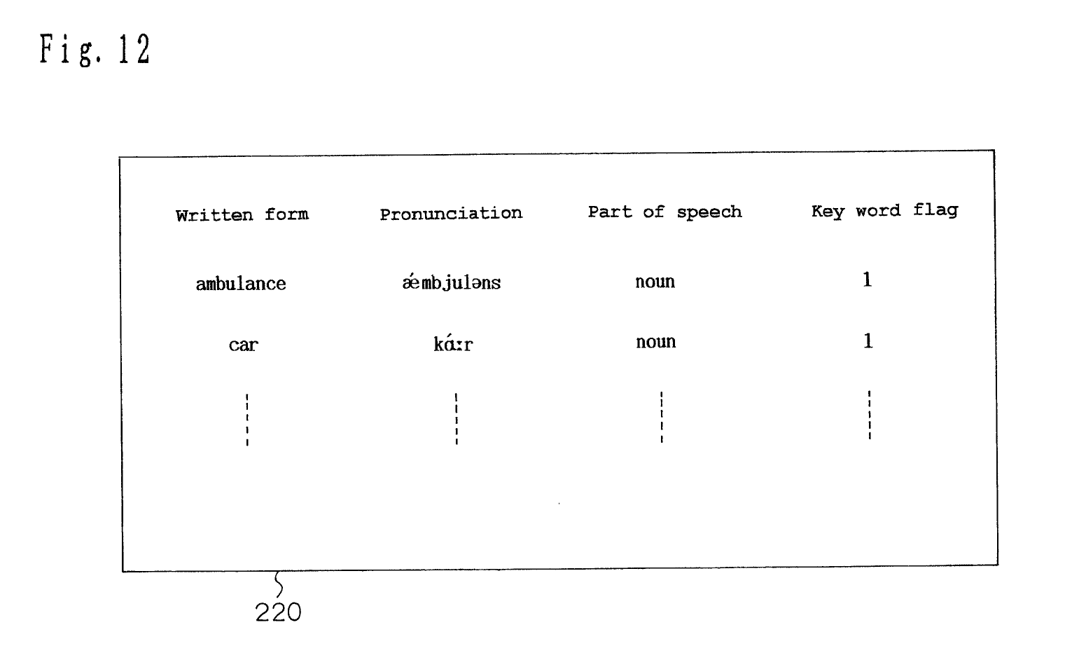

FIG. 9 is a functional block diagram showing the structure of a system for providing information by speech according to a second embodiment of the present invention. FIG. 10 is a flowchart of the operation of the system for providing information by speech according to the second embodiment of the present invention.

In FIG. 9, the same parts and elements as those of FIG. 1 are designated by the same reference numerals and will not be described, and only different parts and elements will be described. In the system for providing information by speech of FIG. 9 according to the second embodiment, the key word information assigned dictionary 120 of the structure of FIG. 1 is replaced by an English key word information assigned dictionary 220 used for English language processing, the meaning class database 121 is replaced by an English meaning class database 221 which is a meaning class database in English, the dependency relation database 122 is replaced by an English dependency relation database 222 which is a dependency relation database in English, and the standard sentence pattern database 140 is replaced by a Japanese standard sentence pattern database 240 which is a standard sentence pattern database in Japanese.

Moreover, the text input portion 110 of the structure of FIG. 1 is replaced by a speech input portion 210 for inputting a speech, and the key word extracting portion 130 is replaced by a speech recognizing and key word extracting portion 230 that recognizes the input speech and assigns meaning tags with reference to the English key word information assigned dictionary 220. Moreover, a Japanese dictionary 225 in which meaning tags and the Japanese words corresponding to the meaning tags are stored is added, and the non-stereotyped part generating portion 160 is replaced by a non-stereotyped part Japanese generating portion 260 that generates Japanese words corresponding to non-stereotyped parts with reference to the Japanese dictionary 225. Except these, the structure is the same as that of the first embodiment.

The operation of the system for providing information by speech structured as described above will be described with reference to FIG. 10.

In the system for providing information by speech according to this embodiment, like in the first embodiment, before providing information by speech, it is necessary to prepare the English key word information assigned dictionary 220, the English meaning class database 221, the English dependency relation database 222 and the Japanese standard sentence pattern database 240.

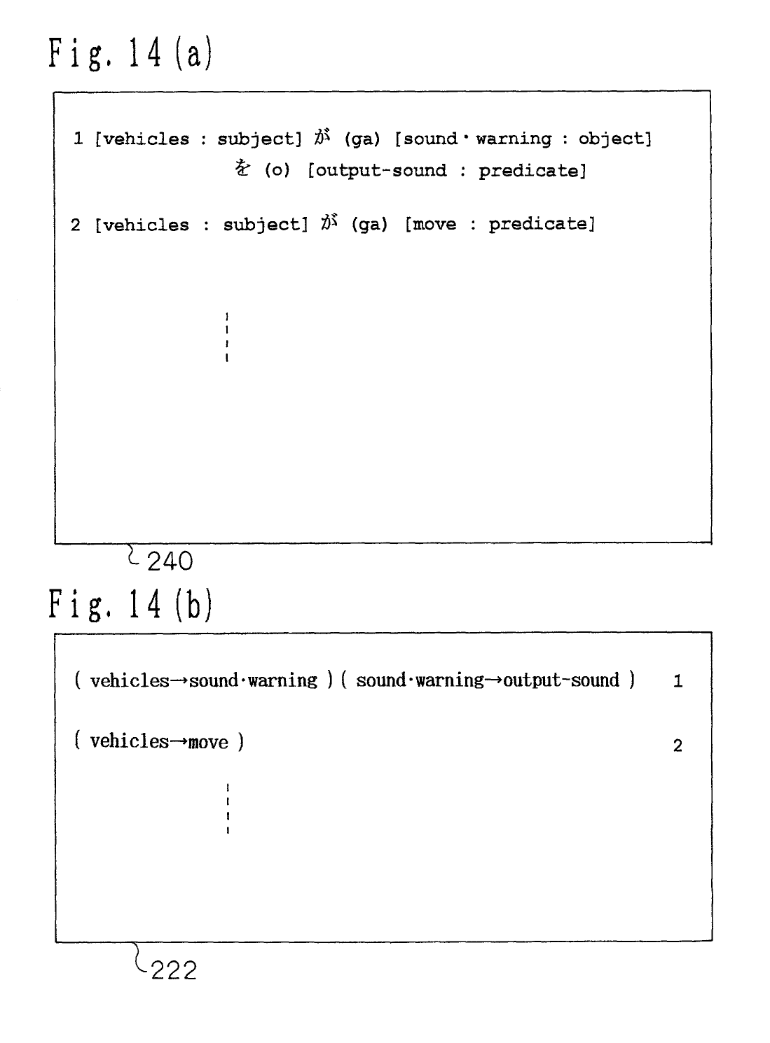

FIG. 12 shows an example of the English key word information assigned dictionary 220. In the English key word information assigned dictionary 220, information necessary for analysis of morphemes such as the written forms, the pronunciations, the parts of speech and the like of English sentences is stored, and English morphemes to be treated as key words are assigned the key word flag. With respect to “ambulance” of FIG. 12, the pronunciation is represented by phonetic symbols, and the part of speech is a noun. These pieces of information are used in morpheme analysis. The meaning of the key word flag is the same as that of the first embodiment.

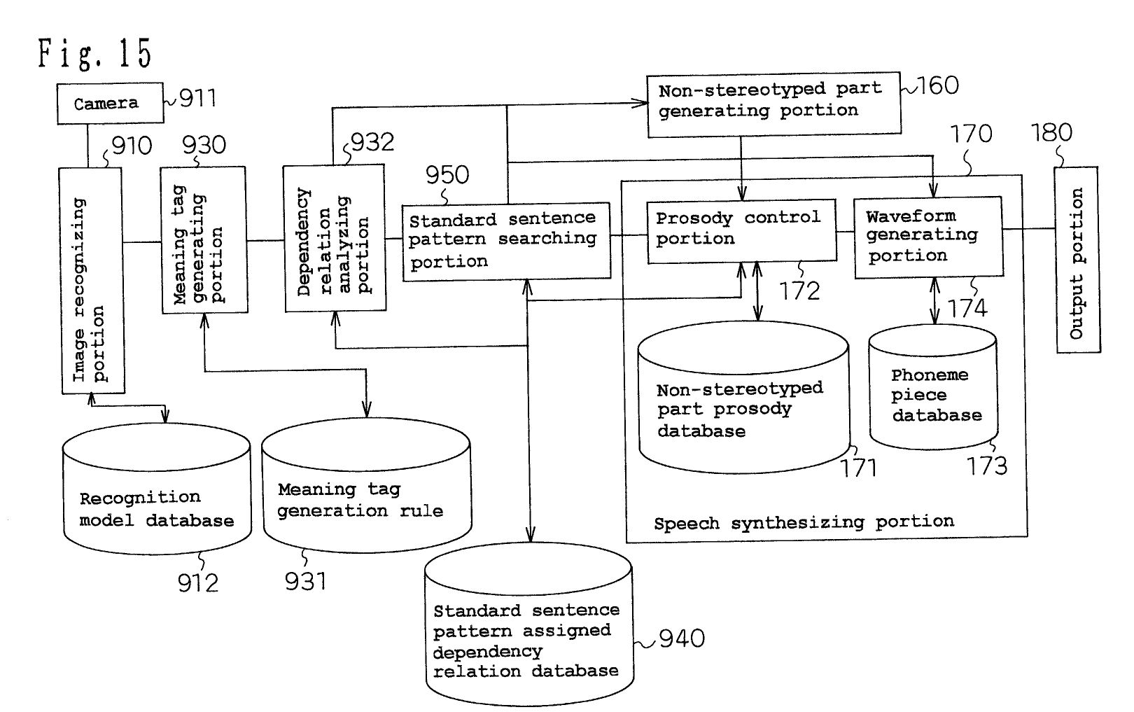

FIG. 13 shows an example of the English meaning class database 221. In the English meaning lass database 221, each key word is assigned a meaning tag representative of the class to which the key word belongs. For example, “ambulance” is assigned “vehicles” as the meaning tag, and “car” is also assigned “vehicles” as the meaning tag. These are the same as those of the first embodiment except that not Japanese but English is treated.

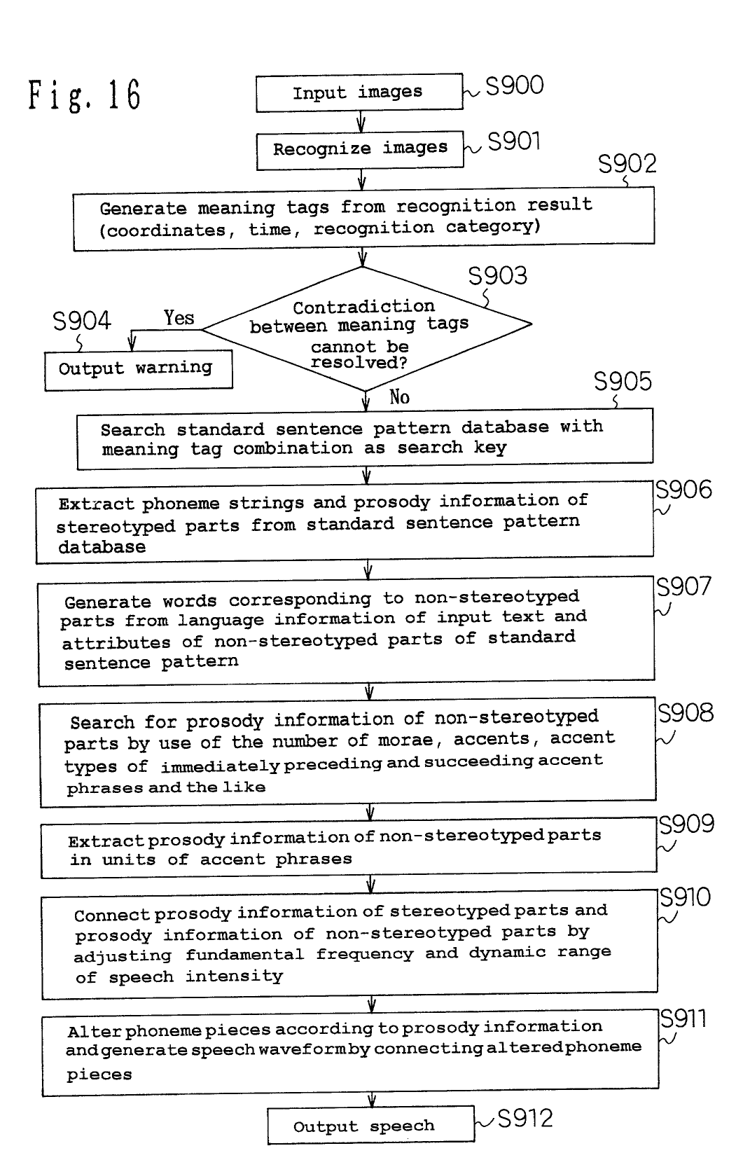

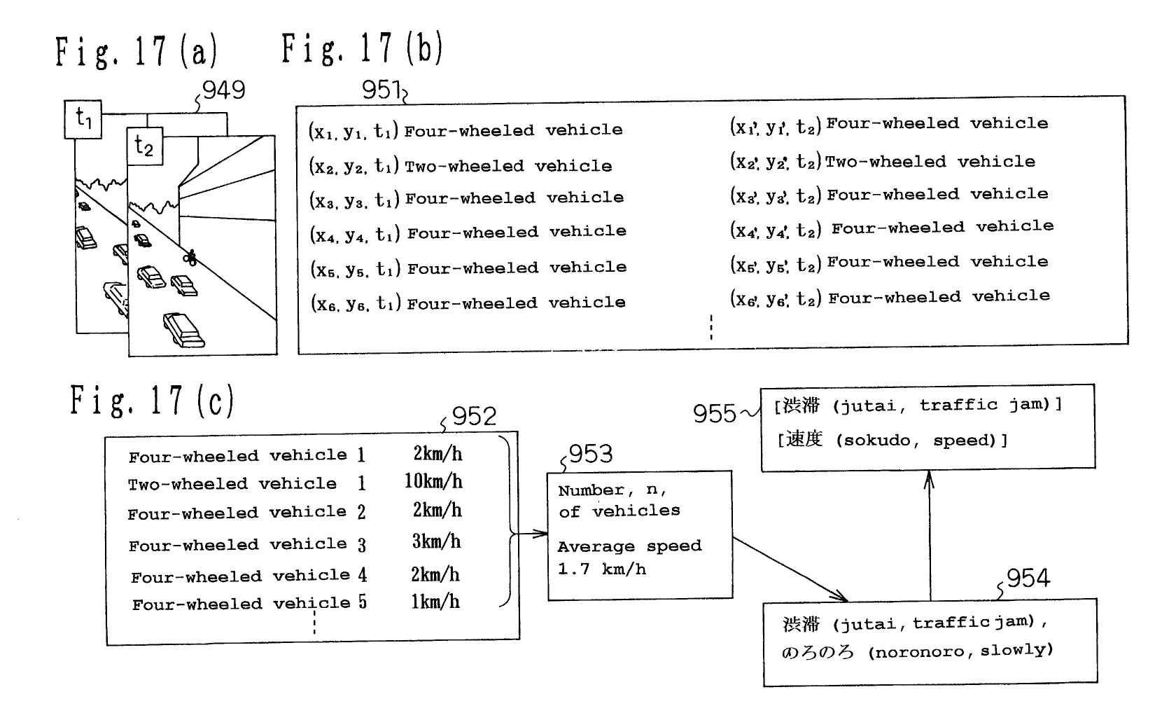

FIG. 14(a) shows an example of the Japanese standard sentence pattern database 240. In the Japanese standard sentence pattern database 240, a plurality of standard sentence patterns is stored. For example, the first standard sentence pattern is “[vehicles: subject](ga)[sound·warning: object](o)[output-sound: predicate].” The meaning tag “vehicles” is the subject of the standard sentence pattern, the meaning tag “sound·warning” is the object of the standard sentence pattern, and the meaning tag “output-sound” is the predicate of the standard sentence pattern. In each standard sentence pattern in the Japanese standard sentence pattern database 240, adjustment parameters of stereotyped part phoneme strings, stereotyped part prosody patterns and non-stereotyped part prosody patterns are stored like in the first embodiment. These are used in speech synthesis.

FIG. 14(b) shows an example of the English dependency relation database 222. In the English dependency relation database 222, sets of meaning tags assigned to the standard sentence patterns in the Japanese standard sentence pattern database 240 are stored. In FIG. 14(b), “(vehicles→sounds·warning), (sound·warning→output-sound)” is one meaning tag set. The meaning of the number such as 1 following the meaning tag set is the same as that of the first embodiment.

It is assumed that the English key word information assigned dictionary 220, the English meaning class database 221, the English dependency relation database 222 and the Japanese standard sentence pattern database 240 as described above are prepared.

Next, the operation to provide information by speech will be described.

The speech input portion 210 accepts an English speech waveform to be processed (step 110), and the speech recognizing and key word extracting portion 230 recognizes the input speech, and converts it to a string of English words (step 115). Then, the speech recognizing and key word extracting portion 230 performs morpheme analysis on the speech recognition result to assign language information such as the part of speech, and performs syntactic analysis to assign a meaning tag to each syntactic unit (step 120).

At step 120, an operation similar to the operation example described with reference to FIG. 8 in the first embodiment is performed.

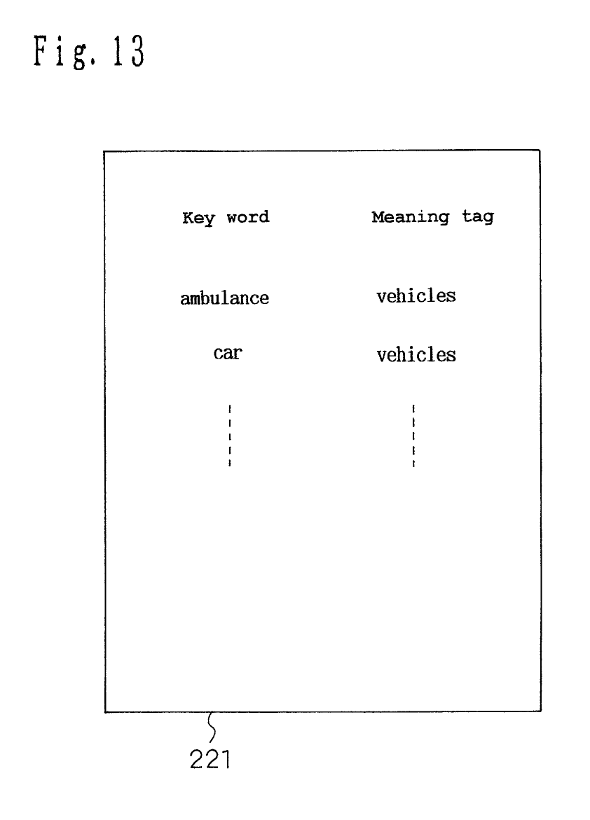

Specifically, it is assumed that the result of recognizing the speech input to the speech input portion 210 and converting it to a string of English words is an input text 720 as shown in FIG. 11. That is, it is assumed that a speech corresponding to a text “An ambulance wails its siren,” is input to the speech input portion 210.

Then, the speech recognizing and key word extracting portion 230 recognizes the input speech, converts it to a string of English words, and performs morpheme analysis on the input text 720 by use of the English key word information assigned dictionary 220 to assign language information such as the pronunciation and the part of speech. Moreover, the speech recognizing and key word extracting portion 230 extracts morphemes assigned the key word flag in the English key word information assigned dictionary 220 as key words from the input text 720. The key word extraction result 721 of FIG. 11 is key words extracted in this manner.

Then, the speech recognizing and key word extracting portion 230 replaces the extracted key words with meaning tags with reference to the English meaning class database 221. By further assigning language information such as the part of speech, the meaning tag assignment result 722 of FIG. 11 is obtained.

Then, the dependency relation analyzing portion 132 calculates the degree of coincidence between the meaning tag string of each syntactic unit output from the speech recognizing and meaning extracting portion 230 and each meaning tag set in the English dependency relation database. Then, the standard sentence pattern searching portion 150 selects from the Japanese standard sentence pattern database 240 the Japanese standard sentence pattern corresponding to the meaning tag set having the highest degree of coincidence calculated by the dependency relation analyzing portion 132 (step 130).

Specifically, the dependency relation analyzing portion 132 forms meaning tag pairs by arbitrarily combining the meaning tags of the meaning tag assignment result 722 which is the string of the meaning tags extracted by the speech recognizing and key word extracting portion 230. That is, from the meaning tag assignment result 722, three meaning tag pairs (vehicles→output-sound), (output-sound→sound·warning) and (sound·warning→vehicles) are formed as shown in the meaning tag combinations 723. Then, the dependency relation analyzing portion 132 compares the formed meaning tag combinations 723 and the meaning tag sets in the dependency relation database 122, and calculates the number of coinciding meaning tag pairs. In the example of FIG. 14(b), with respect to the meaning tag set “(vehicles→sound·warning), (sound·warning→output-sound)”, two meaning tag pairs coincide with meaning tag pairs of the meaning tag combinations 723 formed by the dependency relation analyzing portion 132. In this case, the degree of coincidence of this meaning tag set is 2.

With respect to the meaning tag set “(vehicles→move)”, since it coincides with none of the meaning tag pairs of the meaning tag combinations 703 formed by the dependency relation analyzing portion 132, the degree of coincidence of this meaning tag set is 0. Moreover, in the example of FIG. 14(b), the dependency relation analyzing portion 132 calculates the degrees of coincidence of the other meaning tag sets to be 0.

Every time calculating the degree of coincidence of a meaning tag set, the dependency relation analyzing portion 132 notifies the standard sentence pattern searching portion 150 of the calculated degree of coincidence and the number of the standard sentence pattern in the Japanese standard sentence pattern database 240 corresponding to the meaning tag set the degree of coincidence of which is calculated.

Notified by the dependency relation analyzing portion 132 of the degree of coincidence and the number of the standard sentence pattern in the Japanese standard sentence pattern database 240 corresponding to the meaning tag set the degree of coincidence of which is calculated, the standard sentence pattern searching portion 150 selects from the Japanese standard sentence pattern database 240 the standard sentence pattern corresponding to the meaning tag set having the highest degree of coincidence. In the example of FIG. 14(b), the meaning tag set having the highest degree of coincidence is “(vehicles→sound·warning), (sound·warning→output-sound).” Therefore, as the standard sentence pattern corresponding to the meaning tag set, “[vehicles: subject] [symbol] (ga)[sound·warning: object] [symbol] (o)[output-sound: predicate]” is selected from the Japanese standard sentence pattern database 240 of FIG. 14(a) as shown in the selected standard sentence pattern 724.

Then, the standard sentence pattern searching portion 150 extracts the phoneme strings and the prosody information of the stereotyped parts of the standard sentence pattern selected in this manner (step 140).

Then, the non-stereotyped part Japanese generating portion 160 extracts the attributes of the non-stereotyped parts of the standard sentence pattern selected at step 140 and the Japanese words corresponding to the meaning tags assigned at step 20 from the Japanese dictionary 255, and generates Japanese words corresponding to the non-stereotyped parts (step 150).

Specifically, like in the first embodiment, the non-stereo typed part Japanese generating portion 160 recognizes that “ambulance” corresponds to the part of “[vehicles: subject]” of the selected standard sentence pattern 724, obtains “ [symbol] (kyukyusha, ambulance)” which is the Japanese word corresponding to “ambulance” with reference to the Japanese dictionary 225, and applies “ [symbol] (kyukyusha, ambulance)” to the part of “[vehicles: subject].” Similar processing is performed on the other meaning tags, that is, the non-stereotyped parts, and as the result thereof, a Japanese sentence as shown in the application to the standard sentence pattern 725 shown in FIG. 11 can be obtained.

At the succeeding steps 60 to 100, operations similar to those described with reference to the figures in the first embodiment are performed to output a Japanese speech.

As described above, according to the system for providing information by speech of this embodiment, by use of the speech synthesizing portion that realizes synthetic speech with high naturalness by using stereotyped sentences for a given text by extracting the meaning of the input English speech, converting it to a Japanese standard sentence pattern having an equal meaning and synthesizing a speech, translated information can be easily provided by natural speech.

The speech recognizing and key word extracting portion 230, the dependency relation analyzing portion 132, the standard sentence pattern searching portion 150 and the non-stereotyped part Japanese generating portion 160 in this embodiment are an example of the analyzing means in the present invention. The speech synthesizing portion 170 in this embodiment is an example of the speech synthesizing means in the present invention. The English key word information assigned dictionary 220 and the English meaning class database 221 in this embodiment are an example of the relation information in the present invention. Extracting key words in this embodiment is an example of extracting all or some of the words of the first language in the present invention. Extracting as key words morphemes assigned the key word flag in this embodiment is an example of extracting all or some of the words of the first language based on the predetermined criterion in the present invention. The text generated as a result of speech recognition such as the English input text 720 in this embodiment is an example of the input sentence of the first language in the present invention. The meaning tags in this embodiment are an example of the standard words in the present invention. The meaning tag set stored in the English dependency relation database 222 in this embodiment is an example of the standard sentence pattern of the first language in the present invention. The standard sentence pattern stored in the Japanese standard sentence pattern database 240 in this embodiment is an example of the standard sentence pattern of the second language in the present invention.

While in this embodiment, a case where a speech in English is input and information is provided by a speech in Japanese is described, the present invention is not limited thereto. The present invention is applicable to a case where a speech in an arbitrary language is input and information is provided by a speech in another arbitrarily language such as a case where a speech in Japanese is input and information is provided by a speech in Chinese.

While in this embodiment, morphemes assigned the key word flag in the English key word information assigned dictionary 220 are extracted as key words from the input text 720 and the key word flag is assigned to all the content words in the example of FIG. 12, by assigning the key word flag only to words frequently used for a specific case such as a case where a person rides a vehicle, provision of information on the specific case by speech can be efficiently performed. In such a case, not all the morphemes occurring in the input text 720 are assigned the key word flag in the English key word information assigned dictionary 220. Therefore, in such a case, there are cases where not all the morphemes in the input text 720 are extracted as key words but only some of them are extracted as key words.

While in this embodiment, the extracted key words are replaced with meaning tags by use of the English meaning class database 221, it is not always necessary to use the meaning class database 121. In this case, as the criterion for selecting key words, the English words equivalent to the words included in the standard sentence patterns stored in the Japanese standard sentence pattern database 140 are selected as the key words. Therefore, of the words in the English key word information assigned dictionary 220, only the words satisfying this criterion are assigned the key word flag. In the Japanese standard sentence pattern database 240, standard sentence patterns in which the non-stereotyped parts of the standard sentence patterns are described by Japanese words equivalent to key words instead of meaning tags are stored. In the English dependency relation database 222, key word sets in which the parts of the meaning tags of the meaning tag sets are replaced by key words are stored. The dependency relation analyzing portion 132 forms a combination of key words instead of a combination of meaning tags from the extracted key words, and selects the degree of coincidence between the key word combination and the key word sets stored in the English dependency relation database 222. In this case, since the key words are not replaced with meaning tags, the non-stereotyped part Japanese generating portion 260 is unnecessary. As described above, information provision by speech can also be performed when the standard sentence pattern consists of only stereotyped parts.

While in this embodiment, the English key words extracted from the input text 720 are replaced with English meaning tag, the present invention is not limited thereto. It may be performed to obtain Japanese key words into which the extracted English key words are translated by use of a Japanese dictionary and replace the obtained Japanese key words with Japanese meaning tags. In this case, in the dependency relation database, Japanese meaning tag sets are stored unlike in this embodiment. In the English meaning class database 221, Japanese word classes are described. Instead of the English key word dictionary 220, a Japanese key word dictionary 220 in which Japanese words are described is provided. The dependency relation analyzing portion 132 forms a Japanese meaning tag combination from the obtained Japanese meaning tags, and calculates the degree of coincidence between the Japanese meaning tag combination and the Japanese meaning tag sets stored in the dependency relation database 222. Based on the result of the calculation, the standard sentence pattern searching portion 150 selects the most relevant Japanese meaning tag set, and selects the Japanese standard sentence pattern corresponding to the selected meaning tag set. By replacing the Japanese meaning tag sets of the non-stereotyped parts of the standard sentence pattern with the Japanese words corresponding to the English key words corresponding to the Japanese meaning tag set, the application to the standard sentence pattern 725 can be obtained.

Further, instead of obtaining Japanese key words into which the extracted English key words are translated by use of a Japanese dictionary and replacing the obtained Japanese key words with Japanese meaning tags as described above, the obtained Japanese key words may be used as they are. That is, a structure not using the English meaning class database 221 may be used. In this case, in the dependency relation database 222, Japanese key word sets in which the meaning tags of the meaning tag sets are replaced with Japanese key words are stored instead of the meaning tag sets of this embodiment. Instead of the English key word dictionary 220, a Japanese key word dictionary in which Japanese words are described is provided. In this case, the English key words extracted by the speech recognizing and key word extracting portion 230 are translated into Japanese words by use of a Japanese dictionary to obtain Japanese key words, and the dependency relation analyzing portion 132 forms a Japanese key word combination in which Japanese key words are described in the parts of the meaning tags of the meaning tag combination instead of the meaning tag combination of this embodiment. Then, the Japanese key word set most relevant to the formed Japanese key word combination is selected, and the Japanese standard sentence pattern corresponding to the selected Japanese key word set is selected. In this case, since no meaning tags are used, the non-stereotyped part Japanese generating portion 260 is unnecessary.

(Third Embodiment)

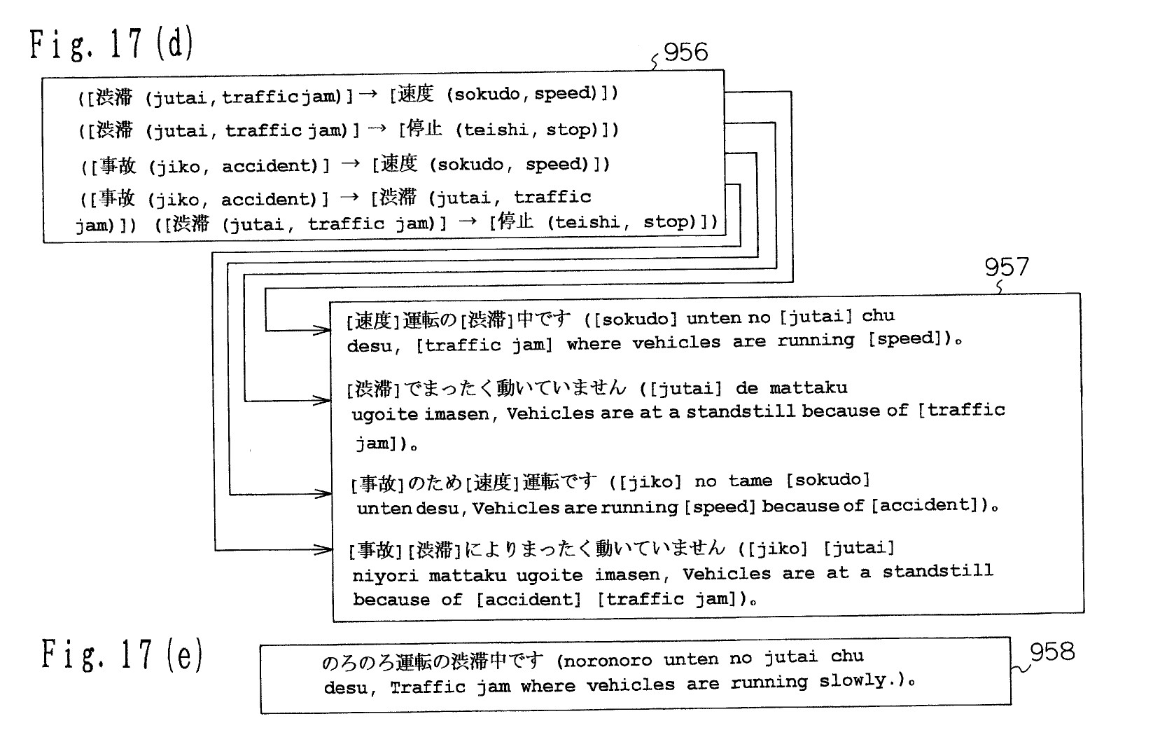

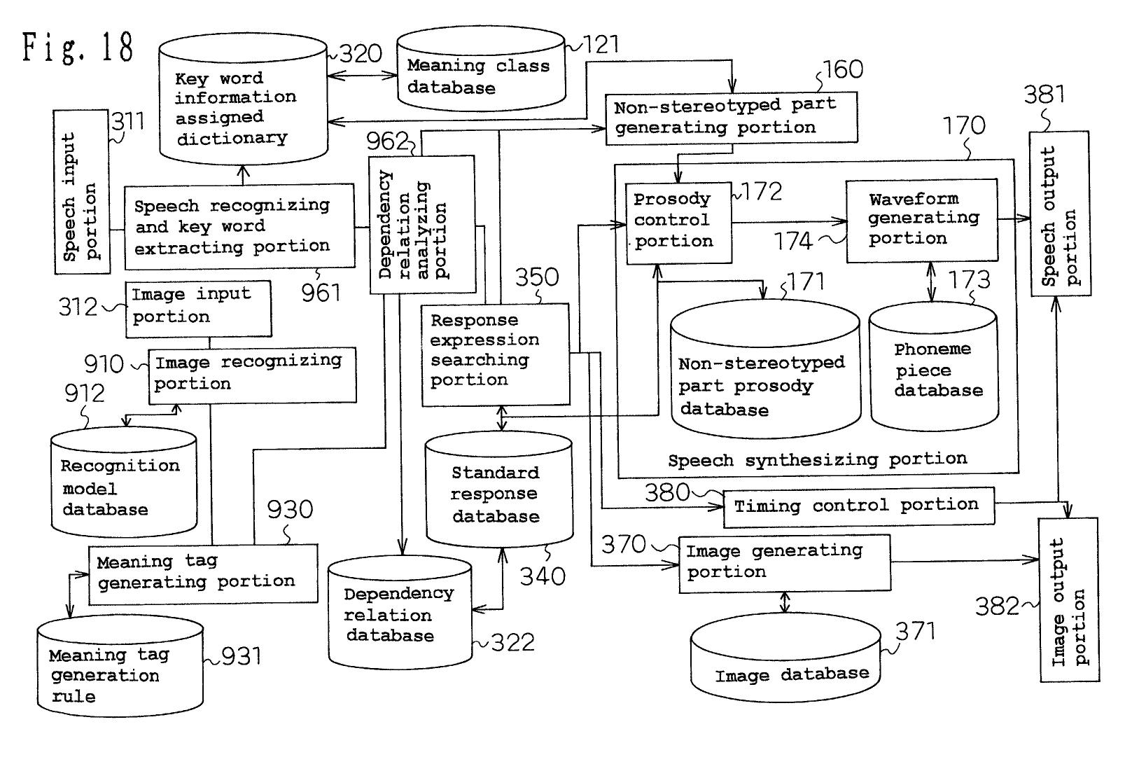

FIG. 15 is a functional block diagram showing the structure of a system for providing information by speech according to a third embodiment of the present invention. FIG. 16 is a flowchart of the operation of the system for providing information by speech according to the third embodiment of the present invention.

In FIG. 15, the same parts and elements as those of the first embodiment of FIG. 1 are designated by the same reference numerals and will not be described, and only different parts and elements will be described.

Reference numeral 911 represents a camera that shoots the conditions of a road where vehicles run. Reference numeral 910 represents an image recognizing portion that recognizes the shot images output by the camera 911 based on a recognition model database 912. Reference numeral 930 represents a meaning tag generating portion that generates a plurality of words by performing analysis based on the result of the image recognition and generates a meaning tag string from the generated words by use of a meaning tag generation rule 931. Reference numeral 932 represents a dependency relation analyzing portion that calculates the degree of coincidence between the generated meaning tag string and the meaning tag sets stored in a standard sentence pattern assigned dependency relation database 940. Reference numeral 950 represents a standard sentence pattern searching portion that selects the standard sentence pattern corresponding to the meaning tag set having the highest degree of coincidence based on the degrees of coincidence calculated by the dependency relation analyzing portion 932.

The operation of the system for providing information by speech structured as described above will be described with reference to FIG. 16.

At predetermined time intervals, the camera 911 shots two images shot at different times, and outputs the shot images to the image recognizing portion 910. Then, the image recognizing portion 910 inputs the two images shot at different times (step 900).

Then, the image recognizing portion 910 performs image recognition on the input images by use of the recognition model database 912.

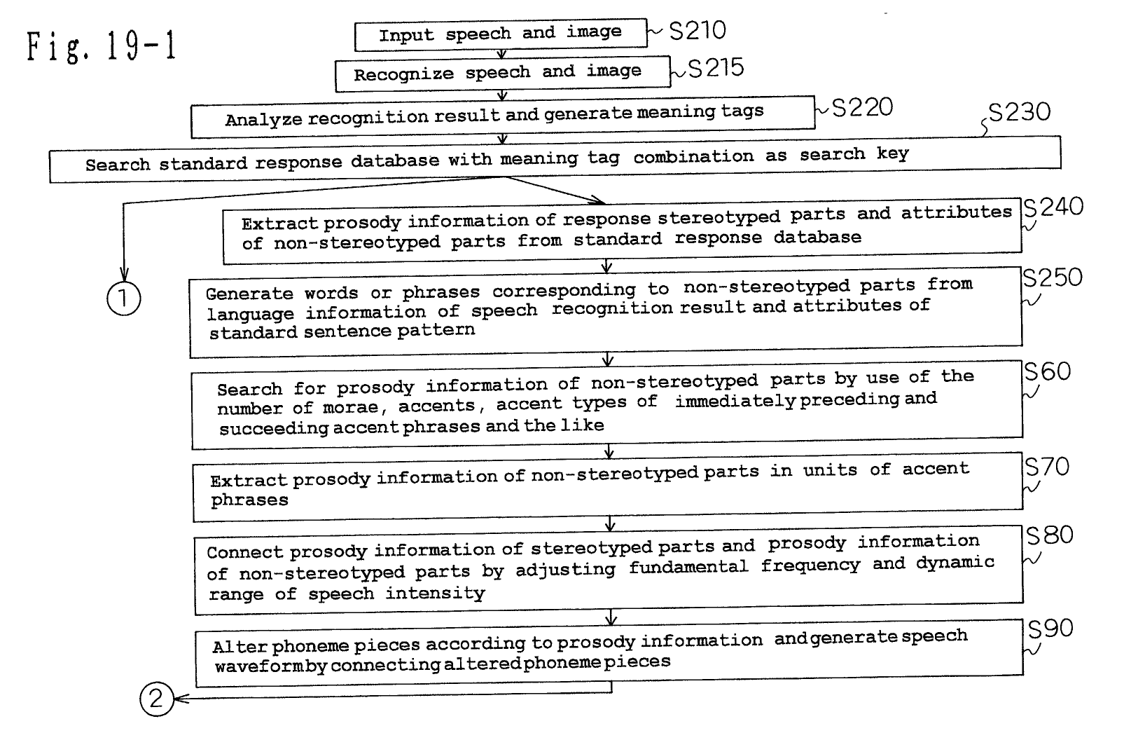

Specifically, FIG. 17(a) shows, as input images 949, an example of the images input to the image recognizing portion 910. The input images 949 are two images, one shot at a time t1 and the other, at a time t2.

Then, the image recognizing portion 930 performs image recognition on the input images 949 by use of the recognition model database 912, and recognizes the information shown in the recognition result 951 shown in FIG. 17(b). That is, in the recognition result 951, the following are described for each moving body such as a four-wheeled vehicle or a two-wheeled vehicle: the coordinates representative of the position on the road of the moving body in the image shot at the time t1; the coordinates representative of the position on the road of the moving body in the image shot at the time t2; and the kind of the moving body (whether the moving body is a four-wheeled vehicle or a two-wheeled vehicle).

In the recognition model database 912, the following, for example, are described: basic data based on which moving bodies in the input images 949 are recognized and the coordinates representative of the positions on the road of the recognized moving bodies at the time t1 and the time t2 are obtained; and a rule and an algorithm for recognizing whether a moving body is a four-wheeled vehicle or a two-wheeled vehicle. Examples of the basic data include data representative of the positional relationship between the camera 911 and the road. By using the data, the actual position on the road of a moving body recognized as a four-wheeled vehicle or a two-wheeled vehicle can be found from the position of the moving body in the image. Examples of the rule and the algorithm include, in the case of the nighttime, an algorithm for detecting the headlights or the headlight of a moving body such as a four-wheeled vehicle or a two-wheeled vehicle in the input images 949 and a rule for determining whether the moving body is a four-wheeled vehicle or a two-wheeled vehicle from the detected headlights or headlight, and in the case of the daytime, an algorithm for detecting a moving body from the input images 949 and a rule for recognizing whether the detected moving body is a four-wheeled vehicle or a two-wheeled vehicle. A rule for using an image recognition method used in the nighttime and an image recognition method used in the daytime each in a proper case is also described. The recognition model database 912 may use an algorithm and a rule different from the above-described ones.

The image recognizing portion 910 outputs the recognition result 951 by use of the rule, the algorithm and the basic data described in the recognition model database 912.

Then, the meaning tag generating portion 930 generates meaning tags from the result of the recognition by the image recognizing portion 910 by use of the meaning tag generation rule 931 (step 902).

Specifically, the meaning tag generating portion 930 calculates from the recognition result 951 the speeds of the moving bodies such as four-wheeled and two-wheeled vehicles as an analysis intermediate result 952 as shown in FIG. 17(c). Then, from the analysis intermediate result 952, the number of the moving bodies in the input images 949 and the average speed of the moving bodies are calculated as an analysis result 953. In the analysis result 953, a number, n, of moving bodies are running on the road at an average speed of 1.7 km/h.

The meaning tag generation rule 931 includes a rule for generating words in accordance with the contents of the analysis result 953 and a rule for associating words with meaning tags like the meaning class database 121 of the first embodiment.

The meaning tag generating portion 930 generates words like generated words 954 from the analysis result 953 by use of the meaning tag generation rule 931. Then, the meaning tag generating portion 930 generates the meaning tags 955 corresponding to the generated words 954 by use of the meaning tag generation rule 931.

Then, the meaning tag generating portion 930 checks the generated meaning tags for errors (step 902). When contradictory meaning tags are generated and the contradiction cannot be resolved, a warning that information provision by speech cannot be performed is output (step 904).

Examples of the case where the warning is output include a case where the image recognition of the input images 950 is a failure so that the analysis result 953 is an impossible result such that the number of moving bodies is 100 and the average speed is 300 km/h, and the generated words 954 cannot be generated, and a case where although the generated words 954 are generated, the generated words 954 generates contradictory meaning tags such as “ [symbol] (jutai, traffic jam), [symbol] (juncho ni tsuko, run smoothly).”

Then, the dependency relation analyzing portion 932 forms a meaning tag combination from the meaning tags generated by the meaning tag generating portion 932, and calculates the degree of coincidence between the meaning tag combination and the meaning tag sets stored in the standard sentence pattern assigned dependency relation database 940. Based on the result of the calculation, the standard sentence pattern searching portion 950 selects the standard sentence pattern corresponding to the meaning tag set having the highest degree of coincidence from the standard sentence pattern assigned dependency relation database 940 (step 905).

Specifically, a meaning tag combination is formed by combining the meaning tags 955 of FIG. 17 like in the first embodiment. In the example of FIG. 17, since the number of meaning tags 955 is two, the possible meaning tag combination is only one pair “([ [symbol] (jutai, traffic jam)]→[ [symbol] (sokudo, speed)]).”

In the standard sentence pattern assigned dependency relation database 940, meaning tag sets as shown in the meaning tag sets 956 of FIG. 17 and standard sentence patterns as shown in the corresponding standard sentence patterns 957 are stored, and each of the meaning tag sets is associated with one of the standard sentence patterns.

The dependency relation analyzing portion 932 calculates the degree of coincidence between a meaning tag combination “([ [symbol] (jutai, traffic jam)]→[ [symbol] (sokudo, speed)])” and each meaning tag set. In the example of FIG. 17, the meaning tag set “([ [symbol] (jutai, traffic jam)]→[ [symbol] (sokudo, speed))” has the highest degree of coincidence.

Therefore, the standard sentence pattern searching portion 950 selects “[ [symbol] (sokudo, speed)] [symbol] (unten no, driving)[ [symbol] (jutai, traffic jam)] [symbol] (chu desu)∘” of the corresponding standard sentence patterns 957 which is a standard sentence pattern corresponding to the meaning tag set “([z,773 (jutai, traffic jam)]→[ [symbol] (sokudo, speed)]).”

Step 906 is similar to step 40 of the first embodiment.

Then, the non-stereotyped part generating portion 160 generates words corresponding to the non-stereotyped parts of the selected standard sentence pattern (step 907).

That is, the generated words 954 are applied to the parts of the meaning set of the selected standard sentence pattern “[ [symbol] (sokudo, speed)] [symbol] (unten no, driving)[ [symbol] (jutai, traffic jam)] [symbol] (chu desu)∘.”

The succeeding steps will not be described because they are similar to those of the first embodiment.

As described above, according to this embodiment, by inputting images obtained by shooting road conditions, and analyzing the images, road information such as “ [symbol] (noronoro unten no jutai chu desu, Traffic jam where vehicles are running slowly.)∘” can be provided by speech.

The image recognizing portion 910 and the meaning tag generating portion 930 in this embodiment are an example of the signal processing means in the present invention. The meaning tag generating portion 930, the dependency relation analyzing portion 932, the standard sentence pattern searching portion 950 and the non-stereotyped part generating portion 160 in this embodiment are an example of the analyzing means in the present invention. The speech synthesizing portion 170 in this embodiment is an example of the speech synthesizing means in the present invention. The words generated by performing image recognition and analyzing the result of the recognition such as the generated words 954 in this embodiment are an example of one or a plurality of words in the present invention. The key word information assigned dictionary 120 and the meaning class database 121 in this embodiment are an example of the relation information in the present invention. Extracting key words in this embodiment is an example of extracting all or some of the words in the present invention. Extracting as key words morphemes assigned the key word flag in this embodiment is an example of extracting all or some of the words based on the predetermined criterion in the present invention. The meaning tags in this embodiment are an example of the standard words in the present invention.

While in this embodiment, the meaning tag generating portion 930 generates the meaning tag 955 from each of the generated words 954, the present invention is not limited thereto. The generated words 954 may be used as they are. That is, the dependency relation analyzing portion 2 treats the generated words 954 as key words, and forms the above-mentioned key word combination. Moreover, instead of the meaning tag sets 956, the above-mentioned key word sets are provided. Then, the dependency relation analyzing portion 2 calculates the degree of coincidence between the key word combination and the key word sets, and the standard sentence pattern searching portion 950 selects the standard sentence pattern corresponding to the key word set having the highest degree of coincidence. Then, speech synthesis of the standard sentence pattern is performed by use of the prosody information. In this case, since the standard sentence pattern includes no meaning tag sets, the non-stereotyped part generating portion 160 is unnecessary like in the above-described modification.

While the image recognizing portion 910 inputs two images shot at different times in this embodiment, the present invention is not limited thereto. The image recognizing portion 910 may input two or more images shot at different times. Moreover, it may be performed that the camera 911 shots moving images and the image recognizing portion 910 inputs the moving images.

(Fourth Embodiment)

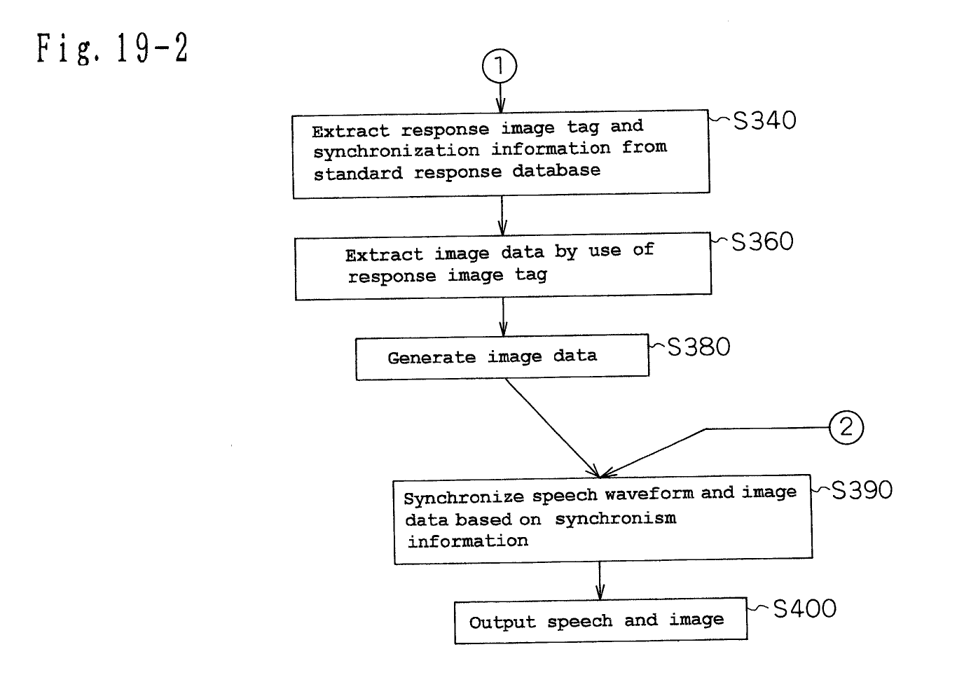

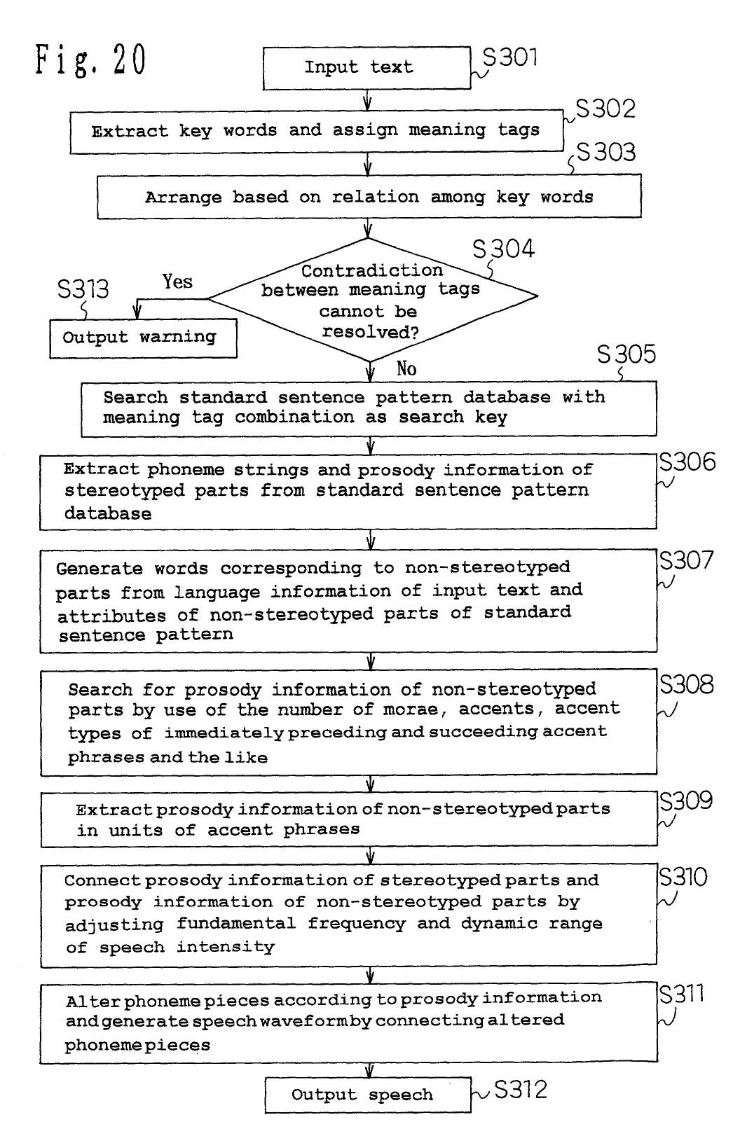

FIG. 18 is a functional block diagram showing the structure of a system for providing information by speech according to a fourth embodiment of the present invention. FIG. 19 is a flowchart of the operation of the system for providing information by speech according to the fourth embodiment of the present invention.

In FIG. 18, the same parts and elements as those of FIGS. 1 and 15 are designated by the same reference numerals and will not be described, and only different parts and elements will be described.

Reference numeral 311 of the system for providing information by speech of the fourth embodiment of FIG. 18 represents a speech input portion for inputting a speech. Reference numeral 312 represents an image input portion for inputting an image. Reference numeral 320 is a key word information assigned dictionary in which the feature amounts and the meaning tags of a speech are stored. Reference numeral 961 represents a speech recognizing and key word extracting portion that performs speech recognition on the speech input from the speech input portion 311 with reference to the key word information assigned dictionary 320, extracts key words and assigns meaning tags to the key words. The image recognizing portion 910 is an image recognizing portion that performs image recognition on the image input from the image input portion 312 with reference to the recognition model database 912. Reference numeral 930 represents a meaning tag generating portion that generates meaning tags from the result of the image recognition with reference to a meaning tag generation rule. Reference numeral 962 represents a dependency relation analyzing portion that forms a meaning tag combination from the generated meaning tag string and calculates the degree of coincidence between the meaning tag combination and the meaning tag sets in the dependency relation database. Reference numeral 322 represents a standard response database in which the following are stored: response standard sentence patterns which are standard sentence patterns of responses corresponding to the input speech and image; stereotyped part information of the response speech of each response standard sentence pattern; and response image tags which are tags for associating response images with response standard sentence patterns. Reference numeral 350 represents a response expression searching portion that searches for and extracts the corresponding response standard sentence pattern from a standard response database 340 by use of the meaning tag string. Reference numeral 381 represents a speech output portion that outputs a speech. Reference numeral 382 represents an image output portion that outputs an image. Reference numeral 371 represents an image database in which response images are stored. Reference numeral 370 represents an image generating portion that generates image data based on the image tags extracted from the standard response database 340 by the response expression searching portion 350. Reference numeral 380 represents a timing control portion that adjusts the timing of speech output and image output.

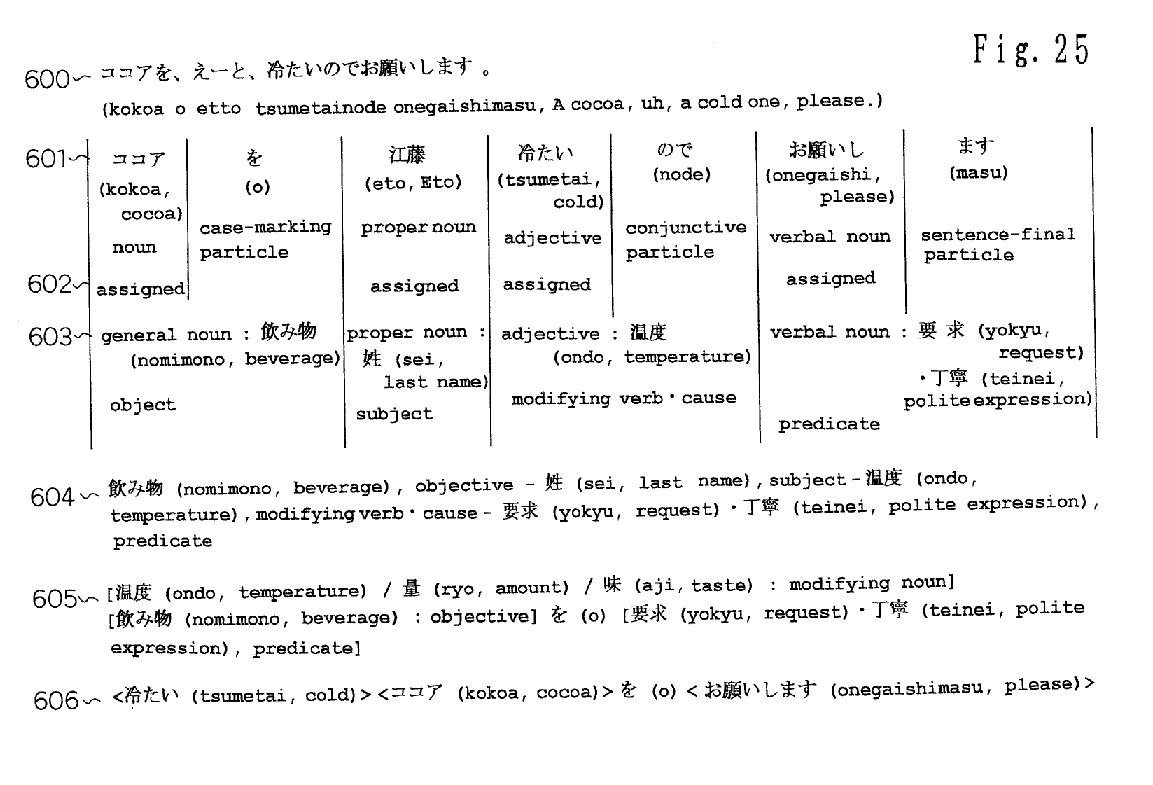

The operation of the system for providing information by speech structured as described above will be described with reference to FIG. 24.

The speech input portion 311 accepts a speech waveform to be processed, the image input portion 312 accepts image data synchronizing with the speech to be processed (step 210), and the speech recognizing and key word extracting portion 330 recognizes the input speech and converts it to a word string in a manner similar to the speech recognizing and key word extracting portion 230 of the second embodiment. The image recognizing portion 910 performs image recognition in a manner similar to the image recognizing portion 910 of the third embodiment to generate a recognition result. The meaning tag generating portion 930 generates a word string comprising one or a plurality of words from the result of the image recognition (step 215). The speech recognizing and key word extracting portion 961 performs morpheme analysis on the word string, assigns language information such as the part of speech, performs syntactic analysis and assigns a meaning tag to each syntactic unit. The meaning tag generating portion 930 generates meaning tags from the generated word string (step 220). Here, the operations of the speech input portion 311 and the speech recognizing and key word extracting portion 961 are similar to those of the second embodiment, and the operations of the image input portion 312, the image recognizing portion 910 and the meaning tag generating portion 930 are similar to those of the third embodiment.

The dependency relation analyzing portion 962 forms combinations of the generated meaning tags. In forming the meaning tag combinations, a combination of the meaning tags generated by the speech recognizing and key word extracting portion 961 and a combination of the meaning tags generated by the meaning tag generating portion 912 are separately formed. Therefore, when a speech and an image are simultaneously input to the speech input portion 311 and the image input portion 312, respectively, a combination of the meaning tags corresponding to the input speech and a combination of the meaning tags corresponding to the input image are formed. In this case, the calculation of the degree of coincidence between the meaning tag combination corresponding to the input speech and the dependency relation database 322 is performed in a manner similar to that in the second embodiment, and the calculation of the degree of coincidence between the meaning tag combination corresponding to the input image and the dependency relation database 322 is performed in a manner similar to that in the third embodiment.

The response expression searching portion 350 selects from the standard response database 340 the response standard sentence pattern corresponding to the meaning tag set having the highest degree of coincidence with the meaning tag combination notified of by the dependency relation analyzing portion 962 (step 230). When an image and a speech are simultaneously input, the response expression searching portion 350 selects the response standard sentence pattern corresponding to the input image and the response standard sentence pattern corresponding to the input speech.

Further, the response expression searching portion 350 extracts the phoneme strings and the prosody information of the stereotyped parts of the selected response standard sentence pattern (step 240). Like in the first embodiment, with the response standard sentence pattern, the phoneme strings and the prosody information of the stereotyped parts are previously associated, and these are stored in the standard response database together with the response standard sentence pattern.

Moreover, the response image tag to which the selected response standard sentence pattern also corresponds and the information on the synchronism between the image and the standard response sentence pattern are extracted (step 340).

When non-stereotyped parts are present in the standard response sentence pattern, the non-stereotyped part generating portion 160 extracts the attributes of the non-stereotyped parts of the standard response sentence pattern selected at step 240 and the words or the phrases corresponding to the meaning tags assigned at step 220 from the key word information assigned dictionary 320 and the meaning tag generation rule 931, and generates non-stereotyped parts (step 250).

At the succeeding steps 60 to 90, operations similar to those described with reference to FIG. 2 in the first embodiment are performed to output a speech waveform.

The image generating portion 370 extracts a response image from the image database 371 by use of the response image tag of the response standard sentence pattern selected at step 230 (step 360) and generates an image based on the information on the synchronism with the standard response sentence pattern (step 380).

The timing control portion 380 synchronizes the speech waveform generated at step 90 and the image generated at step 380 based on the response image and the information on the synchronism with the standard response sentence pattern extracted at step 340, and outputs a response speech and a response image from the speech output portion 381 and the image output portion 382.

As described above, according to the interactive system of this embodiment, by extracting the meaning of the input speech and image, and synthesizing a response speech and generating a response image based on the standard response sentence pattern corresponding to the meaning, for a given input, a response sentence can be efficiently generated irrespective of variations in word order and expression, and by use of the speech synthesizing portion that realizes synthetic speech with high naturalness by using stereotyped sentences, an interactive response can be generated by natural speech.

The speech recognizing and key word extracting portion 961, the dependency relation analyzing portion 962, the response expression searching portion 350, the image recognizing portion 910, the meaning tag generating portion 930 and the non-stereotyped part generating portion 160 in this embodiment are an example of the analyzing means in the present invention. The speech synthesizing portion 170 in this embodiment is an example of the speech synthesizing means in the present invention The text generated by speech recognition in this embodiment is an example of the input sentence in the present invention. One or a plurality of words generated by analyzing the result of the image recognition in this embodiment are an example of the input sentence in the present invention. The key word information assigned dictionary 120 and the meaning class database 121 in this embodiment are an example of the relation information in the present invention. Extracting key words in this embodiment is an example of extracting all or some of the words in the present invention. Extracting as key words morphemes assigned the key word flag in this embodiment is an example of extracting all or some of the words based on the predetermined criterion in the present invention. The meaning tag in this embodiment is an example of the standard word in the present invention.

While the meaning class database 121 is used in this embodiment, it is not always necessary to use the meaning class database. In this case, key words are selected from among one or a plurality of words generated by analyzing the text generated by speech recognition and the result of the image recognition. In selecting key words, only key words included in the standard sentence patterns stored in the standard response database 340 are selected. However, in this case, in the standard response database of the standard response database 340, key words are described instead of the parts of the meaning tags of the standard response sentence patterns. The standard response sentence pattern corresponding to the key word set having the highest degree of coincidence with the key word combination is selected. On the standard response sentence pattern selected in this manner, speech synthesis is performed by use of the prosody information associated with the standard response sentence pattern. The key word combination and the key word set are similar to those described above.

While speech synthesis is performed by connecting phoneme pieces in the first to the fourth embodiments, it may be performed by a method other than this method.

While adjustment parameters of stereotyped part phoneme strings, stereotyped part prosody patterns and non-stereotyped part prosody patterns are stored in the standard sentence pattern database, the standard sentence pattern assigned dependency relation database and the standard response database in the first to the fourth embodiments, instead of stereotyped part phoneme strings and stereotyped part prosody patterns, recorded speeches may be stored.

While adjustment parameters of stereotyped part phoneme strings, stereotyped part prosody patterns and non-stereotyped part prosody patterns are stored in the standard sentence pattern database, the standard sentence pattern assigned dependency relation database and the standard response database in the first to the fourth embodiments, instead of stereotyped part phoneme strings and stereotyped part prosody patterns, parameters such as formant information conforming to the synthesizing method of the speech synthesizing portion 170 may be stored.

While in the first to the fourth embodiments, the phoneme string, the number of morae, the accent, the position in the sentence, the presence or absence and the durations of immediately preceding and succeeding pauses, the accent types of the immediately preceding and succeeding accent phrases and the prosody information are stored in the non-stereotyped part prosody database 171, in addition to these, the string of parts of speech, the clause attribute, the dependency, the prominence and the like may be stored, or it is necessary only to store at least one of the above-mentioned conditions except the prosody information.

While the input is a single signal in the first to the third embodiments, a plurality of input signals may be accepted like in the fourth embodiment.

While the input is a plurality of signals in the fourth embodiment, a single input signal may be accepted.

While the input is a text in the first embodiment, the input may be one or a combination of a speech, a sound, an image, a vibration, an acceleration, a temperature, a tension and the like other than a text.

While the input is a speech in the second embodiment, the input may be a text or a combination of a speech and a text.

While the input is an image in the third embodiment, the input may be one or a combination of a sound, a vibration, an acceleration, a temperature, a tension and the like other than an image.

While the input is a speech and an image in the fourth embodiment, the input may be one or a combination of a sound, a vibration, an acceleration, a temperature, a tension and the like other than a speech and an image.

While English is converted to Japanese in the second embodiment, the languages may be other languages.

While the language of the input speech is a single language in the second embodiment, switching may be made among a plurality of languages automatically or by a selection by the user.

While the language of the output speech is a single language in the second embodiment, switching may be made among a plurality of languages by a selection by the user.

As described above, according to this embodiment, by, for an arbitrary input such as a text, a speech or an image, analyzing the meaning of the input signal and converting it to a language expression by a standard sentence pattern, conversion from a wide range of media and modalities to a speech and language conversion are enabled, and information can be provided by high quality speech.

(Fifth Embodiment)

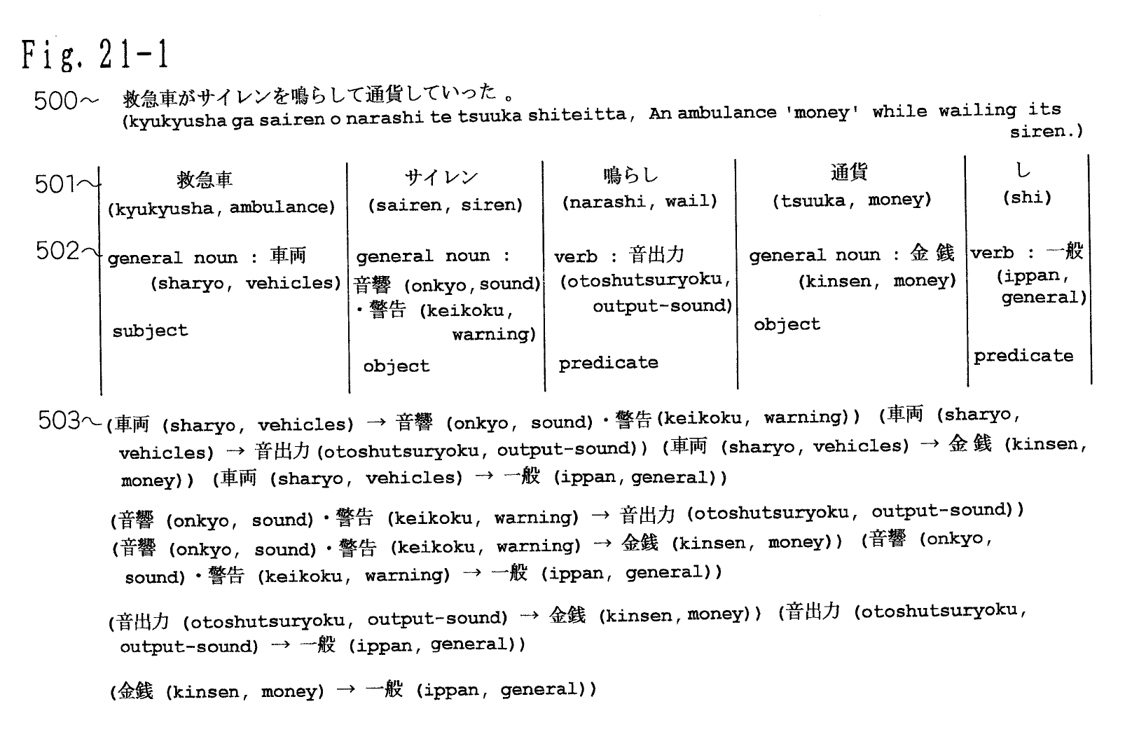

FIG. 1 is a functional block diagram showing the structure of a system for providing information by speech according to a fifth embodiment of the present invention. FIG. 20 is a flowchart of the operation of the system for providing information by speech according to the fifth embodiment of the present invention.

The structure of the system for providing information by speech according to the fifth embodiment is similar to that of the first embodiment. That is, in FIG. 1, reference numeral 110 represents the text input portion for inputting a text. Reference numeral 120 represents the key word information assigned dictionary in which information necessary for analysis of morphemes such as the written form and the part of speech are stored, and morphemes to be treated as key words are assigned the key word flag and meaning tags. Reference numeral 121 represents the meaning class database in which meaning tags corresponding to the key words in the key word information assigned dictionary 120 are stored. Reference numeral 130 represents the key word extracting portion that performs morpheme analysis on the input text and extracts key words from the input text with reference to the key word information assigned dictionary 120 and assigns each of the extracted key words a meaning tag. Reference numeral 122 represents the dependency relation database in which meaning tag sets formed by combining meaning tags relevant to each other are stored. The standard sentence pattern data corresponding to each meaning tag set is stored in the standard sentence pattern database 140. Reference numeral 132 represents the dependency relation analyzing portion that calculates the degree of coincidence between the meaning tag string output from the key word extracting portion 130 and each of the meaning tag sets stored in the dependency relation database 122. Reference numeral 140 represents the standard sentence pattern database in which adjustment parameters of the meaning tag string, the stereotyped part phoneme string, the stereotyped part prosody pattern and the non-stereotyped part prosody pattern of each standard sentence pattern are stored. Reference numeral 150 represents the standard sentence pattern searching portion that searches the standard sentence pattern database by use of the meaning tag string. Reference numeral 160 represents the non-stereotyped part generating portion that generates phonetic symbol strings of the non-stereotyped parts of the input. Reference numeral 170 represents the speech synthesizing portion. Reference numeral 180 represents the output portion that outputs a speech waveform. The speech synthesizing portion 170 includes: the non-stereotyped part prosody database 171 in which accent phrase attributes such as the phoneme string, the number of morae and the accent, and the prosody information are stored; the prosody control portion 172 that extracts the prosody information of the non-stereotyped parts with reference to the non-stereotyped part prosody database 171 and connects the extracted prosody information to the prosody information of the stereotyped parts extracted by the standard sentence pattern searching portion 150; and the waveform generating portion 174 that generates a speech waveform based on the prosody information output from the prosody control portion 172 by use of the phoneme piece database 173 in which a waveform generating unit is stored and phoneme pieces stored in the phoneme piece database 173.

The operation of the system for providing information by speech structured as described above will be described with reference to FIG. 20.

In the system for providing information by speech according to this embodiment, like in the first embodiment, before information is provided by speech, the key word information assigned dictionary 120, the meaning class database 121, the dependency relation database 122 and the standard sentence pattern database 140 are prepared.

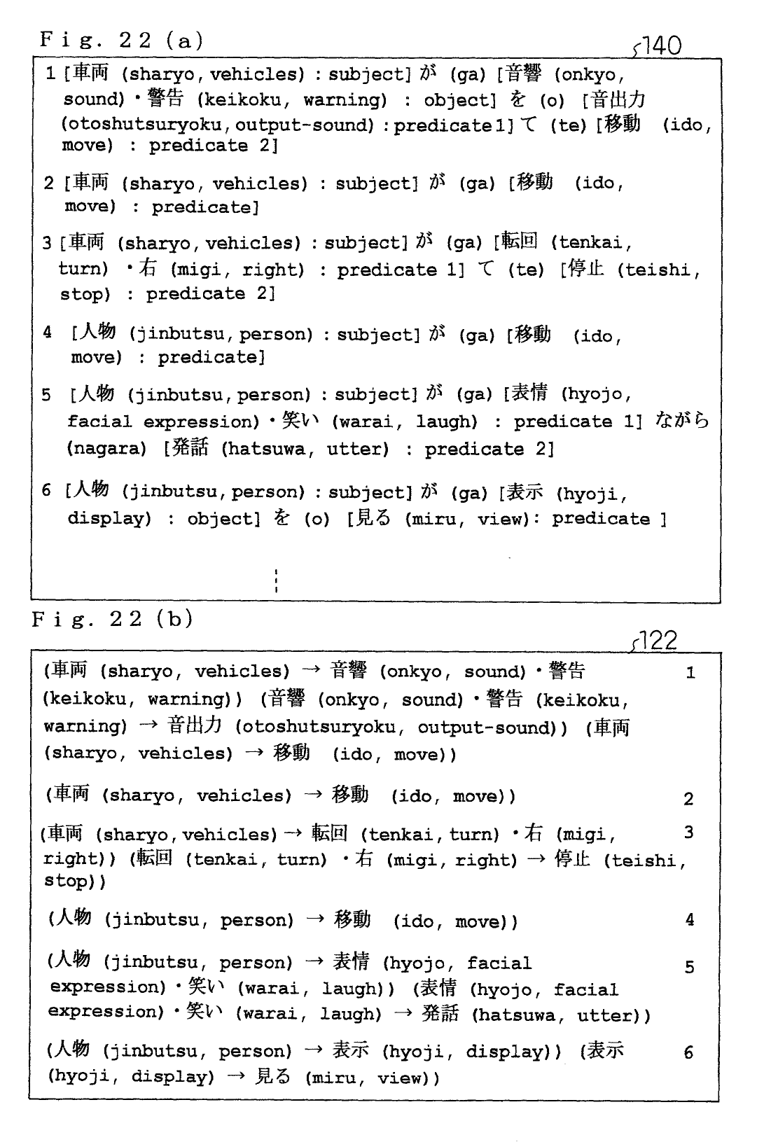

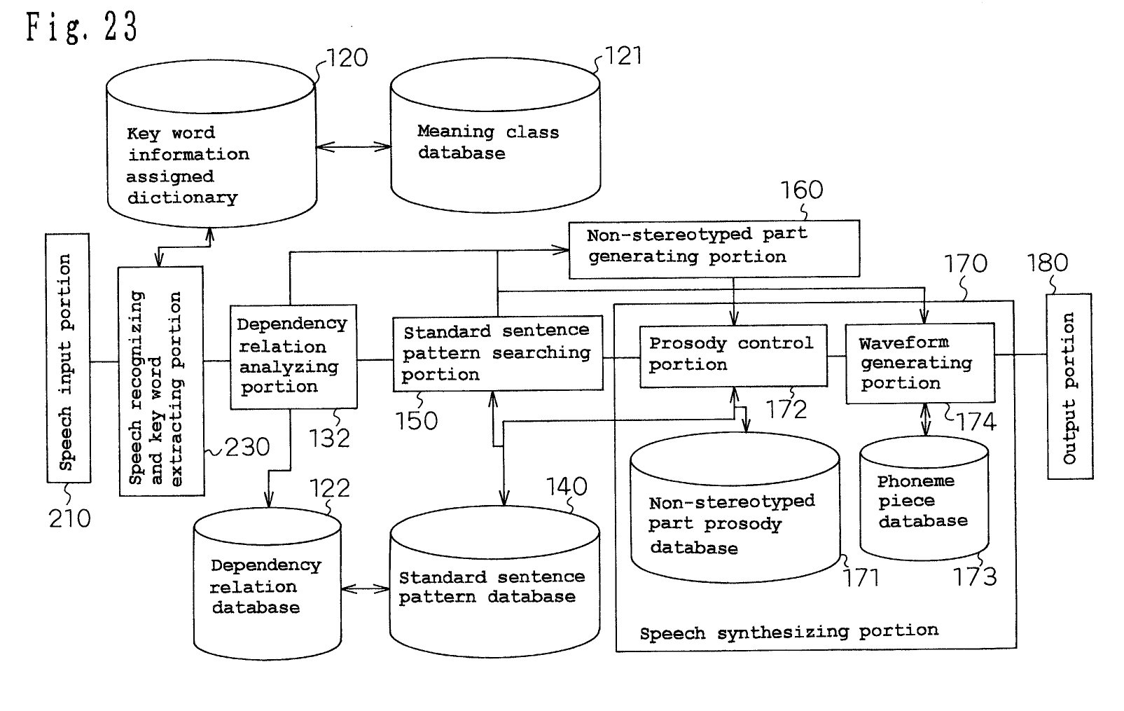

FIG. 5 shows an example of the key word information assigned dictionary 120. FIG. 6 shows an example of the meaning class database 121. These have been described in detail in the first embodiment. FIG. 22(a) shows an example of the standard sentence pattern database 140. FIG. 22(b) shows an example of the dependency relation database 122. The standard sentence pattern database 140 shown in FIG. 22(a) is different from that described in the first embodiment in the first standard sentence pattern. The dependency relation database 122 shown in FIG. 22(b) is different from that described in the first embodiment in the first meaning tag set. Except these, they are similar to those of the first embodiment.

It is assumed that the key word information assigned dictionary 120, the meaning class database 121, the dependency relation database 122 and the standard sentence pattern database 140 as described above are prepared.

Next, the operation to provide information by speech will be described.

The text input portion 110 accepts text data to be processed (step 301). Then, the key word extracting portion 130 performs morpheme analysis on the input text data with reference to the key word information assigned dictionary 120, extracts morphemes assigned the key word flag, and assigns a meaning tag and language information such as the pronunciation and the part of speech to each syntactic unit (step 302).

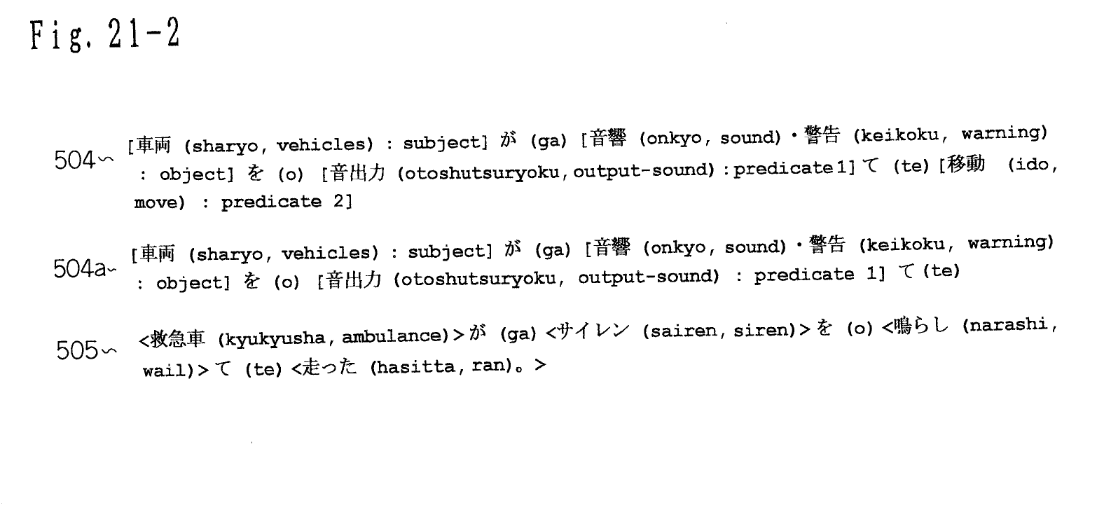

The operation of such step 302 will be described with reference to FIG. 21. It is assumed that the input text is an input text 500, that is, “ [symbol] (kyukyusha ga sairen o narashi te tsuuka shiteitta, An ambulance ‘money’ while wailing its siren.)∘.” In the input text 500, the part which must be written as “ [symbol] (tsuuka, pass)” is written as “ [symbol] (tsuuka, money)” because of an input error. This text data is morpheme-analyzed, language information such as the pronunciation and the part of speech is assigned, and morphemes assigned the key word flag in the key word information assigned dictionary 120 are extracted as key words. The key word extraction result 501 in FIG. 21 is key words extracted in this manner.

Then, the key word extracting portion 130 replaces syntactic units including key words with meaning tags based on the syntactic information obtained by the morpheme analysis by use of the meaning class database 121. As a result of such language information being assigned and the syntactic units being replaced with meaning tags as described above, the meaning tag assignment result 502 is obtained. In this embodiment, clauses are used as syntactic units. That is, “ [symbol] (kyukyusha ga, An ambulance)” is assigned “general noun: [symbol] (sharyo, vehicles), subject” as the language information and the meaning tag, “ [symbol] (saireno, its siren)” is assigned “general noun: [symbol] (onkyo, sound)· [symbol] (keikoku, warning), predicate” as the language information and the meaning tag, “ [symbol] (narashi te, while wailing)” is assigned “verb: [symbol] (otoshutsuryoku, output-sound), predicate” as the language information and the meaning tag, “ [symbol] (tsuuka, money)” is assigned “general noun: [symbol] (kinsen, money), object” as the language information and the meaning tag, and “ [symbol] (shiteitta, did)” is assigned “verb: [symbol] (ippan), predicate” as the language information and the meaning tag.

Then, the dependency relation analyzing portion 132 analyzes the relation among the extracted key words (step 303). Further, the dependency relation analyzing portion 132 determines whether the relation among the key words can be analyzed or not (step 304). When the relation among the key words cannot be analyzed and a contradictory key word cannot be excluded, a warning is output to the user and the program is ended (step 313) When a key word irrelevant or contradictory to other key words can be determined to be an input error and can be excluded at step 304, the dependency relation analyzing portion 132 outputs a meaning tag set with which the standard sentence pattern representative of the meaning of the input can be searched for.

The operations of such steps 303 and 304 will be described with reference to FIG. 21. By the analysis, “ [symbol] (kyukyusha, ambulance)” and “ [symbol] (sairen, siren)”, and “ [symbol] (sairen, siren) and [symbol] (narasu, wail)” of the key word extraction result 501 are each determined to be highly related to each other, “ [symbol] (suru, do)” is determined to be slightly related to all of “ [symbol] (kyukyusha, ambulance)” “ [symbol] (sairen, siren)” and “ [symbol] (tsuuka, money)”, and “ [symbol] (tsuuka, money)” is determined to be irrelevant to all of “ [symbol] (kyukyusha, ambulance)”, “ [symbol] (sairen, siren)” and “ [symbol] (narasu, wail).” From these analysis results, “ [symbol] (tsuuka, money)” is excluded as an inappropriate part in identifying the meaning of the entire input text, and meaning tag sets like the meaning tag sets 503 with which a standard sentence pattern can be searched for are output. The exclusion of an input error based on the meaning of the key words and the relation among the key words is performed, for example, by a method of Japanese Patent Application No. 2001-65637.

The standard sentence pattern searching portion 150 searches the standard sentence pattern database 140 by use of the meaning tag sets output from the dependency relation analyzing portion (step 305), maps the input text into a specific standard sentence pattern, and extracts the phoneme strings and the prosody information of the stereotyped parts of the mapped standard sentence pattern (step 306).

The operations of such steps 305 and 306 will be described with reference to FIG. 21. A standard sentence pattern including meaning tags common to those included in the meaning tag combinations 503 formed by the dependency relation analyzing portion 132 is searched for, and as a result, a standard sentence pattern like the selected standard sentence pattern 504 is selected. The mapping of the meaning tag sets into the standard sentence pattern is performed, for example, by a method of Japanese Patent Application No. 2001-65637.

That is, the operations of steps 303 to 306 are as described below when performed by the method of Japanese Patent Application No. 2001-65637. The entire disclosure of Japanese Patent Application No. 2001-65637 filed on Mar. 8, 2001 including specification, claims, drawings and summary are incorporated herein by reference in its entirety.

First, the dependency relation analyzing portion 132 combines two meaning tags of the meaning tag assignment result 502 to form meaning tag combinations as shown in the meaning tag combinations 503. The meaning tag assignment result 502 includes five meaning tags, and the total number of possible combinations of the five meaning tags is ten. The meaning tag combinations 503 include ten meaning tag combinations. All the possible combinations of the meaning tags included in the meaning tag assignment result 502 are formed to obtain the meaning tag combinations 503.

Then, the dependency relation analyzing portion 132 calculates the degree of coincidence between the meaning tag combinations 503 and the meaning tag sets in the dependency relation database 122. In the example of FIG. 22(b), first, the degree of coincidence between the meaning tag set “ [symbol] (sharyo, vehicles) [symbol] (onkyo, sound)· [symbol] (keikoku, warning)) ( [symbol] (onkyo, sound)· [symbol] (keikoku, warning)→ [symbol] (otoshutsuryoku, output-sound)) ( [symbol] (sharyo, vehicles) [symbol] (ido, move))” and the meaning tag combinations 503.

First, the first meaning tag pair of the meaning tag set ( [symbol] (sharyo, vehicles) [symbol] (onkyo, sound)· [symbol] (keikoku, warning)) is examined. A meaning tag pair coinciding with the first meaning tag pair is present in the meaning tag combinations 503. Then, the second meaning tag pair of the meaning tag set ( [symbol] (onkyo, sound)· [symbol] (keikoku, warning)→ [symbol] (otoshutsuryoku, output-sound)) is examined. A meaning tag pair coinciding with the second meaning tag pair is present in the meaning tag combinations 503. Then, the third meaning tag pair of the meaning tag set ( [symbol] (sharyo, vehicles) [symbol] (ido, move)) is examined. A meaning tag pair coinciding with the third meaning tag pair is absent in the meaning tag combinations 503. Therefore, the degree of coincidence of the first meaning tag set is 2.

Likewise, the meaning tag pair of the second meaning tag set ( [symbol] (sharyo, vehicles)→ [symbol] (ido, move)) is examined. A meaning tag pair coinciding with the meaning tag pair is absent in the meaning tag combinations 503. Therefore, the degree of coincidence of the second meaning tag set is 0. Likewise, the degrees of coincidence of the third and succeeding meaning tag sets of FIG. 22(b) are also 0. The dependency relation analyzing portion 132 calculates the degree of coincidence in this manner.

Notified of the degree of coincidence by the dependency relation analyzing portion 132, the standard sentence pattern searching portion 150 selects from the standard sentence pattern database 140 the standard sentence pattern corresponding to the meaning tag set having the highest degree of coincidence of the meaning tag sets in the dependency relation database 122. In the above-described example, since the meaning tag set “( [symbol] (sharyo, vehicles)→ [symbol] (onkyo, sound)· [symbol] (keikoku, warning)) ( [symbol] (onkyo, sound)· [symbol] (keikoku, warning)→ [symbol] (otoshutsuryoku, output-sound)) ( [symbol] (sharyo, vehicles)→ [symbol] (ido, move))” has the highest degree of coincidence, the selected standard sentence pattern 504 which is a standard sentence pattern corresponding to this meaning tag set, that is, “[ [symbol] (sharyo, vehicles): subject] [symbol] (ga)[ [symbol] (onkyo, sound)· [symbol] (keikoku, warning): object] [symbol] (o)[ [symbol] (otoshutsuryoku, output-sound): predicate 1] [symbol] (te)[ [symbol] (ido, move): predicate 2]” is selected.

Then, the standard sentence pattern searching portion 150 excludes the following meaning tag from the selected standard sentence pattern 504: of the meaning tag pairs of the meaning tag set having the highest degree of coincidence “( [symbol] (sharyo, vehicles)→ [symbol] (onkyo, sound)· [symbol] (keikoku, warning)) ( [symbol] (onkyo, sound)· [symbol] (keikoku, warning)→ [symbol] (otoshutsuryoku, output-sound)) ( [symbol] (sharyo, vehicles)→ [symbol] (ido, move))”, a meaning tag that belongs to a meaning tag pair coinciding with none of the meaning tag pairs of the meaning tag combinations 503 and is not included in the meaning tag pairs coinciding with meaning tag pairs in the meaning tag set combinations 503. As such a meaning tag, “ [symbol] (ido, move)” is excluded. In this manner, an input error is excluded.

Consequently, removing the meaning tag “ [symbol] (ido, move)” from the selected standard sentence pattern 504, the standard sentence pattern searching portion 150 obtains “[ [symbol] (sharyo, vehicles): subject] [symbol] (ga)[ [symbol] (onkyo, sound)· [symbol] (keikoku, warning): object] [symbol] (o)[ [symbol] (otoshutsuryoku, output-sound): predicate 1](te)”, that is, an input error excluded standard sentence pattern 504a.

Then, the standard sentence pattern searching portion 150 extracts the phoneme strings and the prosody information of the stereotyped parts of the selected standard sentence pattern 504.

The non-stereotyped part generating portion 160 compares the attributes of the non-stereotyped parts of the standard sentence pattern 504 selected at step 305 and the language information assigned to the key words not determined to be an input error as step 304, and generates words corresponding to the non-stereotyped parts from the key words extracted at step 302 (step 307).

The operation of step 307 will be described with reference to FIG. 21. The key words not excluded at step 304 are applied to non-stereotyped parts of the standard sentence pattern 504 selected by the standard sentence pattern searching portion 150, and a word frequently occurring in the standard sentence pattern is applied to the non-stereotyped part to which none of the key words corresponds.

That is, there is no key word corresponding to the meaning tag “ [symbol] (ido, move)” excluded in the input error excluded standard sentence pattern 504a, a word “ [symbol] (hashiru, run)” which frequently occurs at the meaning tag “ [symbol] (ido, move)” is applied. In this manner, the application to the standard sentence pattern 505 is obtained.

The prosody control portion 172 searches the non-stereotyped part prosody database 171 by use of at least one of the phoneme strings, the numbers of morae and the accents of the non-stereotyped parts generated at step 307, the positions of the non-stereotyped parts in the sentence, the presence or absence and the durations of pauses between the non-stereotyped parts and the stereotyped parts, and the accent types of the stereotyped parts adjoining the non-stereotyped parts (step 308) and extracts the prosody information of the non-stereotyped parts in units of accent phrases (step 309).

Then, the prosody control portion 172 adjusts the prosody information of the non-stereotyped parts extracted at step 308 based on the non-stereotyped part prosody adjustment parameters of the standard sentence pattern mapped at step 306, and connects the adjusted prosody information to the prosody information of the stereotyped parts extracted at step 306. The adjustment is performed as described, for example, in Japanese Patent Application No. 2000-163807 (step 310).

The waveform generating portion 174 generates a speech waveform by use of phoneme pieces stored in the phoneme piece database 173 based on the phoneme strings of the stereotyped parts extracted at step 306, the phoneme strings of the non-stereotyped parts generated at step 307 and the prosody information generated at step 310 (step 311).

The speech waveform generated at step 311 is output as a speech from the output portion 180 (step 312).

In this manner, a speech “ [symbol] (kyukyushaga sairen o narasite hashitta, An ambulance ran while wailing its siren.)” is output.

While in this embodiment, when an input error is excluded, a frequently occurring word is applied to the excluded meaning tag, speech synthesis may be performed only on the stereotyped and non-stereotyped parts included in the input error excluded standard sentence pattern 504a. When this is done, in the above-described example, a speech “ [symbol] (kyukyusha ga sairen o narasite, An ambulance while wailing its siren.)” is output.

As described above, according to the system for providing information by speech of this embodiment, by extracting the meaning of the input text after excluding the input error, converting it to a standard sentence pattern having an equal meaning and synthesizing a speech, for an incomplete text having an input error or an omitted part or comprising an enumeration of words, synthetic speech with high naturalness can be realized in a language expression complete as a sentence, and information can be accurately provided by natural speech.

(Sixth Embodiment)

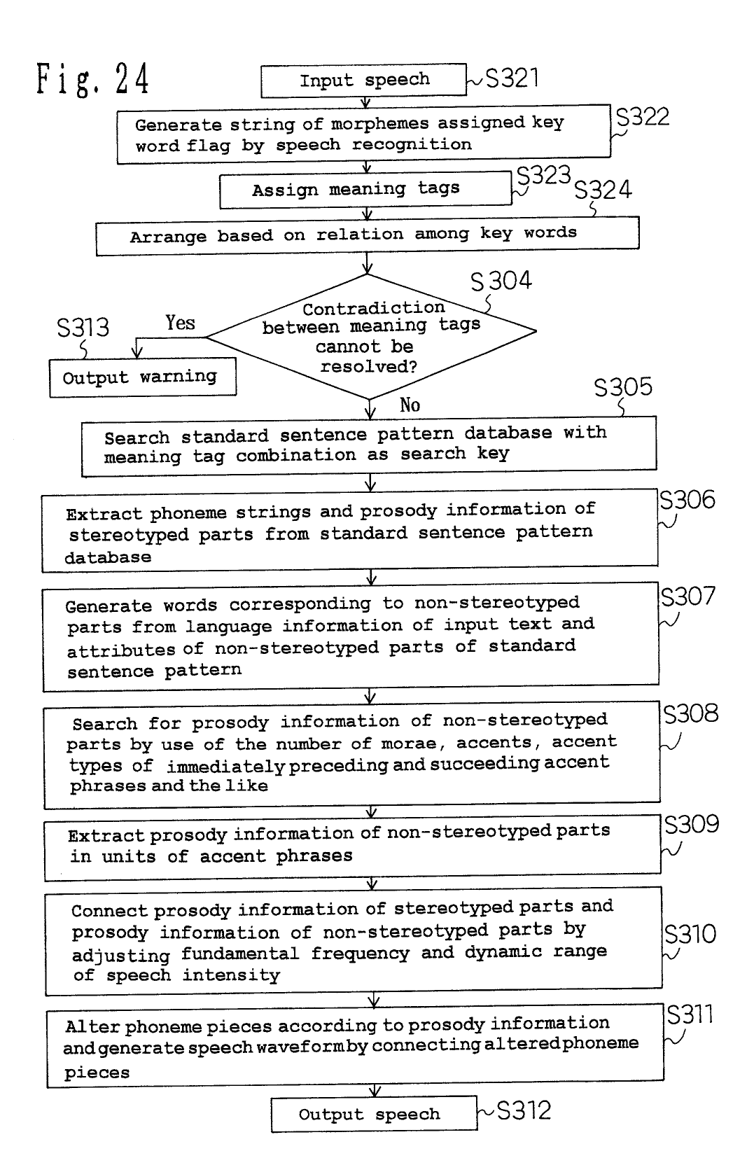

FIG. 23 is a functional block diagram showing the structure of a system for providing information by speech according to a sixth embodiment of the present invention. FIG. 24 is a flowchart of the operation of the system for providing information by speech according to the sixth embodiment of the present invention.

In FIG. 23, the same parts and elements as those of FIG. 1 are designated by the same reference numerals and will not be described, and only different parts and elements will be described. In FIG. 23 of the sixth embodiment, the structure is the same as that of the first embodiment except that the text input portion 110 of the structure of FIG. 1 is replaced by the speech input portion 210 and that the key word extracting portion 130 is replaced by the speech recognizing and key word extracting portion 230 that recognizes the input speech with reference to the key word information assigned dictionary 120 and feature amount data and outputs the result of the recognition as a string of morphemes assigned the key word flag. The operation of the system for providing information by speech structured as described above will be described with reference to FIG. 24.

The speech input portion 210 accepts a speech waveform to be processed (step 321). The speech recognizing and key word extracting portion 230 recognizes the input speech with reference to the key word information assigned dictionary 120 and the feature amount data, performs conversion of the input speech to a morpheme string and extraction of key words at the same time, and generates a speech recognition result as a string of morphemes assigned the key word flag (step 322). Then, the speech recognizing and key word extracting portion 230 arranges the morpheme string into syntactic units by use of language information such as the part of speech, and assigns meaning tags and language information such as the pronunciation and the part of speech (step 323).

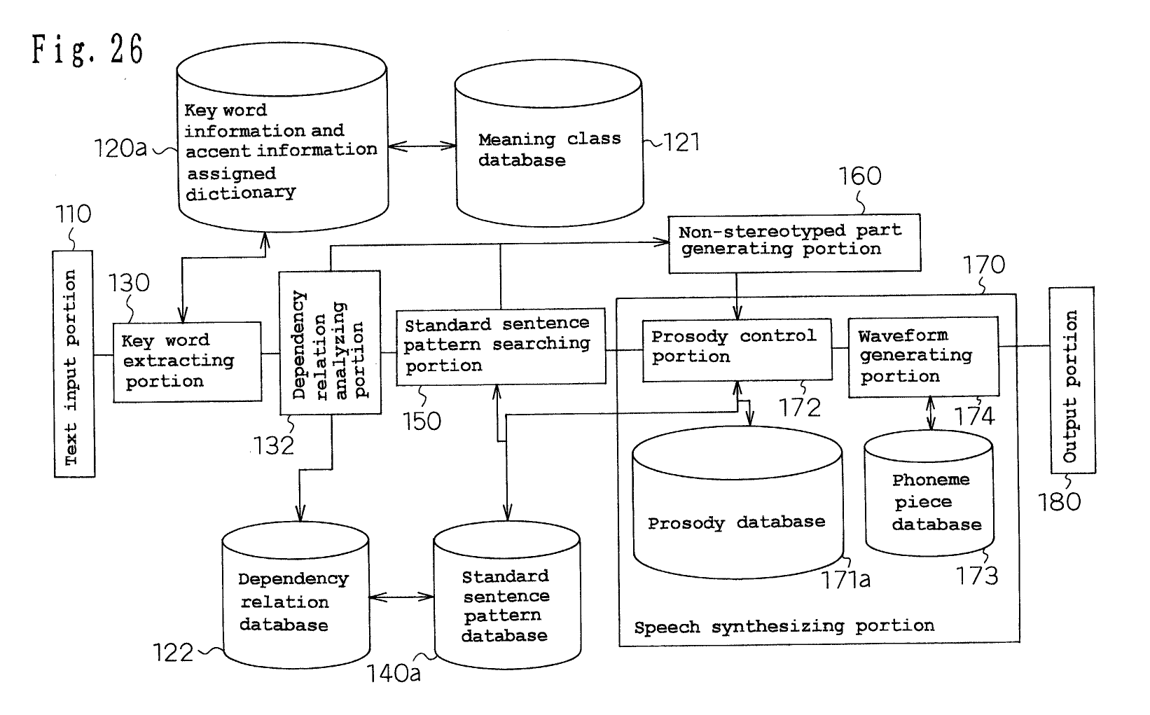

The operations of such steps 322 and 323 will be described with reference to FIG. 25. It is assumed that the input speech is an input speech 600, that is, “ [symbol] , [symbol] , (kokoa o etto tsumetainode onegaishimasu, A cocoa, uh, a cold one, please.)∘.” The result of speech recognition of this speech data is a morpheme string like the speech recognition result 601. It is assumed that the morphemes assigned the key word flag in the key word information assigned dictionary 120 are “ [symbol] (kokoa, cocoa)” “ [symbol] (eto, Eto)” “ [symbol] (tsumetai, cold)” and “ [symbol] (onegai, please)” as shown in the key word flag 602. Assigning meaning tags to the syntactic units including key words with reference to the meaning class database 121, the meaning tag assignment result 603 is obtained. In this embodiment, clauses are used as syntactic units. That is, “ [symbol] (kokoa, cocoa)” is assigned “general noun: [symbol] (nomimono, beverage), subject” as the meaning tag and the language information, “ [symbol] (eto, Eto)” is assigned “proper noun: [symbol] (sei, last name), subject” as the meaning tag and the language information, “ [symbol] (tsumetai, cold)” is assigned “adjective: [symbol] (ondo, temperature), modifying verb cause” as the meaning tag and the language information, and “ [symbol] (onegaishimasu, please)” is assigned “verbal noun: [symbol] (yokyu, request)· [symbol] (teinei, polite expression), predicate” as the meaning tag and the language information.

Then, the dependency relation analyzing portion 132 analyzes the relation among the extracted key words (step 303). Further, the dependency relation analyzing portion 132 determines whether the relation among the key words can be analyzed or not (step 304).

When the relation among the key words cannot be analyzed and a contradictory key word cannot be excluded, a warning is output to the user and the program is ended (step 313). When a key word irrelevant or contradictory to other key words can be determined to be a recognition error or an inserted unnecessary word and can be excluded at step 304, the dependency relation analyzing portion 132 outputs a meaning tag set with which a standard sentence pattern representative of the meaning of the input can be searched for.

The operations of such steps 325 and 304 will be described with reference to FIG. 25. By the analysis, “ [symbol] (kokoa, cocoa) and [symbol] (tsumetai, cold)” and “ [symbol] (kokoa, cocoa) and [symbol] (onegaisuru, please)” assigned the flag in the key word flag 602 are each determined to be highly related to each other, and “ [symbol] (eto, Eto)” is determined to be irrelevant to “ [symbol] (kokoa, cocoa)” and “ [symbol] (tsumetai, cold)” and slightly related only with “ [symbol] (onegaisuru, please).” From these analysis results, “ [symbol] (eto, Eto)” is excluded as an inappropriate part in identifying the meaning of the entire input text, and a meaning tag set like the meaning tag set 604 with which a standard sentence pattern can be searched for is output. The exclusion of an input error based on the meaning of the key words and the relation among the key words is performed, for example, by the method described in Japanese Patent Application No. 2001-65637. That is, details of these operations are similar to those described in the fifth embodiment.

The standard sentence pattern searching portion 150 searches the standard sentence pattern database 140 by use of the meaning tag sets output from the dependency relation analyzing portion 132 (step 305), maps the input text into a specific standard sentence pattern, and extracts the phoneme strings and the prosody information of the stereotyped parts of the mapped standard sentence pattern (step 306).

The operations of such steps 305 and 306 will be described with reference to FIG. 25. A standard sentence pattern including meaning tags common to those included in the meaning tag set 604 output from the dependency relation analyzing portion 132 is searched for, and as a result, a standard sentence pattern like the selected standard sentence pattern 605 is selected. The selection of the standard sentence pattern from the meaning tag set is performed, for example, by the method described in Japanese Patent Application No. 2001-65637. That is, details of these operations are similar to those described in the fifth embodiment.

The non-stereotyped part generating portion 160 compares the attributes of the non-stereotyped parts of the standard sentence pattern selected at step 305 and the language information assigned to the key words not determined to be an input error as step 304, and generates words corresponding to the non-stereotyped parts from the key words extracted at step 322 (step 307).

The operation of step 307 will be described with reference to FIG. 25. The key words not excluded at step 304 are applied to the non-stereotyped parts of the standard sentence pattern 605 selected by the standard sentence pattern searching portion 150.

The prosody control portion 172 searches the non-stereotyped part prosody database 171 by use of at least one of the phoneme strings, the numbers of morae and the accents of the non-stereotyped parts generated at step 307, the positions of the non-stereotyped parts in the sentence, the presence or absence and the durations of pauses between the non-stereotyped parts and the stereotyped parts, and the accent types of the stereotyped parts adjoining the non-stereotyped parts (step 308), and extracts the prosody information of the non-stereotyped parts for each accent phrase (step 309).

Then, the prosody control portion 172 adjusts the prosody information of the non-stereotyped parts extracted at step 308 based on the non-stereotyped part prosody adjustment parameters of the standard sentence pattern selected at step 305, and connects the adjusted prosody information to the prosody information of the stereotyped parts extracted at step 305. The adjustment is performed, for example, in a manner similar to that of the above-described embodiment (step 310).

The waveform generating portion 174 generates a speech waveform by use of phoneme pieces stored in the phoneme piece database 173 based on the phoneme strings of the stereotyped parts extracted at step 306, the phoneme strings of the non-stereotyped parts generated at step 307 and the prosody information generated at step 310 (step 311).

The speech waveform generated at step 311 is output as a speech from the output portion 180 (step 312).

As described above, according to the system for providing information by speech of this embodiment, by extracting the meaning of the input speech after excluding a colloquial expression, an inserted unnecessary word or a speech recognition error, converting it to a standard sentence pattern having an equal meaning and synthesizing a speech, for an incomplete text in which an unnecessary word is inserted, having a recognition error, an omitted part or an inverted part, or comprising an enumeration of words, synthetic speech with high naturalness can be realized in a language expression complete as a sentence, and information can be accurately provided by natural speech.

While speech synthesis is performed by connecting phoneme pieces in the fifth and the sixth embodiments, it may be performed by a method other than this method.

While adjustment parameters of stereotyped part phoneme strings, stereotyped part prosody patterns and non-stereotyped part prosody patterns are stored in the standard sentence pattern database in the fifth and the sixth embodiments, instead of stereotyped part phoneme strings and stereotyped part prosody patterns, recorded speeches may be stored.

While adjustment parameters of stereotyped part phoneme strings, stereotyped part prosody patterns and non-stereotyped part prosody patterns are stored in the standard sentence pattern database in the fifth and the sixth embodiments, instead of stereotyped part phoneme strings and stereotyped part prosody patterns, parameters such as formant information conforming to the synthesizing method of the speech synthesizing portion 170 may be stored.

While in the fifth and the sixth embodiments, the phoneme string, the number of morae, the accent, the position in the sentence, the presence or absence and the durations of immediately preceding and succeeding pauses, the accent types of the immediately preceding and succeeding accent phrases and the prosody information are stored in the non-stereotyped part prosody database 171, in addition to these, the string of parts of speech, the clause attribute, the dependency, the prominence and the like may be stored, or it is necessary only to store at least one of the above-mentioned conditions except the prosody information.

As described above, according to this embodiment, not only an arbitrary input text can be accepted but also an arbitrary input signal such as a speech, an image or a sound can be accepted, so that information can be provided by natural speech.

Moreover, according to this embodiment, by, for an arbitrary input such as a text or a speech, analyzing the meaning of the input signal and converting it to a language expression by a standard sentence pattern, conversion from a wide range of media and modalities to a speech and language conversion are enabled, and information can be provided by high quality speech.

The present invention is a program for causing a computer to perform the functions of all or some of the means (or apparatuses, devices, circuits, portions or the like) of the system for providing information by speech according to the present invention described above which program operates in cooperation with the computer.

Further, the present invention is a program for causing a computer to perform the operations of all or some of the steps (or processes, operations, workings or the like) of the system for providing information by speech according to the present invention described above which program operates in cooperation with the computer.

Some of the means (or apparatuses, devices, circuits, portions or the like) in the present invention and some of the steps (or processes, operations, workings or the like) in the present invention mean some of a plurality of means and some of a plurality of steps, respectively, or mean some functions of one means and some operations of one step, respectively.

Moreover, a computer-readable recording medium on which the program of the present invention is recorded is included in the present invention.

Moreover, a usage of the program of the present invention may be such that the program is recorded on a computer-readable recording medium and operates in cooperation with a computer.

Moreover, a usage of the program of the present invention may be such that the program is transmitted over a transmission medium, is read by a computer and operates in cooperation with the computer.

Moreover, examples of the recording medium include ROMs, and examples of the transmission medium include a transmission medium such as the Internet, light, radio waves and sound waves.

Moreover, the above-mentioned computer of the present invention is not limited to pure hardware such as a CPU, but may include firmware, an OS, and peripherals.

As described above, the structure of the present invention may be realized either as software or as hardware.

As is apparent from the description given above, the present invention can provide an apparatus for providing information by speech, a method for providing information by speech and a program that are capable of accepting an arbitrary input and providing information by natural speech.

Moreover, the present invention can provide an apparatus for providing information by speech, a method for providing information by speech and a program that are capable of accepting an arbitrary input and outputting a speech that can be understood by the listener even when there is an error in the input.

Moreover, the present invention can provide an apparatus for providing information by speech, a method for providing information by speech and a program that are capable of converting even a nonverbal input such as a speech, an image or a sound to an understandable speech.

What is claimed is:

1. An apparatus for providing information by speech, comprising:
analyzing means of extracting all or some of words from an input sentence based on a predetermined criterion, replacing the extracted words with standard words by use of predetermined relation information, selecting a standard sentence pattern most relevant to the input sentence from among a plurality of prepared standard sentence patterns by use of the standard words, and replacing all or some of the standard words of the selected standard sentence pattern with the corresponding words; and
speech synthesizing means of performing speech synthesis of the sentence on which the word replacement has been performed, by use of prosody information previously assigned to at least the selected standard sentence pattern,
wherein said relation information is such that to the predetermined standard words, words relevant to the standard words are related.

2. An apparatus for providing information by speech according to claim 1, wherein said predetermined criterion is selection of a word occurring in the relation information.

3. An apparatus for providing information by speech, comprising:
analyzing means of extracting all or some of words from an input sentence based on a predetermined criterion, and selecting a standard sentence pattern most relevant to the input sentence from among a plurality of prepared standard sentence patterns by use of the extracted words; and
speech synthesizing means of performing speech synthesis of the selected standard sentence pattern by use of prosody information previously assigned to at least the selected standard sentence pattern,
wherein said predetermined criterion is selection of a word coinciding with any of words registered in the prepared standard sentence patterns.

4. An apparatus for providing information by speech, comprising:
analyzing means of extracting all or some of words of a first language from an input sentence of the first language based on a predetermined criterion, replacing the extracted words of the first language with standard words of a second language by use of predetermined relation information, selecting a standard sentence pattern of the second language most relevant to the input sentence from among a plurality of prepared standard sentence patterns of the second language by use of the standard words of the second language, and replacing all or some of the standard words of the second language of the selected standard sentence pattern of the second language with words of the second language corresponding to words of the first language corresponding to the standard words of the second language; and
speech synthesizing means of performing speech synthesis of the sentence on which the word replacement has been performed, by use of prosody information previously assigned to at least the selected standard sentence pattern of the second language,
wherein said relation information is such that to the predetermined standard words of the second language, words of the first language relevant to the standard words of the second language are related.

5. An apparatus for providing information by speech, comprising:
analyzing means of extracting all or some of words of a first language from an input sentence of the first language based on a predetermined criterion, replacing the extracted words of the first language with standard words of the first language by use of predetermined relation information, selecting a standard sentence pattern of the first language most relevant to the input sentence from among a plurality of prepared standard sentence patterns of the first language by use of the standard words of the first language, identifying a predetermined standard sentence pattern of a second language associated with the selected standard sentence pattern of the first language, and replacing all or some of standard words of the second language of the identified standard sentence pattern of the second language with words of the second language equivalent to the input words of the first language corresponding to the standard words of the first language corresponding to the standard words of the second language; and
speech synthesizing means of performing speech synthesis of the sentence on which the word replacement has been performed, by use of prosody information previously assigned to at least the selected standard sentence pattern of the second language,
wherein said relation information is such that to the predetermined standard words of the first language, words of the first language relevant to the standard words of the first language are related.

6. An apparatus for providing information by speech according to claims 4-5, wherein said predetermined criterion is selection of a word of the first language occurring in the relation information.

7. An apparatus for providing information by speech, comprising:
analyzing means of extracting all or some of words of a first language from an input sentence of the first language based on a predetermined criterion, and selecting a standard sentence of a second language most relevant to the input sentence from among a plurality of prepared standard sentence patterns of the second language by use of words of the second language corresponding to the extracted words of the first language; and
speech synthesizing means of performing speech synthesis of the selected standard sentence pattern of the second language by use of prosody information previously assigned to at least the selected standard sentence pattern of the second language,
wherein said predetermined criterion is selection of a word of the first language corresponding to a word of the second language registered in the prepared standard sentence patterns of the second language.

8. An apparatus for providing information by speech, comprising:
analyzing means of extracting all or some of words of a first language from an input sentence of the first language based on a predetermined criterion, selecting a standard sentence pattern of the first language most relevant to the input sentence of the first language from among a plurality of prepared standard sentence patterns of the first language by use of the extracted words of the first language, and identifying a predetermined standard sentence pattern of a second language corresponding to the selected standard sentence pattern of the first language; and
speech synthesizing means of performing speech synthesis of the identified standard sentence pattern of the second language by use of prosody information previously assigned to at least the identified standard sentence pattern of the second language,
wherein said predetermined criterion is selection of a word of the first language coinciding with any of words of the first language registered in the prepared standard sentence patterns of the first language.

9. An apparatus for providing information by speech, comprising:
analyzing means of extracting all or some of words from an input sentence based on a predetermined criterion, replacing the extracted words with standard words by use of predetermined relation information, selecting a standard sentence pattern most relevant to the input sentence from among a plurality of prepared standard sentence patterns by use of the standard words, identifying a predetermined response standard sentence pattern corresponding to the selected standard sentence pattern, and replacing all or some of the standard words of the identified response standard sentence pattern with the corresponding words; and
speech synthesizing means of performing speech synthesis of the sentence on which the word replacement has been performed, by use of prosody information previously assigned to at least the identified response standard sentence pattern,
wherein said relation information is such that to the predetermined standard words, words relevant to the standard words are related.

10. An apparatus for providing information by speech according to claim 9, wherein said predetermined criterion is selection of a word occurring in the relation information.

11. An apparatus for providing information by speech, comprising:
analyzing means of extracting all or some of words from an input sentence based on a predetermined criterion, selecting a standard sentence pattern most relevant to the input sentence from among a plurality of prepared standard sentence patterns by use of the extracted words, and identifying a predetermined response standard sentence pattern corresponding to the selected standard sentence pattern; and
speech synthesizing means of performing speech synthesis of the identified response standard sentence pattern by use of prosody information previously assigned to at least the identified response standard sentence pattern,
wherein said predetermined criterion is selection of a word the same as a word registered in the prepared standard sentence patterns.

12. An apparatus for providing information by speech according to any of claims 1, 2, 4, and 7-10, wherein when replacing the standard words of the selected standard sentence pattern with the words, said analyzing means leaves, of the standard words of the selected standard sentence pattern, standard words not corresponding to the words as they are, or replaces the standard words not corresponding to the words with predetermined words.

13. An apparatus for providing information by speech according to any of claims 1-5 and 7-11, wherein all or some of the prepared standard sentence patterns are each associated with a predetermined operation and/or image data.

14. An apparatus for providing information by speech according to claim 13, wherein all or some of the prepared standard sentence patterns are each associated with a predetermined operation, and when selecting or identifying the standard sentence pattern, said analyzing means also identifies the operation corresponding to the standard sentence pattern, and the identified operation is performed when said speech synthesizing means outputs a result of the speech synthesis.

15. An apparatus for providing information by speech according to claim 13, wherein all or some of the prepared standard sentence patterns are each associated with a predetermined image, and when selecting or identifying the standard sentence pattern, said analyzing means also identifies the image corresponding to the standard sentence pattern, and the identified image is displayed when said speech synthesizing means outputs a result of the speech synthesis.

16. An apparatus for providing information by speech according to any of claims 1-5 and 7-11, comprising signal processing means of analyzing an input signal and generating one word or a plurality of words in accordance with a result of the analysis,
wherein said input sentence is the generated word or words.

17. An apparatus for providing information by speech according to claim 16, wherein said input signal is at least one of a speech, a sound, an image, a vibration, an acceleration, a temperature and a tension.

18. An apparatus for providing information by speech according to claim 17, wherein said input signal is at least a speech, and said signal processing means performs speech recognition of the input speech and generates one word or a plurality of words in accordance with a result of the speech recognition.

19. An apparatus for providing information by speech according to claim 17, wherein said input signal is at least a sound, and said signal processing means recognizes a sound source of the input sound and generates one word or a plurality of words in accordance with a result of the sound source recognition.

20. An apparatus for providing information by speech according to claim 17, wherein said input signal is at least an image, and said signal processing means analyzes the input image and generates one word or a plurality of words in accordance with a result of the analysis.

21. An apparatus for providing information by speech according to any of claims 1-5 and 7-11, wherein there is a possibility that the input sentence is incomplete.

22. An apparatus for providing information by speech according to claim 21, wherein that there is a possibility that the input sentence is incomplete is a case where there is a possibility that all or a part of the input sentence is omitted, a case where there is a possibility that all or a part of the input sentence is replaced with an irrelevant sentence, or a case where there is a possibility that an irrelevant sentence is inserted in the input sentence.

23. An apparatus for providing information by speech according to claim 22, wherein when said analyzing means fails in the selection of the standard sentence pattern because all or a part of the input sentence is omitted or all or a part of the input sentence is replaced with an irrelevant sentence, said speech synthesizing means does not perform the speech synthesis.

24. An apparatus for providing information by speech according to any of claims 1-5 and 7-11, wherein a part of the input sentence are any of sentences, phrases, bunsetsu, and words.

25. An apparatus for providing information by speech according to claim 21, wherein that there is a possibility that the input sentence is incomplete is a case where there is a possibility that the input sentence is a grammatically incomplete sentence including a colloquial expression, a case where there is a possibility that the input sentence is an enumeration of words, a case where the input sentence includes a literal error or an omitted word, or a case where there is a possibility that the input sentence is not a sentence but an expression comprising symbols and words.

26. An apparatus for providing information by speech according to claim 21, wherein when the input sentence is a sentence generated as a result of a speech recognition result, that there is a possibility that the input sentence is incomplete is a case where there is a possibility that the speech recognition result includes a recognition error, or a case where there is a possibility that the speech recognition is a failure so that a recognition result corresponding to all or part of the input speech on which the speech recognition is performed is not output as the speech recognition result.

27. An apparatus for providing information by speech according to any of claims 1-5 and 7-11, wherein said prosody information is a speech waveform obtained by recording a naturally generated speech of the standard sentence pattern assigned the prosody information.

28. An apparatus for providing information by speech according to any of claims 1-5 and 7-11, wherein said prosody information is information extracted from a naturally generated speech of the standard sentence pattern assigned the prosody information.

29. An apparatus for providing information by speech according to claim 28, wherein said extracted information includes at least one of a fundamental frequency pattern, an intensity pattern, a phoneme duration pattern and a speech rate of the speech.

30. An apparatus for providing information by speech according to any of claims 1-5 and 7-11, wherein said prosody information is associated with at least one of the following conditions: a phoneme string; the number of morae, the number of syllables; an accent; a position in a sentence; presence or absence and a duration of an immediately preceding or succeeding pause; an accent type of an immediately preceding or succeeding accent phrase; prominence; a string of parts of speech; a bunsetsu attribute; and a dependency relation.

31. An apparatus for providing information by speech according to any of claims 1-5 and 7-11, wherein said prosody information is stored in prosody generation units, and said prosody generation units are any of accent phrases, phrases, words and clauses.

32. A method for providing information by speech, comprising the steps of:
extracting all or some of words from an input sentence based on a predetermined criterion, and replacing the extracted words with standard words by use of predetermined relation information;
selecting a standard sentence pattern most relevant to the input sentence from among a plurality of prepared standard sentence patterns by use of the standard words;
replacing all or some of the standard words of the selected standard sentence pattern with the corresponding words; and
performing speech synthesis of the sentence on which the word replacement has been performed, by use of prosody information previously assigned to at least the selected standard sentence pattern,
wherein said relation information is such that to the predetermined standard words, words relevant to the standard words are related.

33. A method for providing information by speech, comprising the steps of:
extracting all or some of words from an input sentence based on a predetermined criterion, and selecting a standard sentence pattern most relevant to the input sentence from among a plurality of prepared standard sentence patterns by use of the extracted words; and
performing speech synthesis of the selected standard sentence pattern by use of prosody information previously assigned to at least the selected standard sentence pattern,
wherein said predetermined criterion is selection of a word coinciding with any of words registered in the prepared standard sentence patterns.

34. A program for causing a computer to function as all or some of the following means of the apparatus for providing information by speech according to claim 1:
analyzing means of extracting all or some of words from an input sentence based on a predetermined criterion, replacing the extracted words with standard words by use of predetermined relation information, selecting a standard sentence pattern most relevant to the input sentence from among a plurality of prepared standard sentence patterns by use of the standard words, and replacing all or some of the standard words of the selected standard sentence pattern with the corresponding words; and
speech synthesizing means of performing speech synthesis of the sentence on which the word replacement has been performed, by use of prosody information previously assigned to at least the selected standard sentence pattern.

35. A program for causing a computer to function as all or some of the following means of the apparatus for providing information by speech according to claim 3:
analyzing means of extracting all or some of words from an input sentence based on a predetermined criterion, and selecting a standard sentence pattern most relevant to the input sentence from among a plurality of prepared standard sentence patterns by use of the extracted words; and
speech synthesizing means of performing speech synthesis of the selected standard sentence pattern by use of prosody information previously assigned to at least the selected standard sentence pattern.

36. A program for causing a computer to function as all or some of the following means of the apparatus for providing information by speech according to claim 4:
analyzing means of extracting all or some of words of a first language from an input sentence of the first language based on a predetermined criterion, replacing the extracted words of the first language with standard words of a second language by use of predetermined relation information, selecting a standard sentence pattern of the second language most relevant to the input sentence from among a plurality of prepared standard sentence patterns of the second language by use of the standard words of the second language, and replacing all or some of the standard words of the second language of the selected standard sentence pattern of the second language with words of the second language corresponding to words of the first language corresponding to the standard words of the second language; and
speech synthesizing means of performing speech synthesis of the sentence on which the word replacement has been performed, by use of prosody information previously assigned to at least the selected standard sentence pattern of the second language.

37. A program for causing a computer to function as all or some of the following means of the apparatus for providing information by speech according to claim 5:
analyzing means of extracting all or some of words of a first language from an input sentence of the first language based on a predetermined criterion, replacing the extracted words of the first language with standard words of the first language by use of predetermined relation information, selecting a standard sentence pattern of the first language most relevant to the input sentence from among a plurality of prepared standard sentence patterns of the first language by use of the standard words of the first language, identifying a predetermined standard sentence pattern of a second language associated with the selected standard sentence pattern of the first language, and replacing all or some of standard words of the second language of the identified standard sentence pattern of the second language with words of the second language equivalent to the input words of the first language corresponding to the standard words of the first language corresponding to the standard words of the second language; and
speech synthesizing means of performing speech synthesis of the sentence on which the word replacement has been performed, by use of prosody information previously assigned to at least the selected standard sentence pattern of the second language.

38. A program for causing a computer to function as all or some of the following means of the apparatus for providing information by speech according to claim 7:
analyzing means of extracting all or some of words of a first language from an input sentence of the first language based on a predetermined criterion, and selecting a standard sentence pattern of a second language most relevant to the input sentence from among a plurality of prepared standard sentence patterns of the second language by use of words of the second language corresponding to the extracted words of the first language; and
speech synthesizing means of performing speech synthesis of the selected standard sentence pattern of the second language by use of prosody information previously assigned to at least the selected standard sentence pattern of the second language.

39. A program for causing a computer to function as all or some of the following means of the apparatus for providing information by speech according to claim 8:
analyzing means of extracting all or some of words of a first language from an input sentence of the first language based on a predetermined criterion, selecting a standard sentence pattern of the first language most relevant to the input sentence of the first language from among a plurality of prepared standard sentence patterns of the first language by use of the extracted words of the first language, and identifying a predetermined standard sentence pattern of a second language corresponding to the selected standard sentence pattern of the first language; and
speech synthesizing means of performing speech synthesis of the identified standard sentence pattern of the second language by use of prosody information previously assigned to at least the identified standard sentence pattern of the second language.

40. A program for causing a computer to function as all or some of the following means of the apparatus for providing information by speech according to claim 9:
analyzing means of extracting all or some of words from an input sentence based on a predetermined criterion, replacing the extracted words with standard words by use of predetermined relation information, selecting a standard sentence pattern most relevant to the input sentence from among a plurality of prepared standard sentence patterns by use of the standard words, identifying a predetermined response standard sentence pattern corresponding to the selected standard sentence pattern, and replacing all or some of the standard words of the identified response standard sentence pattern with the corresponding words; and
speech synthesizing means of performing speech synthesis of the sentence on which the word replacement has been performed, by use of prosody information previously assigned to at least the identified response standard sentence pattern.

41. A program for causing a computer to function as all or some of the following means of the apparatus for providing information by speech according to claim 11:
analyzing means of extracting all or some of words from an input sentence based on a predetermined criterion, selecting a standard sentence pattern most relevant to the input sentence from among a plurality of prepared standard sentence patterns by use of the extracted words, and identifying a predetermined response standard sentence pattern corresponding to the selected standard sentence pattern; and
speech synthesizing means of performing speech synthesis of the identified response standard sentence pattern by use of prosody information previously assigned to at least the identified response standard sentence pattern.
